(19) United States
(12) Patent Application Publication
(10) Pub. No.: US 2026/0334733 A1
(43) Pub. Date: Oct. 29, 2026

(54) Micro Puree Machine

(71) Applicant: SharkNinja Operating LLC, Needham, MA (US)

(72) Inventors: Jonathan James, Witney (GB); Nathan Lyell, Suffolk (GB); Will Alexander, London (GB); Ming Li Shi, Guangdong (CN); Kai Ping Hu, Guangdong (CN); Xu Sheng Deng, Huizhou (CN); Diego Jasso, New Hope, MN (US); Nick Lerwill, London (GB); Lukas Tubby, Mansfield, MA (US); Noah William Weinstock, South Boston, MA (US); Pierce James Barnard, Manly (AU)

(21) Appl. No.: 19/731,633

(22) Filed: Jul. 6, 2026

Related U.S. Application Data
(63) Continuation-in-part of application No. 18/595,156, filed on Mar. 4, 2024.
(63) Continuation-in-part of application No. 18/627,745, filed on Apr. 5, 2024.
(63) Continuation-in-part of application No. 18/637,768, filed on Apr. 17, 2024.
(63) Continuation-in-part of application No. 18/606,968, filed on Mar. 15, 2024.
(63) Continuation-in-part of application No. 18/606,879, filed on Mar. 15, 2024.
(63) Continuation-in-part of application No. 18/531,807, filed on Dec. 7, 2023.
(63) Continuation-in-part of application No. 18/541,432, filed on Dec. 15, 2023, now Pat. No. 12,677,991.
(60) Provisional application No. 63/488,312, filed on Mar. 3, 2023.
(60) Provisional application No. 63/578,744, filed on Aug. 25, 2023.
(60) Provisional application No. 63/579,122, filed on Aug. 28, 2023.
(60) Provisional application No. 63/579,602, filed on Aug. 30, 2023.
(60) Provisional application No. 63/601,580, filed on Nov. 21, 2023.

(51) Int. Cl. A47J 43/07; A47J 43/044; B01F 27/07; B01F 27/172; B01F 35/30; B01F 35/31; B01F 101/06

(52) U.S. Cl. CPC A47J 43/0755; A47J 43/044; A47J 43/0711; B01F 27/071; B01F 27/172; B01F 35/31; A47J 2043/0449; B01F 2035/352; B01F 2101/06

(57) ABSTRACT

A helical coupling assembly for a micro puree machine includes at least one protrusion on a processing bowl configured to slidably engage a slot on an interior surface of the coupling when the processing bowl is rotated in a clockwise direction. The slots are configured such that, for a certain range of rotation, the slots are not helical to prevent the bowl from disengaging during extrusion of ingredients from the bowl.

### CROSS-REFERENCE TO RELATED APPLICATIONS

This application is a continuation-in-part of each of U.S. application Ser. No. 18/531,807, filed Dec. 7, 2023, which claims priority to U.S. Provisional Patent Application No. 63/578,744, filed Aug. 25, 2023; U.S. application Ser. No. 18/637,768, filed Apr. 17, 2024, which claims priority to U.S. Provisional Patent Application No. 63/579,602, filed Aug. 30, 2023; U.S. application Ser. No. 18/541,432, filed Dec. 15, 2023, which claims priority to U.S. Provisional Patent Application No. 63/601,580, filed Nov. 21, 2023; U.S. application Ser. No. 18/627,745, filed Apr. 5, 2024; U.S. application Ser. No. 18/606,879, filed Mar. 15, 2024; U.S. application Ser. No. 18/606,968, filed Mar. 15, 2024; and U.S. application Ser. No. 18/595,156, filed Mar. 4, 2024, which claims priority to U.S. Provisional Patent Application No. 63/488,312, filed Mar. 3, 2023, and U.S. Provisional Patent Application No. 63/579,122, filed Aug. 28, 2023. The entire contents of each of the applications listed above are incorporated herein by reference for all purposes.

### FIELD OF THE INVENTION

The present disclosure relates to a food processing device and, more particularly, to a micro puree machine.

### BACKGROUND OF THE INVENTION

Domestic kitchen appliances that are intended to make ice creams, gelatos, frozen yogurts, sorbets and the like are known in the art. Typically, a user adds a series of non-frozen ingredients to a mixing bowl, which often has been previously cooled, for example, in a freezer. The ingredients are then churned by one or more paddles (sometimes referred to as dashers) while a refrigeration mechanism simultaneously freezes the ingredients. These devices have known shortcomings including, but not limited to, the amount of time and effort required by the user to complete the ice cream-making process. Machines of this nature are also impractical for preparing most non-dessert food products.

An alternative type of machine known for making a frozen food product may be referred to as a micro-puree machine. Typically, machines of this nature spin and plunge a blade into a pre-frozen ingredient or combination of ingredients. While able to make frozen desserts like ice creams, gelatos, frozen yogurts, sorbets and the like, micro puree machines can also prepare non-dessert types of foods such as non-dessert purees and mousses.

### SUMMARY OF THE INVENTION

In some embodiments, the disclosure describes a coupling assembly for locking a mixing bowl to a coupling of a micro puree machine before processing ingredients in the bowl.

In some embodiments, the coupling assembly of this disclosure includes a bowl, an outer surface of the bowl having at least one protrusion. The coupling assembly also includes a coupling on the micro puree machine. An inner surface of the coupling defines at least one slot for receiving the at least one protrusion when the bowl is rotated relative to the coupling in a first direction. The at least one slot includes a first portion extending at an angle relative to a lower annular surface of the coupling and a second portion extending parallel to the lower annular surface of the coupling. The second portion is configured to engage a corresponding portion of the at least one protrusion to prevent rotation of the bowl in a second direction when a force is applied to the bowl perpendicular to the second portion.

In further embodiments, the at least one protrusion is at least two adjacent protrusions spaced more than 90 degrees apart about an outer circumference of the bowl. In some embodiments, the at least one protrusion is at least two adjacent protrusions spaced less than 90 degrees apart about an outer circumference of the bowl. In some embodiments, the at least one protrusion is at least two adjacent protrusions, each one of the at least two adjacent protrusions having a different width than another of the at least two adjacent protrusions. In some embodiments, the at least one slot is at least two adjacent slots spaced more than 90 degrees apart about the inner surface of the coupling. In some embodiments, the at least one slot is at least two adjacent slots spaced less than 90 degrees apart about the inner surface of the coupling. In some embodiments, the at least one slot is at least two adjacent slots, each one of the at least two adjacent slots having a different opening length than another of the at least two adjacent slots. In some embodiments, the first portion is helical, and the second portion is not helical. In some embodiments, a length of the second portion is less than a third of a total length of the at least one slot.

In other embodiments, the coupling assembly of this disclosure includes a bowl, an outer surface of the bowl having at least two adjacent protrusions. The coupling assembly also includes a coupling on the micro puree machine. An inner surface of the coupling defines at least two adjacent slots for receiving a respective one of the at least two adjacent protrusions when the bowl is rotated relative to the coupling in a first direction. The at least two adjacent protrusions are spaced more than 90 degrees apart about an outer circumference of the bowl.

In further embodiments, the at least two adjacent protrusions include at least three adjacent protrusions, two of the at least three adjacent protrusions being spaced less than 90 degrees apart about the outer circumference of the bowl. In some embodiments, each one of the at least two adjacent protrusions has a different width than another of the at least two adjacent protrusions. In some embodiments, the at least two adjacent slots are spaced more than 90 degrees apart about the inner surface of the coupling. In some embodiments, the at least two adjacent slots is at least three adjacent slots, two of the at least three adjacent slots being spaced less than 90 degrees apart about the inner surface of the coupling. In some embodiments, each one of the at least two adjacent slots has a different opening length than another of the at least two adjacent slots. In some embodiments, each of the at least two adjacent slots includes a first portion extending at an angle relative to a lower annular surface of the coupling, and a second portion extending parallel to the lower annular surface of the coupling. The second portion is configured to engage a corresponding portion of a respective one of the at least two adjacent protrusions to prevent rotation of the bowl in a second direction when a force is applied to the bowl perpendicular to the second portion. In some embodiments, the first portion is helical, and the second portion is not helical. In some embodiments, a length of the second portion is less than a third of the total length of the at least two adjacent slots.

The disclosure describes an extrusion lever mechanism designed to change the extrusion state of a micro puree machine via electronic control. In some embodiments of the disclosure, this control can be either manual or automatic, as selected by the user. The extrusion lever mechanism may be configured to provide a way for the user to retract an extruding plunger in order to remove the processing bowl from the machine.

In some embodiments, the extrusion lever mechanism includes an extrusion lever and a hub configured to receive a portion of the extrusion lever. The hub includes a plurality of inclined planes extending around a diameter of the hub. The extrusion lever mechanism also includes a pin rotationally keyed to the extrusion lever. Each of a manual extrusion position, a neutral position, and a storage position of the extrusion lever corresponds to a position of the pin relative to the plurality of inclined planes.

In some embodiments, the manual extrusion position of the extrusion lever initiates extrusion of processed ingredients from a bowl of the micro puree machine with user input.

In some embodiments, the manual extrusion position of the extrusion lever is between a vertical position and a first radial position.

In some embodiments, the neutral position of the extrusion lever is a vertical position.

In some embodiments, the storage position of the extrusion lever is on a horizontal plane pointing away from a user.

In some embodiments, an automatic extrusion position of the extrusion lever initiates extrusion of processed ingredients from a bowl of the micro puree machine without user input.

In some embodiments, the automatic extrusion position of the extrusion lever is between a vertical position and a second radial position.

In some embodiments, a retraction position of the extrusion lever initiates retraction of a plunger from a bowl of the micro puree machine without user input.

In some embodiments, the retraction position of the extrusion lever is between a vertical position and a third radial position.

In some embodiments, the extrusion lever mechanism further includes at least one microswitch configured to provide information about the position of the extrusion lever to a printed circuit board.

In at least one aspect, this disclosure describes a mechanism that automatically locks a rotating blade, coupling the blade to a processing shaft during processing and/or extrusion of the ingredients. In some implementations, this locking is achieved as an internal pin of the processing shaft moves along an axis prior to startup. The internal pin can include a plunger with sloped wings which engage ball bearings as the internal pin moves into the locked configuration. In some embodiments, the ball bearings are forced outwards, into cavities within a support hub of the blade. When the ball bearings are within the cavities, the blade can be locked to the processing shaft and can then be rotated by a motor to process ingredients in the processing bowl.

The ball bearings also sit within sockets of a coupling which connects the blade to a main shaft around the internal pin. In a home, or unlocked configuration, the blade is not locked to the processing shaft. In the unlocked configuration, the ball bearings are biased towards a central axis and rest within sockets within internal cavities within the coupling. In the unlocked configuration, the ball bearings do not extend far enough outward from the central axis to engage the cavities within the support hub of the blade. In this configuration, the blade can easily be removed by a user as needed for cleaning or replacement. Advantageously, this provides a reliable locking mechanism which allows the blade to be secured to the processing shaft during operation, and safely decoupled from the processing shaft and removed when not in operation.

An example food processing system is provided. The food processing system include a housing. A drive shaft extends from the housing. The drive shaft includes a first end configured to receive a blade assembly and a second end opposing the first end. At least one sensor is configured to detect a position of the second end of the drive shaft to determine if the blade assembly is coupled to the drive shaft or not.

In some implementations, the drive shaft may include an inner shaft and an outer shaft. The drive shaft may include a coupling at the first end configured to couple the drive shaft to the blade assembly. The drive shaft may include a magnet coupled at about the second end. The second end of the drive shaft may be in a first position relative to the sensor when the blade assembly is coupled to the drive shaft and the second end of the drive shaft is in a second position relative to the sensor when the blade assembly is not coupled to the drive shaft. The sensor determines if the blade assembly may be coupled to the drive shaft or not coupled to the drive shaft by determining if the second end of the drive shaft is in the first position or the second position. The sensor may determine that the blade assembly is not coupled to the drive shaft by detecting a magnetic field within its proximity caused a magnet positioned at about the second end of the drive shaft. The sensor may determine that the blade assembly is coupled to the drive shaft by determining an absence of a magnetic field within its proximity. The drive shaft may be coupled to at least one spring. The at least one spring may be configured to exert a force against the drive shaft that pushes the second end of the drive shaft toward the sensor. When the blade assembly is coupled to the drive shaft, the force of the at least one spring may be overcome by the coupling of the blade assembly to prevent the at least one spring from pushing the second end of the drive shaft toward the sensor. When the blade assembly is decoupled from the drive shaft, a force of the at least one spring may push the second end of the drive shaft into sufficient proximity of the sensor whereby the sensor detects the magnetic field of the magnet and the sensor determines that the blade assembly is not coupled to the drive shaft.

An example food processing system is provided. The food processing system includes a housing. A drive shaft extends from the housing. The drive shaft includes a first end configured to receive a blade assembly and a second end opposing the first end. At least one sensor configured to detect a position of the second end of the drive shaft. The second end of the drive shaft is in a first position relative to the sensor when the drive shaft is extending into a mixing container and the second end of the drive shaft is in a second position relative to the sensor when movement of the drive shaft into the container is inhibited by a threshold resistive force.

In some implementations, the threshold resistive force may be determined by a spring force of at least one spring coupled to the drive shaft. The at least one spring may provide a force that pushes the drive shaft away from the sensor. The resistive force may be caused by at least one of a dropped blade assembly, a hard object, and a hard food product. The sensor may include one of a magnetic sensor and a contact switch. The drive shaft may include a coupling at the first end configured to couple the drive shaft to the blade assembly. The food processing system may include a controller. When the sensor detects that the threshold resistive force has been reached or exceeded, the controller may deactivate the drive motor and a position motor. The resistive forces, using the at least one sensor, may be determined by changes in length of the at least one spring in the housing. When the changes in the length of the at least one spring surpasses a threshold, power to the drive motor may be ceased.

An example food processing system is provided. The food processing system includes a lid and a blade assembly within the lid. An extended drive shaft is configured to determine whether the blade assembly is fully engaged within the lid. When the blade assembly is not fully engaged with the lid, the extended drive shaft fully disengages the blade assembly from the lid and drive motor ceases further operation. Otherwise, the extended drive shaft fully engages with the blade assembly to perform a food processing operation.

In some implementations, when the extended drive shaft is fully engaged with the blade assembly, at least two clips of the lid may be engaged with the extended drive shaft. The lid may include at least one lever, and when the extended drive shaft is fully engaged with the blade assembly and the blade assembly is fully engaged with the lid, the at least one lever of the lid may be rotated to an actuating position. The lid may include at least one lever, and when the extended drive shaft is not fully engaged with the blade assembly and pushes the blade assembly out of the lid, the at least one lever of the lid may be rotated to a non-actuating position.

This disclosure includes systems, methods, and devices for storing one or more extrusion components and/or accessories efficiently in a storage container whereby the components are easily accessible to a user to facilitate extrusion of food ingredients from a processing bowl of a micro-puree machine. The micro-puree machine may include a first processing interface, i.e., a mixing interface, where food ingredients are shaved and/or mixed in a processing bowl and a second processing interface, i.e., an extrusion interface, where the mixed and/or processed food ingredients are extruded from the processing container. The processing container may be moveable from the mixing interface to the extruding interface and be re-configurable to enable extrusion of the processed food ingredients when the processing bowl and/or container is coupled to the extrusion interface of the micro-puree machine. At least one extrusion component may have to be added to the processing bowl to re-configure the processing bowl to perform extrusion of processed food ingredients. An extrusion component may include, without limitation, a plunger, plunger lid or cover, an extrusion nozzle, a drip stop, or other extrusion enabling component. A storage assembly and/or storage container may be used to store at least one extrusion component while not in use, i.e., during machine transport or while food ingredients are being processed in the processing bowl when coupled to the mixing interface. The storage container may include a coupler that enables the storage container to couple to the extrusion interface while also being coupled to and/or storing at least one extrusion component in a housing and/or compartment of the storage container.

According to one aspect of the subject matter described in this disclosure, an exemplary processing bowl for a micro-puree machine is provided. The processing bowl includes an extrusion nozzle configured to extrude processed ingredients from the processing bowl. The extrusion nozzle includes an inlet arranged to receive the processed ingredient from the processing bowl and an outlet arranged to output the processed ingredients from the extrusion nozzle. A drip stop, coupled to the extrusion nozzle, is configured to close the outlet in a closed position to block extrusion of the processed ingredients and open the outlet in an open position to allow extrusion of the processed ingredients.

In some implementations, the drip stop may be coupled to the extrusion nozzle via hinge, the drip stop being configured to pivot between the open and closed positions about an axis of rotation of the hinge. The drip stop may be coupled to the hinge at a first end. The drip stop may include a second end opposing the first end, the drip stop including a finger grip positioned at the second end. The second end may be configured to rest on holder while the drip stop is in the open position. The hinge may be biased to move the drip stop to the open position after the drip stop is rotated a portion of an arc of rotation from the closed position toward the open position. The hinge may be coupled to a wall of the extrusion nozzle. The second end may include at least one magnet configured to activate a magnetic sensor of a micro-puree machine when the processing bowl is coupled to the micro puree machine and the drip stop is in the open position.

According to another aspect of the subject matter described in this disclosure, an exemplary micro-puree machine is provided. The micro puree machine includes a base and a processing bowl. The processing includes: an extrusion nozzle configured to extrude processed ingredients from the processing bowl, the extrusion nozzle including an inlet arranged to receive the processed ingredient from the processing bowl and an outlet arranged to output the processed ingredients from the extrusion nozzle; and a drip stop, coupled to the extrusion nozzle, configured to close the outlet in a closed position to block extrusion of the processed ingredients and open the outlet in an open position to allow extrusion of the processed ingredients. A drip tray is configured to collect spillage from the extrusion nozzle, the drip tray positioned in an opening in the base, wherein the drip tray is configured to extend to a position underneath the extrusion to collect spillage.

In some implementations, the drip stop may be coupled to the extrusion nozzle via hinge, the drip stop being configured to pivot between the open and closed positions about an axis of rotation of the hinge. The drip stop may be coupled to the hinge at a first end. The drip stop may include a second end opposing the first end, the drip stop including a finger grip positioned at the second end. The second end may be configured to rest on holder while the drip stop is in the open position. The hinge may be biased to move the drip stop to the open position after the drip stop is rotated a portion of an arc of rotation from the closed position toward the open position. The hinge may be coupled to a wall of the extrusion nozzle. The second end may include at least one magnet configured to activate a magnetic sensor of a micro-puree machine when the processing bowl is coupled to the micro puree machine and the drip stop is in the open position. The drip tray may include a grip for horizontally extending the drip tray to be positioned underneath the extrusion nozzle. The drip tray may be removable from the base for cleaning.

According to another aspect of the subject matter described in this disclosure, an exemplary drip stop for a micro-puree machine processing bowl is provided. The drip stop includes a first end configured to couple to a nozzle of the processing bowl and a second end opposing the first end. A plate is positioned between the first end and the second end. The plate closes an outlet of the nozzle when the drip stop is in a first position to block extrusion of processed ingredients and opening the outlet of the nozzle when in a second position to enable extrusion of the food ingredients.

In some implementations, the second end may include at least one magnet aligning with a hall sensor or a reed switch of the micro-puree machine to trigger extrusion of the food material.

According to one aspect of the subject matter described in this disclosure, an exemplary storage container for a micro-puree machine is provided. The storage container includes an interface coupler configured to detachably connect the storage container to an extrusion interface of the micro-puree machine. A housing is configured to couple at least one extrusion component to the storage container.

In some implementations, the housing may include a component coupler configured to couple the at least one extrusion component to the storage container. The housing may include a compartment, the at least one extrusion component being coupled to the storage container via storage within the compartment. The housing may include a component coupler configured to couple a first extrusion component to the storage container and a compartment configured to store a second extrusion component. The at least one extrusion component may include one of a plunger, plunger lid, extrusion nozzle assembly (e.g., including an extrusion nozzle, extrusion dial and perhaps other components), and a drip stop.

According to another aspect of the subject matter described in this disclosure, an exemplary extrusion storage is provided. The extrusion storage includes a container for storing an extrusion lid and at least one component of a micro-puree machine. A first side of the container is configured to be coupled to the extrusion lid of the micro-puree machine, and a second side of the container is configured to store the at least one component of the micro-puree machine.

In some implementations, the container may be configured to receive internally the at least one extrusion component. The extrusion lid may include an opening for receiving a shaft positioned within the micro-puree machine. The extrusion lid may include a plunger used by the micro-puree machine for extruding the food material. The container may include a plurality of protruding sections for securely attaching the extrusion lid. The container may include a plurality of radial dials that bayonets on the micro-puree machine. The at least one extrusion component may be a removable drip stop for an extrusion nozzle of the micro-puree machine. The at least one extrusion component may be a nozzle of the micro-puree machine. The extrusion storage may include a cover for protecting the nozzle when stored in the first side of the container.

According to another aspect of the subject matter described in this disclosure, an exemplary extrusion storage is provided. The extrusion storage includes an extrusion component used in extruding food material from a micro-puree machine. An extrusion lid of the micro-puree machine, the extrusion lid configured to protect at least one internal component of the micro-puree machine when a processing bowl of the micro-puree machine is removed. A container for storing the extrusion component and the extrusion lid of the micro-puree machine. A first side of the container is configured to internally receive and protect the extrusion component and a second side of the container configured to be coupled to the extrusion lid resulting in an assembled container. The assembled container is attached to the micro-puree machine.

In some implementations, the extrusion lid may include an opening for receiving a shaft positioned within the micro-puree machine. The extrusion lid may include a plunger used by the micro-puree machine for extruding the food material. The container may include a plurality of protruding sections for securely attaching the extrusion lid. The assembled container may include a plurality of radial dials that bayonets on the micro-puree machine. The extrusion component may be a removable drip stop for an extrusion nozzle of the micro-puree machine. The extrusion component may be a nozzle of the micro-puree machine. The extrusion may include a cover for protecting the nozzle when stored on the first side of the container.

In some embodiments, the disclosure describes an automated additive assembly for a micro-puree machine for pushing additive ingredients to be injected into the extruded product at the nozzle location. Advantageously, the additive assembly may reduce user interaction with the additive ingredients and the with machine housing to produce the final product.

In embodiments, the automated additive assembly of this disclosure includes a body including a reservoir configured for holding an additive ingredient. The body has a channel alignable with a nozzle of the micro-puree machine. A plunger is configured for movement within the reservoir. Movement of the plunger within the reservoir in a first direction forces the additive ingredient into the channel.

In further embodiments, the body includes a passage in fluid communication with the reservoir and the channel. Movement of the plunger within the reservoir in the first direction forces the additive ingredient through the passage. In embodiments, the passage includes a circumferential groove at least partially surrounding and in fluid communication with the channel. In embodiments, the automated additive assembly further includes a lid configured to be secured to an open first end of the body such that an interface between the lid and the body forms a seal. In embodiments, the lid defines an opening in communication with the channel. The opening is configured to fluidly connect to the nozzle. In embodiments, a connector on the plunger extends through an opening in the reservoir. In embodiments, the connector is configured for attachment to a rod for moving the plunger within the reservoir. In embodiments, the automated additive assembly is configured such that forcing the additive ingredient into the channel combines the additive ingredient with the processed ingredients extruded through the nozzle.

In other embodiments, a micro-puree machine of this disclosure includes a bowl attachable to the micro-puree machine. The bowl is configured to house primary ingredients within an interior volume of the bowl. The micro-puree machine also includes a blade for processing the primary ingredients within the interior volume of the bowl. The micro-puree machine also includes a nozzle for extruding the processed ingredients from the interior volume of the bowl. The micro-puree machine also includes an automated additive assembly having a body including a reservoir configured for holding an additive ingredient. The body has a channel alignable with the nozzle. A plunger is configured for movement within the reservoir. Movement of the plunger within the reservoir in a first direction forces the additive ingredient into the channel.

In further embodiments, the body includes a passage in fluid communication with the reservoir and the channel. Movement of the plunger within the reservoir in the first direction forces the additive ingredient through the passage. In embodiments, the passage includes a circumferential groove at least partially surrounding and in fluid communication with the channel. In embodiments, the micro-puree machine further includes a lid configured to be secured to an open first end of the body such that an interface between the lid and the body forms a seal. In embodiments, the lid defines an opening in communication with the channel. The opening is configured to fluidly connect to the nozzle. In embodiments, a connector on the plunger extends through an opening in the reservoir. In embodiments, the connector is configured for attachment to a rod for moving the plunger within the reservoir. In embodiments, the micro-puree machine is configured such that the forcing the additive ingredient into the channel combines the additive ingredient with the processed ingredients extruded through the nozzle.

Embodiments of a method of adding an additive ingredient to processed ingredients in a micro-puree machine of this disclosure include processing the ingredients within a bowl of the micro-puree machine. The bowl is configured to allow extrusion of the processed ingredients through a nozzle. The method also includes adding an additive ingredient to the processed ingredients with an automated additive assembly. The automated additive assembly includes a body including a reservoir configured for holding an additive ingredient. The body has a channel alignable with the nozzle. A plunger is configured for movement within the reservoir. Movement of the plunger within the reservoir in a first direction forces the additive ingredient into the channel.

In further embodiments, the method includes adding the additive ingredient to the reservoir. In embodiments, the method includes moving the plunger through the reservoir such that the additive ingredient is moved out of the reservoir and extruded from the channel while the processed ingredients are extruded through the nozzle. In embodiments, the method includes operatively connecting the plunger to a rod for moving the plunger through the reservoir.

A reading of the following detailed description and a review of the associated drawings will make apparent the advantages of these and other structures. Both the foregoing general description and the following detailed description serve as an explanation only and do not restrict aspects of the disclosure as claimed.

### BRIEF DESCRIPTION OF THE DRAWINGS

The above-mentioned and other features and advantages of this disclosure, and the manner of attaining them, will become more apparent and the disclosure itself will be better understood by reference to the following descriptions of embodiments of the disclosure taken in conjunction with the accompanying drawings, wherein:

FIG. 1A shows an isometric view of a micro-puree machine, according to some embodiments of the disclosure.

FIG. 1B shows the micro-puree machine of FIG. 1A with the bowl assembly disassembled from the housing, according to some embodiments of the disclosure.

FIGS. 1C-1G illustrate embodiments of extrusion assemblies, bowl assemblies, and/or nozzle assemblies of the micro-puree machine of FIG. 1A, according to some embodiments of the disclosure.

FIG. 2A illustrates a portion of another micro-puree machine, according to some embodiments of the disclosure.

FIG. 2B illustrates a reversible bowl assembly that may be coupled to the micro-puree machine of FIG. 2A, according to some embodiments of the disclosure.

FIG. 3A shows another reversible bowl assembly, according to some embodiments of the disclosure.

FIG. 3B shows a blade of the reversible bowl assembly of FIG. 3A, according to some embodiments of the disclosure.

FIG. 3C is a cut-away view of the reversible bowl assembly and first lid of FIGS. 3A and 3B, according to some embodiments of the disclosure.

FIG. 3D shows a detailed view of an embodiment of a plunger coupled to the underside of second lid, according to some embodiments of the disclosure.

FIGS. 4A and 4B illustrate the use of the reversible bowl assembly of FIGS. 3A-3D, according to some embodiments of the disclosure.

FIGS. 5A-5M illustrate additional micro-puree machines, according to some embodiments of the disclosure.

FIGS. 6A-6D illustrate a helical coupling assembly of the bowl to the machine, according to some embodiments of the disclosure.

FIGS. 7A and 7B illustrate rotation of the bowl into the coupling of the micro puree machine according to some embodiments of the disclosure.

FIG. 8A shows another assembled view of a micro puree machine according to some embodiments of the disclosure.

FIGS. 8B-8E illustrate an extrusion lever mechanism of the micro puree machine of FIG. 8A according to some embodiments of the disclosure.

FIGS. 9A-9F show various configurations of the blade assembly of this disclosure with serrated grooves according to some embodiments.

FIGS. 10A-10C show cross sectional views of a locking mechanism and related components in an unlocked configuration in accordance with this disclosure.

FIGS. 11A-1C are similar cross sections views to FIGS. 10A-10C, but also show surrounding components of the micro puree machine in accordance with this disclosure.

FIG. 12A-12C show cross sectional views of a locking mechanism and related components in a locked configuration in accordance with this disclosure.

FIGS. 13A-13C are similar cross sections views to FIGS. 12A-12C, but also show surrounding components of the micro puree machine in accordance with this disclosure.

FIGS. 14A-14B show an alternate embodiment of a locking mechanism in accordance with this disclosure.

FIGS. 15A-15E show another alternate embodiment of a locking mechanism in accordance with this disclosure.

FIG. 16A is an isometric view of a device according to an exemplary embodiment of the present disclosure including a bowl assembly and lid assembly.

FIG. 16B is another isometric view of the device of FIG. 16A without the bowl assembly and lid assembly.

FIG. 17A illustrates a cross-sectional view of a micro puree machine including a kill switch configured to detect when a drive shaft is obstructed from moving downward within a mixing container.

FIG. 17B illustrates the arrangement a drive shaft of a micro puree machine when kill switch is not activated.

FIG. 17C illustrates an arrangement of the drive shaft where a kill switch is activated when a blade is dropped.

FIGS. 18A-18C illustrates an alternative configuration of a drive shaft and sensor used to detect when the drive shaft downward movement in a container is blocked.

FIGS. 19A-19D illustrate an example extended drive shaft used to determine if a blade assembly is properly positioned in a lid.

FIGS. 20A-20C are schematic diagrams of an example extrusion nozzle assembly used with a micro-puree machine.

FIGS. 21A-21B are schematic diagrams of different views of the extrusion nozzle assembly of FIGS. 20A-20C.

FIGS. 22A-22B are schematic diagrams of cross-sectional views of the extrusion nozzle assembly of FIGS. 20A-20C.

FIG. 23 is a schematic diagram of a micro-puree machine with an example drip tray and an example extrusion storage.

FIGS. 24A-24B are detailed schematic diagrams of the drip tray of FIG. 23.

FIGS. 25A-25C are detailed schematic diagrams of the extrusion storage of FIG. 23.

FIGS. 26A-26B are schematic diagrams of another example extrusion storage.

FIG. 27 illustrates an aeration system, according to some embodiments of the disclosure.

FIGS. 28A-28C illustrate an automated additive assembly for use with the micro-puree machine of FIG. 1A, according to some embodiments of this disclosure.

FIGS. 28D-28F further illustrate components of the additive assembly of FIGS. 28A-28C, according to some embodiments of the disclosure.

FIGS. 28G-28K illustrate the use of the additive assembly of FIGS. 28A-28C, according to some embodiments of the disclosure.

FIG. 29 illustrates the use of another automated additive assembly, according to some embodiments of this disclosure.

### DESCRIPTION OF THE INVENTION

The following description is provided to enable those skilled in the art to make and use the described embodiments contemplated for carrying out the invention. Various modifications, equivalents, variations, and alternatives, however, will remain readily apparent to those skilled in the art. Any and all such modifications, variations, equivalents, and alternatives are intended to fall within the spirit and scope of the present invention.

In the following description, like components have the same reference numerals, regardless of different illustrated embodiments. To illustrate embodiments clearly and concisely, the drawings may not necessarily reflect appropriate scale and may have certain structures shown in somewhat schematic form. The disclosure may describe and/or illustrate structures in one embodiment, and in the same way or in a similar way in one or more other embodiments, and/or combined with or instead of the structures of the other embodiments.

In the specification and claims, for the purposes of describing and defining the invention, the terms “about” and “substantially” represent the inherent degree of uncertainty attributed to any quantitative comparison, value, measurement, or other representation. The terms “about” and “substantially” moreover represent the degree by which a quantitative representation may vary from a stated reference without resulting in a change in the basic function of the subject matter at issue. Open-ended terms, such as “comprise,” “include,” and/or plural forms of each, include the listed parts and can include additional parts not listed, while terms such as “and/or” include one or more of the listed parts and combinations of the listed parts. Use of the terms “top,” “bottom,” “above,” “below” and the like helps only in the clear description of the disclosure and does not limit the structure, positioning and/or operation of the disclosure in any manner.

It is also to be understood that the specific devices illustrated in the attached drawings, and described in the following specification, are simply exemplary embodiments of the concept. Hence, specific dimensions and other physical characteristics related to the embodiments disclosed herein are not to be considered as limiting.

The word “comprising” and “comprises”, and the like, does not exclude the presence of elements or steps other than those listed in any claim or the specification as a whole. In the present specification, “comprises” means “includes” and “comprising” means “including.”

As used herein, “at least one of” is synonymous with “one or more of.” For example, the phrase “at least one of A, B, or C” means any one of A, B, or C, or any combination of any two or more of A, B, or C. For example, “at least one of A, B, and C” includes A alone; or B alone; or C alone; or A and B; or A and C; or B and C; or all of A, B, and C.

The term “at least” is synonymous with “greater than or equal to.” The terms “first”, “second”, and the like are not intended to refer to any particular order or chronology, but refer to different conditions, properties, or elements. As used herein, the singular form of “a”, “an”, and “the” include plural referents unless the context clearly dictates otherwise.

Notably, the mechanisms and techniques described herein may be used to configure a machine to process (e.g., micro-puree and perhaps aerate) and extrude ice cream and other frozen ingredients. That is, both the processing and extrusion functions can be performed by a single machine. In such a machine, a same shaft may be used to drive a blade to process the frozen ingredients in a bowl (i.e., a container) and to drive a plunger to extrude the processed ingredients from the bowl. Further, such a machine may include a user interface enabling a user to control the timing of the performance of each function. In some implementations of such a machine, a first shaft may be used to drive processing and a second shaft may be used to drive extrusion, and such implementations may be considered to have a first sub-system or module for processing and a second sub-system or module for extrusion.

In some embodiments, a single lid may be provided (e.g., on an open end of the bowl) that houses (or is coupled to) a blade for processing ingredients, and that also houses (or is coupled to) a plunger for extruding the processed ingredients. In such embodiments, a single shaft driven by one or more motors (e.g., one motor for driving rotation of blade; the other motor for driving linear movement of the driven shaft along its axis) may drive both the processing that uses the blade and the extrusion that uses the plunger, as described in more detail elsewhere herein, and an end of the bowl opposite the lid may include an opening for extrusion of the processed ingredients from the bowl.

In other embodiments, to enable the performance of both functions, the user may flip the processing bowl from a first arrangement, in which the driven shaft engages a blade at a first end of the processing bowl (e.g., the blade housed in or coupled to a first lid at a first open end of the processing bowl), to a second arrangement, in which the driven shaft engages a plunger at a second end of the processing bowl (e.g., the plunger housed in or coupled to a second lid at an open second end of the processing bowl), as described in more detail herein. In such embodiments, the first lid also may include an opening for extruding the ingredients from the bowl during extrusion using the plunger in the second arrangement. Further, in such embodiments, a single shaft driven by one or more motors may drive both the processing by use of the blade and the extrusion by use of the plunger, as described in more detail elsewhere herein.

In other embodiments, to enable the performance of both functions, the user may replace a first lid (e.g., housing or coupled to a blade) for processing from an open end of the processing bowl with a second lid (e.g., housing or coupled to a plunger) for extruding, as described in more detail elsewhere herein. In such embodiments, a single shaft driven by one or more motors may drive both the processing by use of the blade and the extrusion by use of the plunger, or alternatively, a separate shaft may be used for extruding, in which such separate shaft drives the plunger, as described in more detail elsewhere herein.

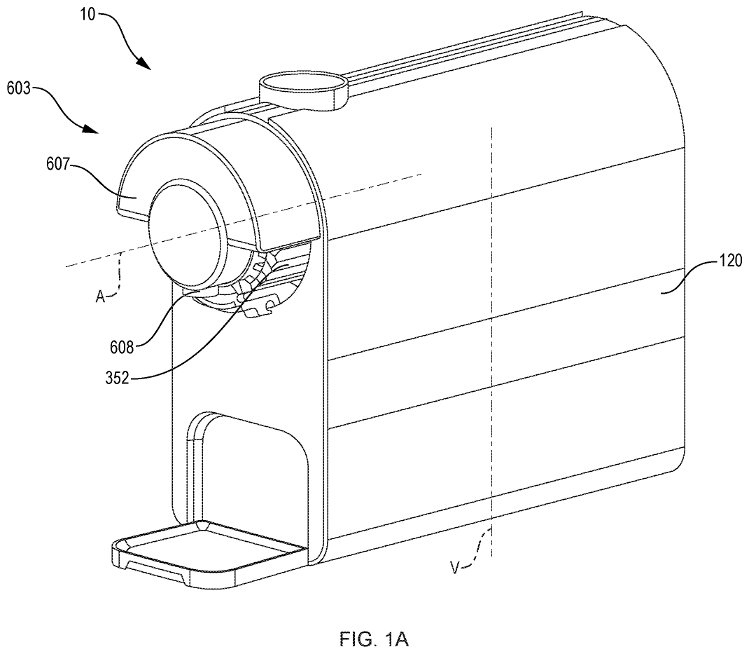

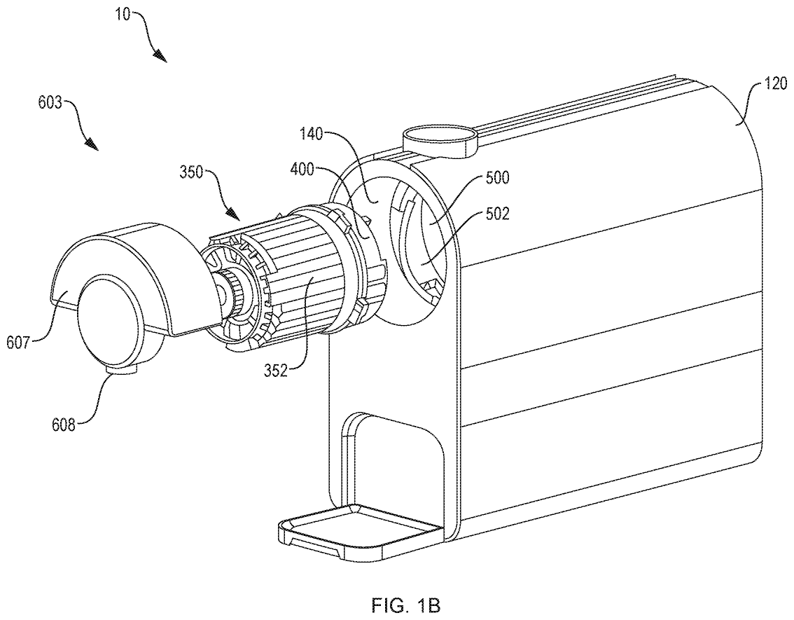

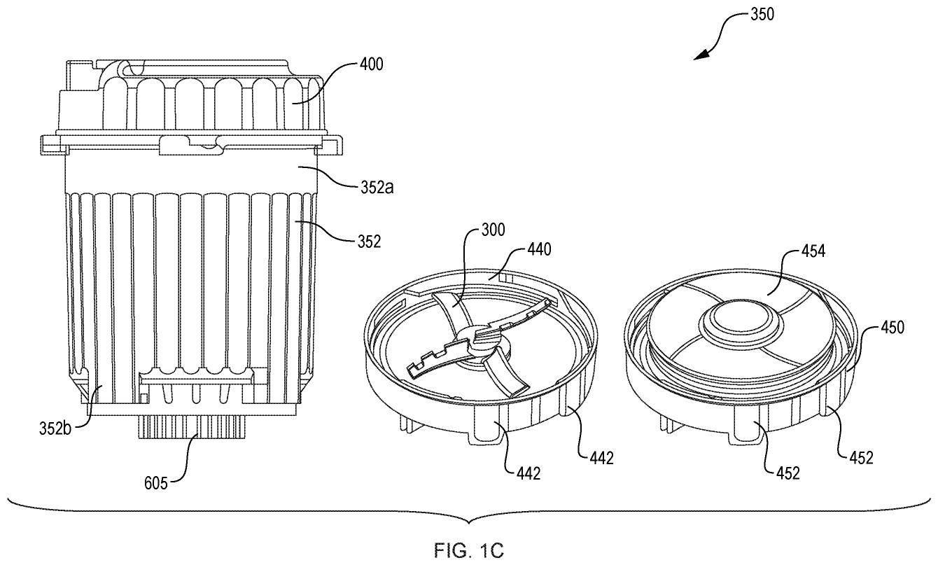

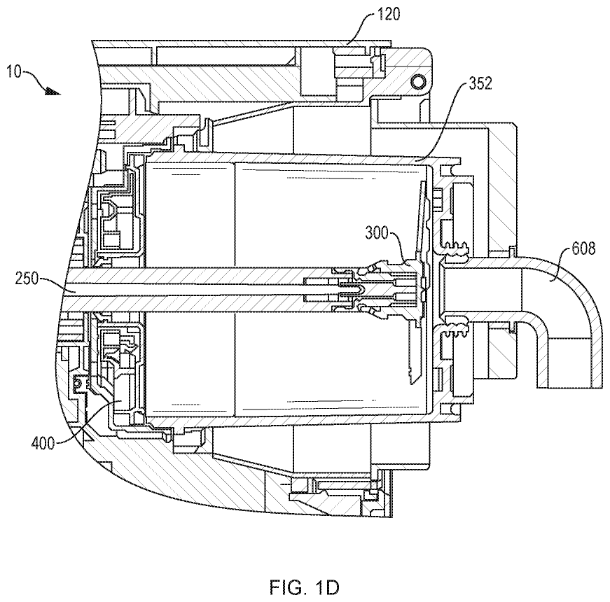

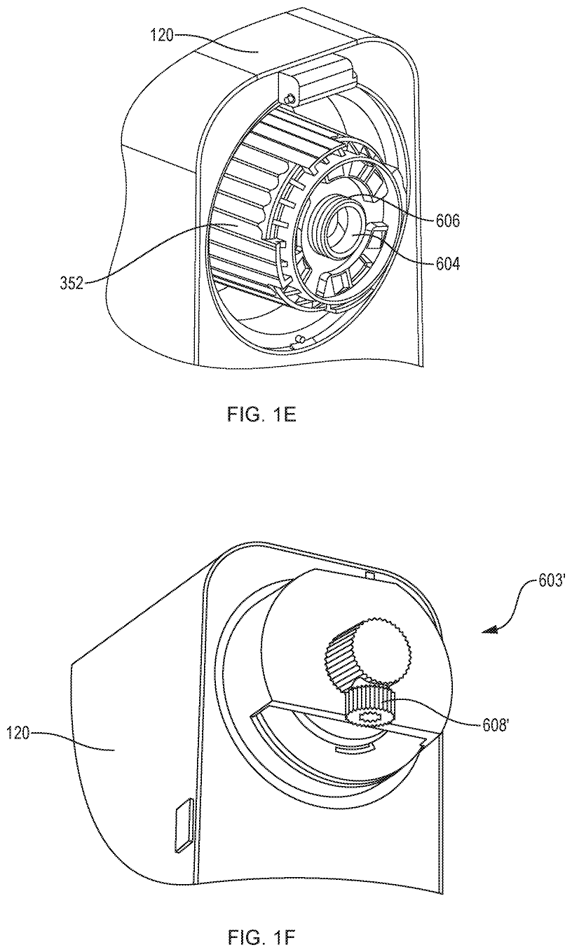

FIG. 1A shows an isometric view of a micro-puree machine 10, according to some embodiments of the disclosure. FIG. 1B shows the micro-puree machine 10 of FIG. 1A with the bowl assembly 350 disassembled from the housing 120 according to some embodiments of the disclosure. FIGS. 1C-1G illustrate embodiments of the extrusion assemblies, bowl assemblies, and/or nozzle assemblies, according to some embodiments of the disclosure.

The micro-puree machine 10 may include a housing 120, which may include a user interface (not shown) for receiving user inputs to control the micro-puree machine 10 and/or display information. The micro-puree machine 10 also may include a bowl assembly 350 and a nozzle assembly 603. The combination of a bowl assembly 350, which may include a lid 400 configured for extruding, and a nozzle assembly 605 may be referred to herein as an extrusion assembly. The nozzle assembly 603 may include a nozzle housing 607 and a nozzle 608.

The bowl assembly 350 may include a bowl 352 configured to contain one or more processed ingredients, ingredients to be processed, or ingredients being processed. A user may couple the bowl assembly 350 to the housing 120 by rotating the bowl assembly 350 relative to the housing 120 (e.g., using screwing threads or a bayonet connection), or by another coupling mechanism and/or technique. The bowl assembly 350 may be assembled to the housing 120 such that a central axis A of the bowl assembly 350 extends perpendicular to a vertical axis V of the housing 120, as shown. However, the disclosure contemplates that the bowl assembly 350 may be assembled to the housing 120 such that the central axis A extends at an angle between 0 and 90° to the vertical axis, for example, as described in U.S. Pat. No. 11,759,057 to SharkNinja Operating, LLC, the entire contents of which are hereby incorporated by reference (the '057 patent), or such that the central axis of the bowl assembly 350 extends parallel to the vertical axis V, for example, as described in U.S. Pat. No. 11,871,765 to SharkNinja Operating, LLC, the entire contents of which are hereby incorporated by reference (the '756 patent). In embodiments, the bowl 352 of the bowl assembly 350 can be manufactured from a disposable material to enhance the convenience of using the micro-puree machine 10. Further, the bowl 352 can be sold as a stand-alone item and can also be prefilled with ingredients to be processed during use of the micro-puree machine 10.

As shown in FIG. 1B, the housing 120 may including a coupling 500 disposed within an opening 140 of the housing 120. An inner surface 502 of the coupling 500 may comprise locating and locking elements for positioning and connecting the bowl assembly 350 to the coupling 500 in two different configurations, as described elsewhere herein. The micro-puree machine 10 may further include a nozzle 608 couplable to the bowl assembly 350 for extruding processed ingredients from the bowl assembly 350. The nozzle 608 may be arranged such that the ingredients are extruded in a vertically downward direction such that a user can place an ice cream cone, cup, bowl, or other edible or non-edible receptacle underneath the nozzle to receive extruded ingredients. The disclosure also contemplates that multiple nozzle shapes may be provided to allow for user customizability. For example, multiple nozzles may be included on a rotatable dial that allows the user to select the desired nozzle shape. In further embodiments, the extrude function may be integrated into a program on the user interface with a predetermined translation speed/flow rate.

As shown in FIG. 1C, the first end 352a of the bowl 352 may be configured to couple to both a first lid 440 and the second lid 450. The first lid 440 may include a blade 300 for processing ingredients, for example, a blade as described in the '765 patent. When the lid 440 is coupled to the bowl 352 (e.g., via reciprocal threading on the bowl and lid), the bowl assembly 350 may be considered to be in a processing configuration and may be coupled to the housing via coupling 500. The lid 440 may have locating and locking elements 442 on its exterior sidewall configured to couple to the locating and locking elements on the inner surface 502 of the coupling 500. The second lid 450 may include a plunger 454 for extruding ingredients. The plunger 454 may furthermore include a flexible seal around its perimeter to ensure contact (e.g., maximum contact) with the sidewall of the bowl 352 to allow for optimal (e.g., maximum) extrusion yield. When the lid 450 is coupled to the bowl 352 (e.g., via reciprocal threading on the bowl and lid), the bowl assembly 350 may be considered to be in an extruding configuration and may be coupled to the housing via coupling 500. The lid 450 may have locating and locking elements 452 on its exterior sidewall configured to couple to the locating and locking elements on the inner surface 502 of the coupling 500.

The second end 352b of the bowl 352 may include a centrally located opening 604, or an opening that is not centrally located, including a coupling collar 606. The coupling collar 606 may include threading or other types of coupling features, for example, slots or cams, e.g., for bayoneting. The opening 604 may be enclosed by a cap 605, for example, during processing, which cap may be removed during extruding. The cap 605 may include interior threading (not shown) or other coupling features that allow it to couple to the coupling collar 606. The opening 604 may further be in fluid communication with a nozzle 608. For example, the opening 604 may be in fluid communication with a nozzle through a conduit (e.g., plastic tubing) that extends from the opening 604 to the nozzle 608, e.g., within nozzle assembly 603. In embodiments, such a conduit may include one or more sections connected by joints (e.g., an elbow joint) to translate the direction (e.g., horizontal) of extrusion from opening 604 to a direction (e.g., vertically downward) of extrusion from the nozzle 608.

As shown in FIG. 1D, the user may attach the first lid 440 to the bowl 352 and couple the bowl assembly 350 to the micro-puree machine 10 using the coupling features described herein. The lid 440 may be configured (e.g., as described in the '765 patent) such that, when the lid 440 is coupling to the housing 120, the blade 300 engages a driven shaft 250 and disengages the lid 440. Through use of a user interface (e.g., as described in the '057 patent), the user may activate a program that controls the blade 300 to rotate and move (e.g., descend or move horizontally or at an angle) into the ingredients in the bowl 352 to process (e.g., micro-puree) them. It should be appreciated that in some embodiments, as shown in FIG. 1D, the nozzle assembly 603 or one or more components thereof (e.g., nozzle 608) may be coupled to the second end 352b of the bowl 350 (and perhaps to the housing) even when extrusion is not being performed, e.g., during processing. In such embodiments, the opening 604 may be closed, for example, using cap 605 or by other means. FIG. 1E is a bottom view of the bowl assembly 350 while coupled to the housing, in which the opening 604 is not covered. In actual use, the opening 604 may be closed, e.g., by cap 605, during processing, or open and coupled to the nozzle assembly 603 during extrusion.

After processing the ingredients in the bowl 352, the user then may remove the bowl assembly 350 from the micro-puree machine 10, remove the first lid 440 from first end 352a, replace it with lid 450 on the first end 352a, couple the nozzle assembly to the second end 352b of the bowl assembly 350 if not already attached, couple the bowl assembly 350 to the housing 120, and initiate extrusion via the user interface. During extrusion, the driven shaft drives the plunger 602 from the first end 352a of the bowl 352 to the second end 352b of the bowl, forcing the processed ingredients to extrude the processed ingredients through the opening 604 and through the nozzle 608.

FIG. 1F illustrates another embodiment of a nozzle assembly 603′, including nozzle 608′, which may be used to extrude processed ingredients, for example, using mechanisms and techniques described herein.

FIG. 1G illustrates another bowl assembly 350′ including the extrusion assembly 600 according to some embodiments of the disclosure. As shown in FIG. 1G, the bowl assembly 350′ may include a nozzle 608′ that is integrated with the bottom edge of the bowl 352′, for example, on the sidewall of the bowl 352′ proximate to a second end 352b′ or extending past the second end 352b′. In embodiments, the bowl assembly 350′ may be configured to be installed to the coupling 500 such that the nozzle 608′ faces vertically downwards when the bowl 352′ is properly installed. During extrusion, the movement of the plunger (e.g., plunger 454) will force the processed ingredients through the nozzle 608′. The nozzle 608′ may be selectively located on the bowl 352′ to optimize the amount of processed ingredients that can be extruded, thus minimizing the amount of yield loss after extrusion. For example, the nozzle 608′ may be located near the bottom edge of the bowl 352′, as shown in FIG. 1G. However, the disclosure contemplates that the nozzle 608′ may alternatively be located at a different longitudinal and/or radial position on the bowl 352′. Bowl assembly 350′ and/or bowl 352′ maybe be the same or different than bowl assembly 350 and/or bowl 352, respectively.

Advantageously, the micro-puree machine 10 may include a sensor (not shown) that recognizes which lid is installed into the machine 10 to restrict certain programs based on the lid functions, which may prevent user error when operating the machine 10. For example, the micro-puree machine may only activate the blade 300 when the sensor detects that the bowl 352 is installed in the first configuration in which lid 440 is coupled to bowl 350 and may only activate the plunger 602 when the sensor detects that the bowl 352 is installed in the second configuration in which lid 440 is coupled to bowl 350. For example, each of lids 440 and 450 may include distinctive physical and/or electromagnetic features, e.g., as part of locating and locking elements 442 and 452, respectively, for which coupling 500 or other elements of the micro-puree machine 10 may be configured to detect and distinguish lid 440 from lid 450.

The housing 120 may house one or more motors and a transmission system (e.g., including gearing) that drive a driven shaft (e.g., driven shaft 250) for engaging the blade 300 and/or plunger 454 when the bowl assembly 350 (coupled to lid 440 or 450, respectively) is coupled to the housing for processing or extruding, respectively, for example, as described in the '765 patent or U.S. Pat. No. 11,882,965 to SharkNinja Operating, LLC (the '965 patent), the entire contents of which are hereby incorporated by reference. For example, the one or more motors may include a first motor for driving rotation of the driven shaft 250 via the transmission, which may be used to drive the rotation of the blade 300 during processing, and, if desired (but not necessary) rotating the plunger 454 during extrusion. A second motor may be configured to move the position of the driven shaft 250, via the transmission, along its axis (e.g., back and forth; or up and down), which may be used to drive the back and forth movement of the blade 300 into and out of the bowl 350 during processing, and to move the plunger 454 into and out of the bowl 350 during extrusion. In embodiments, the micro-puree machine 10 may include gearboxes (e.g., high ratio gearboxes) and reinforced internals (not shown) to allow an extrusion assembly as described herein to withstand high forces and extrude thick outputs from the nozzle 608.

In some embodiments of the disclosure, a reversible bowl assembly may be used, which does not require that a lid be removed between processing and extruding. For example, the reversible bowl assembly may include: a first lid coupled at one end including a blade for processing and an opening for extruding; and a second lid at the other end including a plunger for extruding. Examples of such embodiments will now be described.

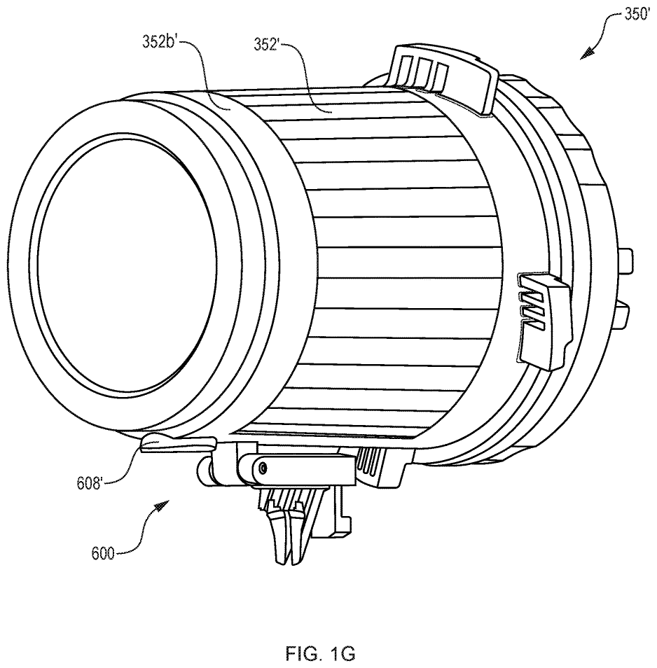

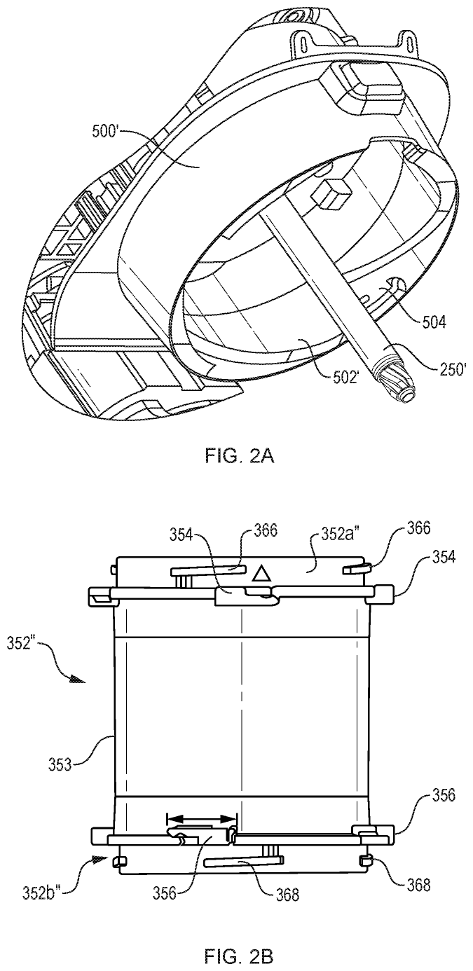

FIG. 2A illustrates an embodiment of a portion of a micro-puree machine including a coupling 500′ for coupling to a bowl assembly, for example, a reversible bowl assembly, in accordance with some embodiments of the disclosure. FIG. 2B illustrates an embodiment of a reversible bowl 352″ that may be coupled to coupling 500′. The bowl 352″ may include any of a variety of external surfaces. For example, embodiments of the bowl may have a ribbed or corrugated surface (e.g., like bowl 352 or 352′), or a smooth surface (e.g., bowl 352″). Similarly, bowls 352 and 352″ may have any variety of surfaces, including smooth surfaces.

As shown in FIG. 2A, the driven shaft 250 of the micro-puree machine 10 may extend from the housing 120 into an interior of the coupling 500′ and optionally all the way through the interior of the coupling 500′. The inner surface 502′ of the coupling 500′ may comprise one or more slots 504 sized and shaped to receive at least one projection 354 on an outer surface of a first open end 352a″ of the bowl 352″. In embodiments, both the first end 352a″ and the second end 352b″ of the bowl 352″ may be open-that is, both the first end 352a″ and the second end 352b″ may not have a top or bottom wall and/or a lid. However, the disclosure is not so limited, and one or both ends 352a″, 352b″ of the bowl 352″ may be closed with a wall or a lid. In embodiments, the at least one projection 354″ on the bowl 352″ may be four projections 354 spaced 90 degrees apart about an outer surface of the first end 352a″ of the bowl 352″. However, the disclosure contemplates more or fewer than four projections 354. In a first configuration of the reversible bowl assembly 350″, the user may rotate the bowl 352″ relative to the coupling 500′ such that the projections 354 are rotated into the slots 504, coupling (e.g., locking) the bowl 352″ and the coupling 500 together.

The slots 504 also may be sized and shaped to receive at least one projection 356 on an outer surface of a second open end 352b″ of the bowl 352″. In embodiments, the at least one projection 356 may be four projections 356 spaced 90 degrees apart about an outer surface of the second end 352b″ of the bowl 352″. However, the disclosure contemplates more or fewer than four projections 356. In a second configuration of the reversible bowl assembly 350″, the user may rotate the bowl 352″ relative to the coupling 500′ such that the projections 356 are rotated into the slots 504, coupling (e.g., locking) the bowl 352″ and the coupling 500′ together. The first end 352a″ of the bowl 352″ may further comprise threads 366 for coupling to a first lid, while the second end 352b″ of the bowl 352″ may comprise threads 368 for coupling to a second lid, as further described elsewhere herein.

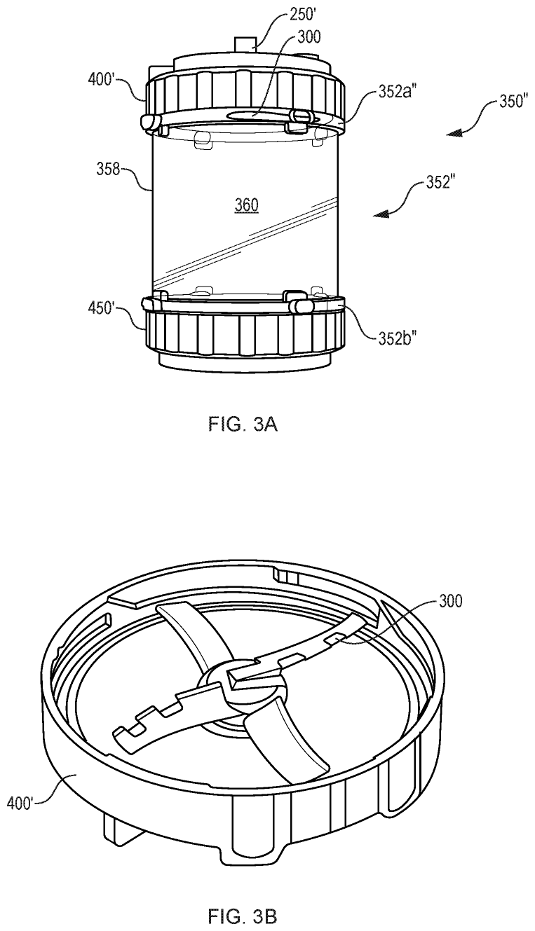

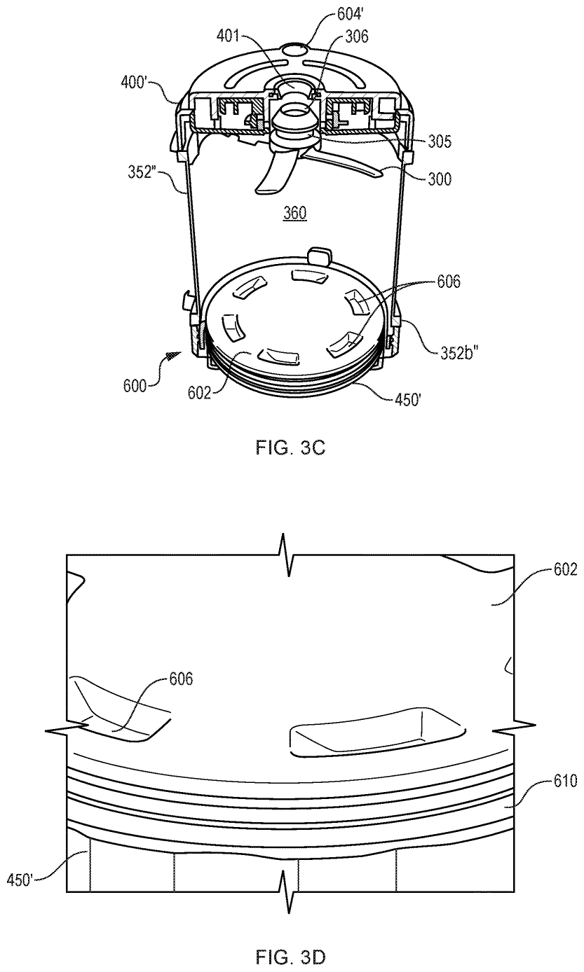

FIG. 3A shows an embodiment of the reversible bowl assembly 350″, assembled according to some embodiments of the disclosure. As shown in FIG. 3A, the bowl 352″ may have an oblong shape and include a cylindrical sidewall 358 defining an interior volume 360 of the bowl 352″. The sidewall 358 may extend between the first open end 352a″ of the bowl 352″ and the second open end 352b″ opposite the first open end 352a″. Embodiments of the sidewall 358 may have various configurations. For example, a cross-section of the sidewall may be circular or polygonal. In addition, a diameter of the sidewall may vary between the first open end 352a″ and the second open end 352b″ (e.g., may be tapered). The first open end 352a″ and the second open end 352b″ may communicate with the interior volume 360 of the bowl 352″. The assembly 350″ may further include a first lid 400′ removably couplable to the first open end 352a″ of the bowl 352″. The first lid 400′ may define an opening 401 (FIG. 3C) configured to couple to a blade 300 for mixing ingredients within the bowl 352″. When the bowl 352″ is installed to the coupling 500′ in the first configuration, the blade 300 may engage with the driven shaft 250′ to rotate and plunge the blade 300 within the ingredients. FIG. 3B shows an embodiment of the blade 300 coupled to the underside of first lid 400'. Some non-limiting examples of the blade 300 are shown in the '765 patent.

FIG. 3C is a cut-away view of the reversible bowl assembly 350″ and the first lid 400', according to some embodiments of the disclosure, whereas blade 300 and a second lid 450′ are not shown in cut-away form. As shown in FIG. 3C, the blade 300 may include a central support hub 305 including a central opening 306 for engaging the driven shaft 250. In embodiments, the second lid 450′ may removably couple to the second open end 352b″ of the bowl 352″. The second lid 450′ may include, or be coupled to, a plunger 602 for pushing the ingredients in the bowl 352″ toward an opening 604 in first lid 400'. The plunger 602, alone or in combination with other components (e.g., the second lid 450', the bowl 352″, or the nozzle 608), may constitute an extrusion assembly 600 for extruding processed ingredients from the bowl 352″. The opening 604′ in the first lid 400′ may further be in fluid communication with a nozzle (e.g., nozzle 608). For example, the opening 604′ may be in fluid communication with a nozzle through a conduit (e.g., plastic tubing) that extends from the opening 604′ to the nozzle. In embodiments, such a conduit may include one or more sections connected by joints (e.g., an elbow joint) to translate the direction (e.g., horizontal) of extrusion from opening 604 to a direction (e.g., vertically downward) of extrusion from the nozzle.

The plunger 602 may be couplable to the driven shaft 250′ of the micro-puree machine when the bowl assembly 350″ is in the second configuration and the bowl 352″ is installed to the coupling 500'. A surface of the plunger 602 facing the interior volume 360 may include a one or more (e.g., a plurality of) indentations 606. The indentations 606 may prevent frozen ingredients from rotational movement within the bowl 352″ during processing by the blade 300. The plunger 602 may furthermore include a flexible seal 610 around its perimeter to ensure contact (e.g., maximum contact) with the sidewall 358 of the bowl 352″ to allow for optimal (e.g., maximum) extrusion yield.

The micro-puree machine of the embodiments described in relation to FIGS. 2A, 2B, 3A-3D, 4B and 4B may include one or more motors and a transmission system (e.g., including gearing) that drive a driven shaft (e.g., driven shaft 250') for engaging the blade assembly 300 and/or plunger 602 when the bowl assembly 350″ (coupled to lid 400′ or 450′, respectively) is coupled to the housing for processing or extruding, for example, as described in the '765 patent or the '965 patent; and may include gearboxes (e.g., high ratio gearboxes) and reinforced internals (not shown) to allow the extrusion assembly 600 to withstand high forces and extrude thick outputs from a nozzle.

FIG. 3D shows a detailed view of an embodiment of the plunger 602 coupled to the underside of second lid 450′. In embodiments, the bowl assembly 350″ may be configured such that only the first lid 400′ can couple to the first open end 352a″ of the bowl 352″ and only the second lid 450′ can couple to the second open end 352b″ of the bowl 352″. For example, a configuration of the threads 366 may be different from a configuration of the threads 368 (FIG. 3B) to prevent the user from attaching the wrong lid to the wrong side of the bowl 352″. The bowl 352″ may further include clear indicators (colors, icons, etc.) that would signal to the user which lid goes on which side of the bowl 352″.

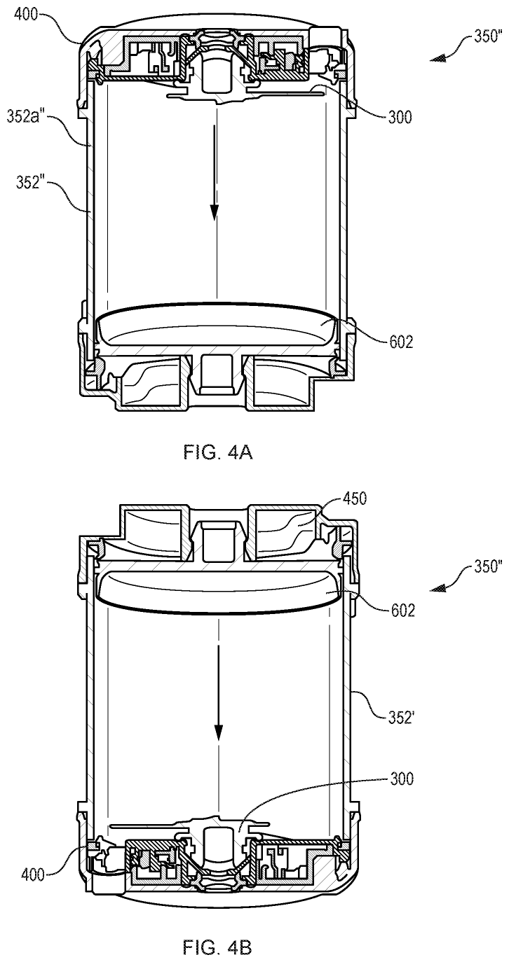

FIGS. 4A and 4B illustrate the use of the reversible bowl assembly 350″ according to some embodiments of the disclosure. As shown in FIG. 4A, a user may first install the bowl assembly 350″ to the micro-puree machine 10 in the first configuration such that the first end 352a″ of the bowl 352″ is secured to the coupling 500′. The user then may select a program at the user interface depending on the desired output (for example, soft serve ice cream, light ice cream, sorbet, gelato, etc.) to spin and plunge the blade 300 into the ingredients in the bowl 352″. For example, the blade 300 may descend into the ingredients and then ascend from the ingredients at one or more predefined rates, while rotating at one or more predefined rates. As shown in FIG. 4B, the user then may then remove the bowl assembly 350″ from the coupling 500′, reverse the orientation of the bowl assembly 350″ (i.e., flip the bowl assembly 350″) and reinstall the second end 352b″ of the bowl 352″ to the coupling 500′ in the second configuration. The user then may select a desired program at the user interface to descend the plunger 602 to extrude the ingredients out through the opening 604′ in the first lid 400′. For example, the plunger 602 may descend into the ingredients to extrude the ingredients out through the opening 604′ and then ascend from the opening 604′ after the extrusion is complete.

While embodiments of the disclosure including performing processing and extrusion using a same driven shaft, in some embodiments, processing and extrusion are performed on different shafts, as will now be described.

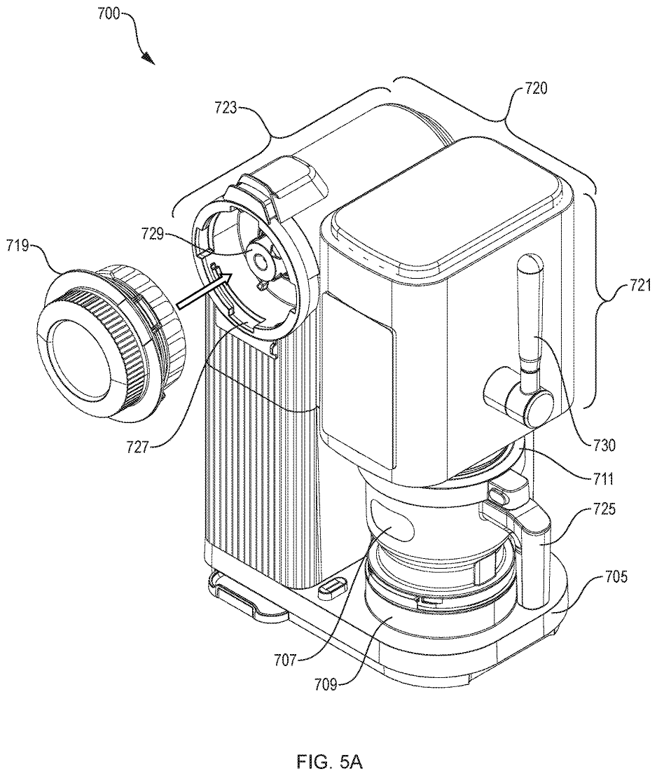

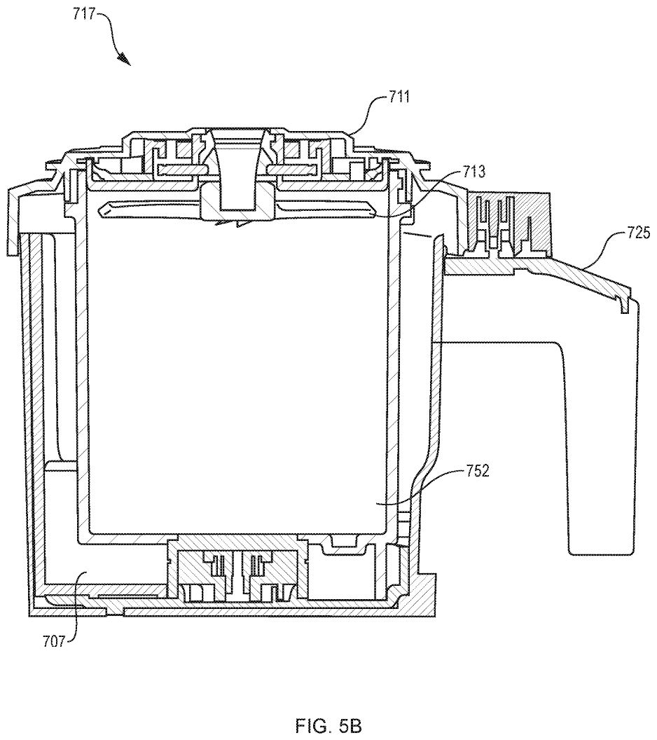

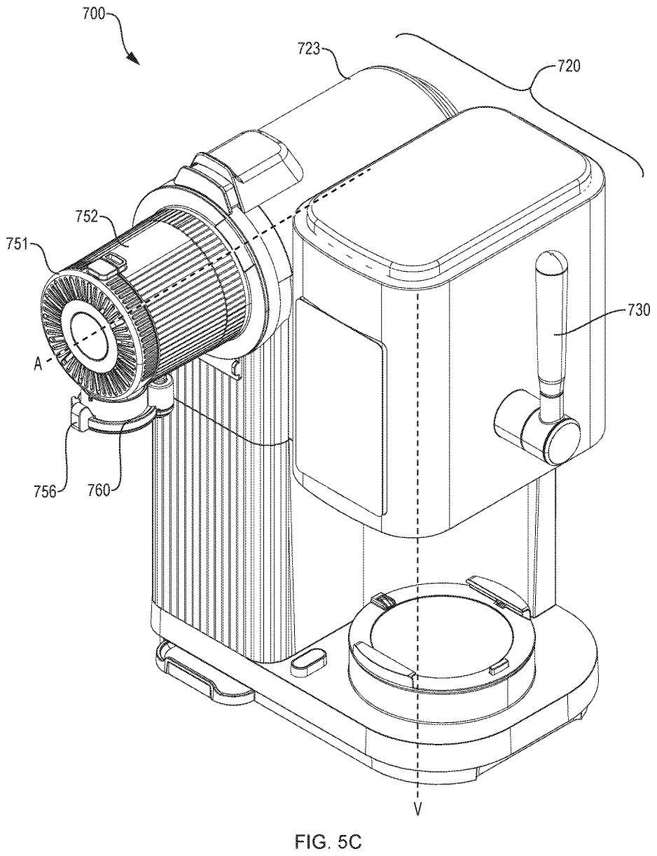

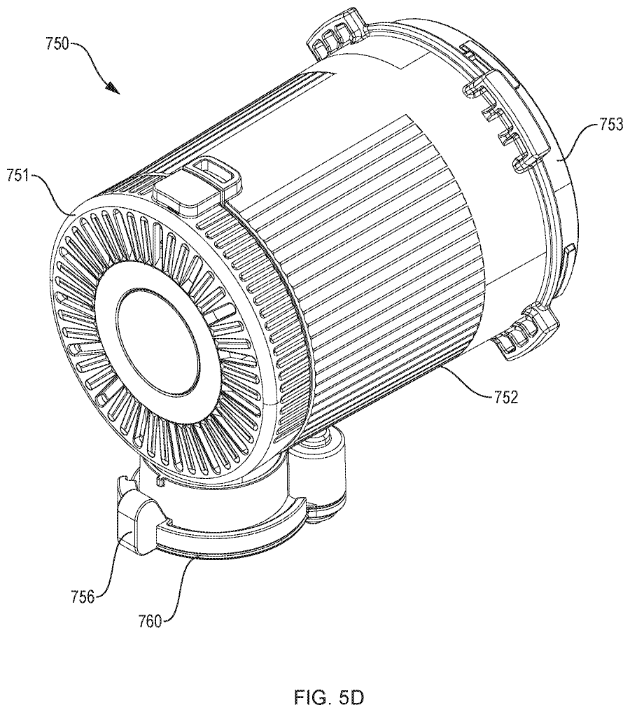

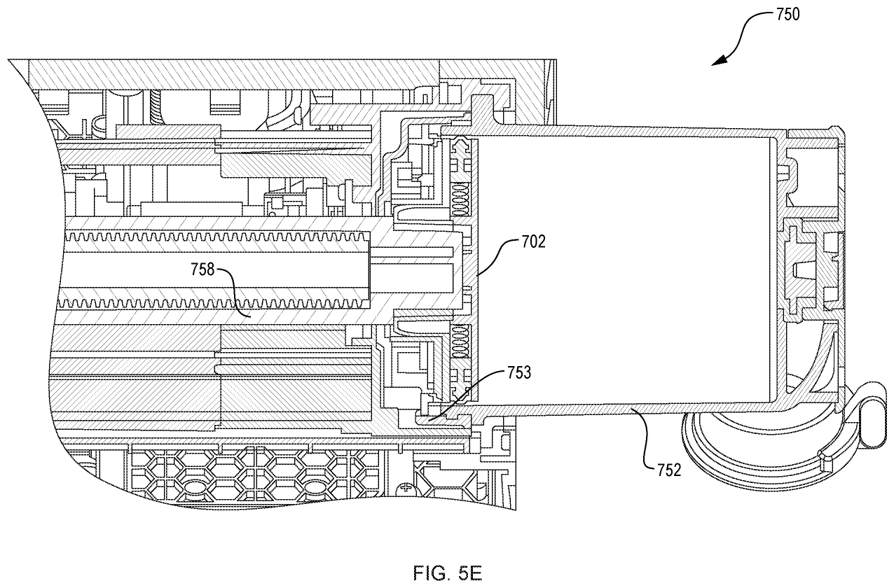

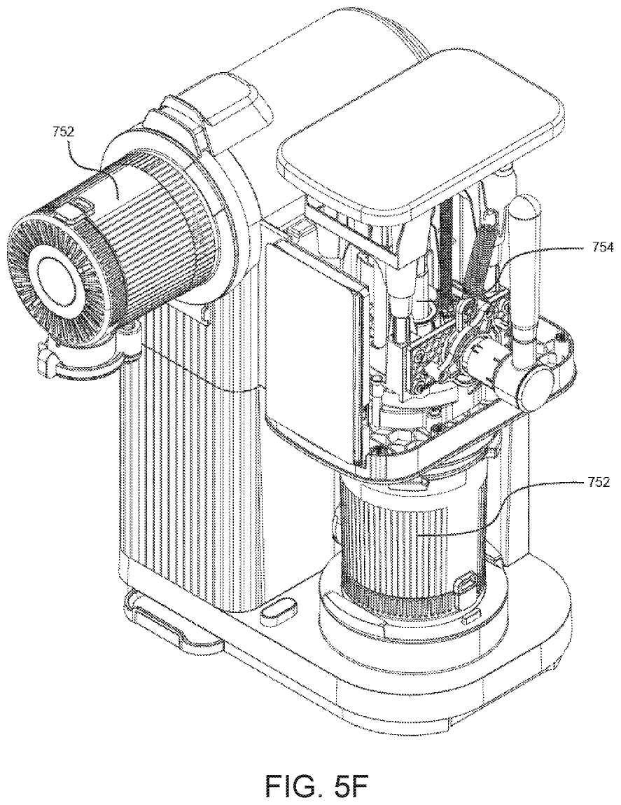

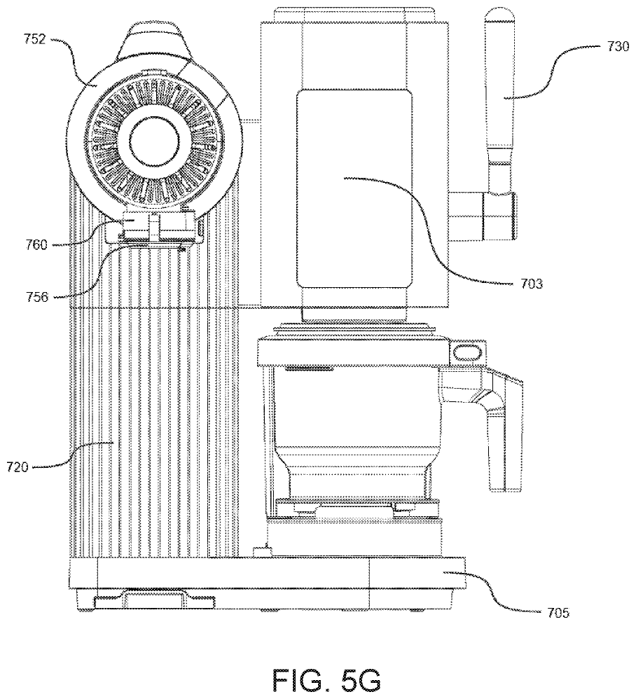

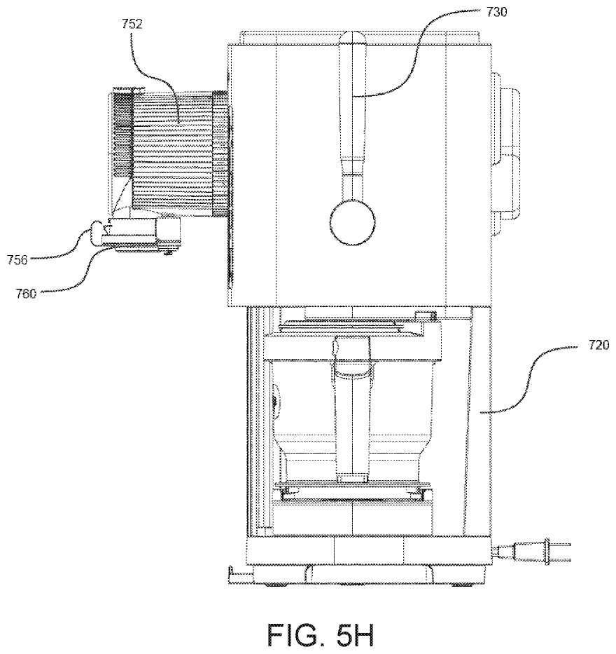

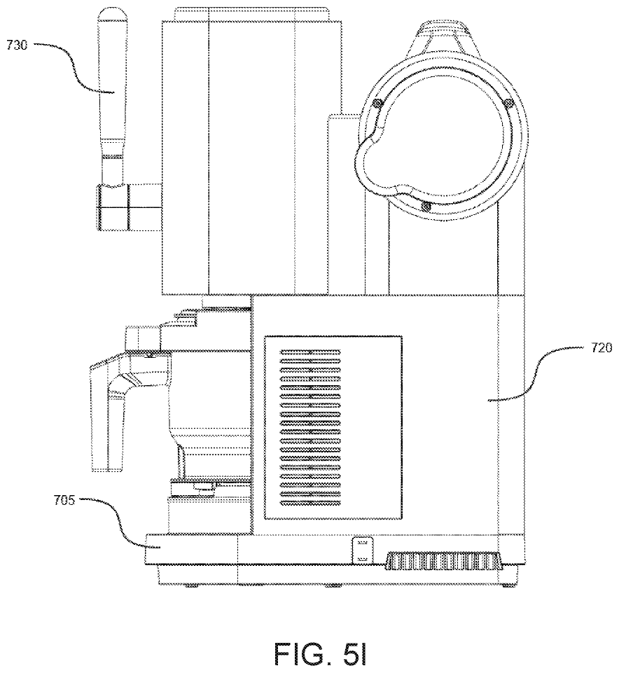

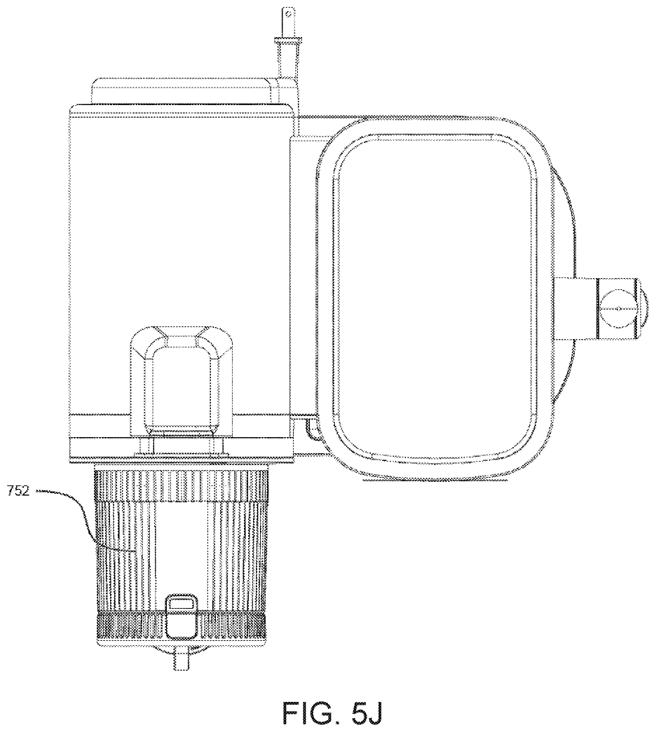

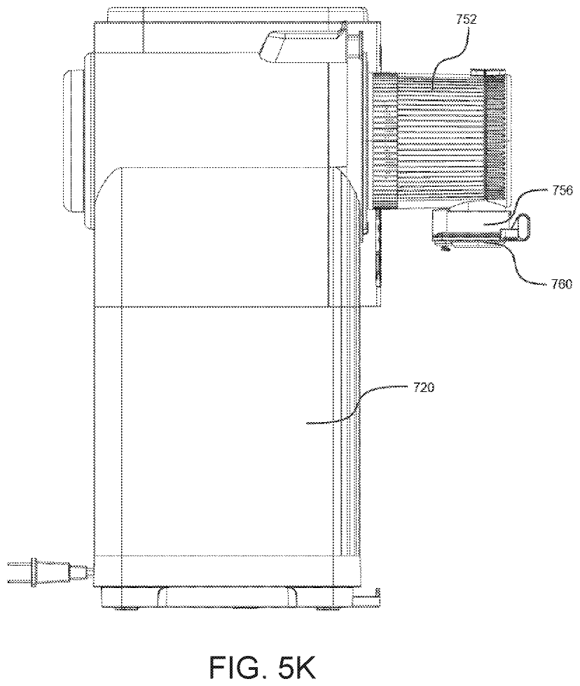

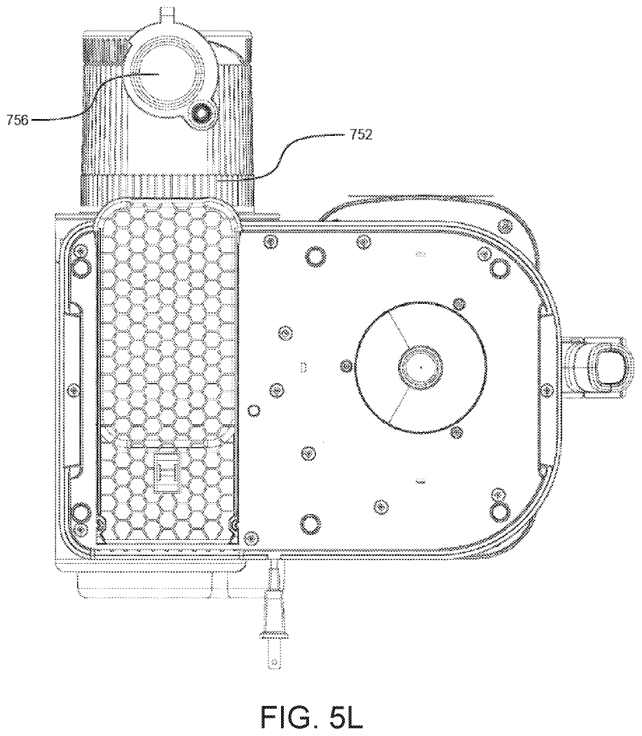

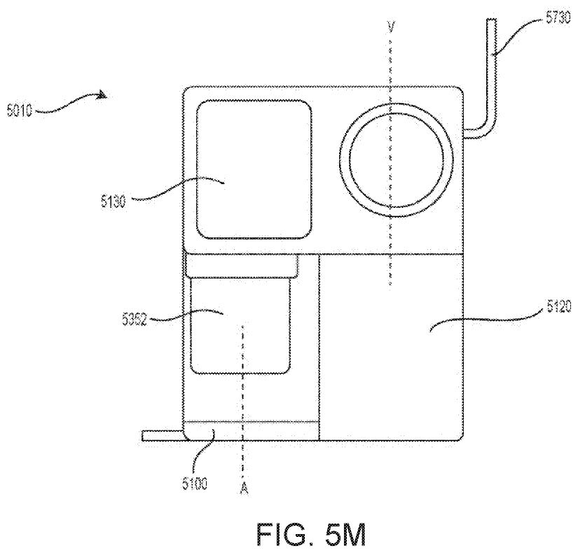

FIGS. 5A-5L illustrate another micro-puree machine 700, according to some embodiments of the disclosure. FIGS. 5A and 5B illustrate an embodiment of micro-puree machine 700 in a first configuration for processing (e.g., micro-pureeing), which may be referred to herein as a processing configuration. FIGS. 5C-5E illustrate an embodiment of micro-puree machine 700 in a first configuration for extruding, which may be referred to herein as an extruding or extrusion configuration. FIGS. 5E-5L illustrates an embodiment of micro-puree machine 700 in both processing and extruding configurations merely for illustrative purposes, as in some embodiments, the micro-puree machine 700 is not configured to perform processing and extruding concurrently.

As shown in FIGS. 5A and 5B, the micro-puree machine 700 may include a base 705 and a housing 720. The housing 720 may include a user interface (703) for receiving user inputs to control the micro-puree machine 700 and/or display information. In some embodiments, the micro-puree machine includes a processing sub-module 721 including one or more components configured to process ingredients in a bowl 752 (e.g., bowl 352 or a variation thereof) and an extruding sub-module 723 including one or more components configured to extrude processed ingredients from the bowl 752. In a processing configuration, the bowl 752 may be coupled to the interior of an outer bowl 707 that is mounted on a processing platform 709 mounted to the base 705. The bowl 752 may be coupled to a lid 711 (e.g., lid 442 or a variation thereof) that houses a blade 713 (e.g., blade 300 or a variation thereof). The bowl 752 may include a nozzle control assembly 751 (e.g., a dial) that enables a user to control an opening or closing of a nozzle 760, a nozzle 760, and a hinged stopper or plug 756 that can be used by a user to selectively cover the nozzle 760, or the nozzle control assembly 751. In some embodiments, the nozzle control assembly 751, the nozzle 760, and the stopper 756 may be removably attachable to the bowl 752. Using the handle 725, a user may rotate and elevate the processing bowl assembly 717 into a processing position in which the blade 713 engages with a driven shaft 754, the lid 711 couples to the micro-puree machine 700, and the blade 713 is released from the lid 711 so that the driven shaft 754 can drive the shaft 754, for example, as described in the '765 patent. By engaging the user interface (or via a remote interface wirelessly connected to a wireless interface within housing 720), the user may initiate processing of the ingredients in the bowl 752. In a processing configuration, extruding sub-module 723 may remain idle, and a cap or plug 719 may be coupled to a coupling 727, covering an interface 729 with driven shaft 758. The coupling 727 (e.g., coupling 500) also may serve as a coupling between the bowl assembly 750 (e.g., the lid 753 of the bowl assembly 750) and the micro-puree machine 700. After the processing of the ingredients, the processing bowl assembly 717 may be decoupled from the micro-puree machine 700 (e.g., from the processing sub-module 721), and de-mounted from the platform 709. The lid 711 may be removed from the outer bowl 707, and the bowl 752 may be removed from the outer bowl 707.

As shown in FIGS. 5C-5E, a lid 753 then may be mounted to the bowl 752, and the bowl 752 then may be coupled to the micro-processing machine 700 (e.g., to the extruding sub-module 723) in an extruding configuration. In the extruding configuration, the bowl 752 may be coupled to a lid 753 (e.g., lid 452 or a variant thereof) that includes a plunger 702. The combination of the bowl 752 and the lid 753 may be referred to herein as a bowl extruding assembly 750. In embodiments, the bowl extruding assembly 750 may be configured to be installed to the micro-puree machine 700 such that the nozzle 760 faces vertically downwards when the bowl extruding assembly 750 is properly installed. The bowl extruding assembly 750 may be assembled to the housing 720 (e.g., the extruding sub-module 723) such that a central axis A of the bowl extruding assembly 750 extends perpendicular to a vertical axis V of the housing 720, as shown. The bowl extruding assembly 750 may include an outlet 760 for extruding processed ingredients from the bowl extruding assembly 750. The micro-puree machine 700 also may include a lever 730 for manually activating a plunger 702 to extrude processed ingredients within the bowl extruding assembly 750 through the outlet 760. While the lever 730 is illustrated on a right side of the machine 700 (from the front view shown in FIG. 5C), the disclosure is not so limited. The lever 730 may be on the left side of, or another location on, the machine 700, and other components of the machine may be rearranged to accommodate the different location of the lever 730. The housing 720 may include electrical, electromagnetic, mechanical and/or electro-mechanical components to translate a pulling down or pushing up of the lever 730 into movement of the plunger 702 within the bowl 752.

Embodiments of the housing 720 of micro-puree machine 700 may house a transmission system that includes a driven shaft 754 for engaging the blade 713, a separate driven shaft 758 for engaging the plunger 702, one or more gearing systems, and one or more position and/or drive motors for moving the driven shaft 754 and the other shaft 758 rotationally and/or axially to process the ingredients in the bowl assembly 750. For example, a drive motor may drive the rotation of the driven shaft 754 and blade (e.g., blade 300) coupled thereto, and a position motor may drive the vertical (e.g., down and up) movement of the driven shaft 754 and a blade. Another motor may drive the second shaft 758 and a plunger (e.g., plunger 454 or 602) attached thereto. In embodiments, the blade 713 may be programmably controlled at the user interface by a computing system to operate at different rotational speeds and moved up and down in different patterns and speeds, and for different periods of time, to make different food items. In embodiments, the plunger 702 in the lid 753 may be programmably controlled at the user interface by a computing system to operate at different rotational speeds and moved up and down in different patterns and speeds, and for different periods of time, to make different food items. Some non-limiting examples of a transmission system and the computing system are shown in described in the '765 patent and in U.S. Pat. No. 11,882,965 to SharkNinja Operating, LLC (the '965 patent), the entire contents of which are hereby incorporated by reference.

In some embodiments of the disclosure, mechanisms are provided, and techniques employed, to lock the processing bowl to the machine, preventing the processing bowl from rotating out of the coupling during processing.

FIG. 5M shows an isometric view of a micro-puree machine 5010, according to another embodiment of the disclosure. The micro-puree machine 5010 may be used to process ingredients on one shaft and extrude the processed ingredients on another shaft. As shown in FIG. 5M, the micro-puree machine 5010 may include a base 5100, a housing 5120, and an extrusion module 5130. The housing 5120 may include a user interface (not shown) for receiving user inputs to control the micro-puree machine 5010 and/or display information. The micro-puree machine 5010 also may include a bowl 5352. The bowl 5352 may be assembled to the housing 5120 such that a central axis A of the bowl 5352 extends parallel to a vertical axis V of the housing 5120, as shown. However, the disclosure contemplates that the bowl 5352 may be assembled to the housing 5120 such that the central axis A extends at an angle of between 0 and 90° to the vertical axis V, or such that the central axis A extends perpendicular to the vertical axis V.

The extrusion module 5130 may be configured to couple to a bowl assembly as described herein, for example, a bowl having a lid with e a plunger housed therein. The extrusion module 5130 also may include a motor and transmission to drive a driven shaft to move the plunger with the bowl during extrusion, for example, as described elsewhere herein. The micro-puree machine 5010 also may include a lever 5730 for activating the plunger to extrude processed ingredients from the bowl 5352 through an integrated nozzle in the bowl 5352 (not shown). The housing 5120 may include electrical, electromagnetic and/or mechanical components the translate a pulling down or pushing up of the lever into movement of the plunger within the bowl.

The nozzle may be integrated with the bottom surface of the bowl 5352 such that nozzle faces vertically downwards when the bowl 5352 is properly installed. In the embodiment of FIG. 5L, the plunger may be configured to extrude the processed ingredients from the bowl 5352 using a separate shaft (not shown) from a driven shaft (e.g., 250) that rotates a blade (e.g., 300). In further embodiments, the separate shaft may be manually driven by the user by cranking the lever 5730.

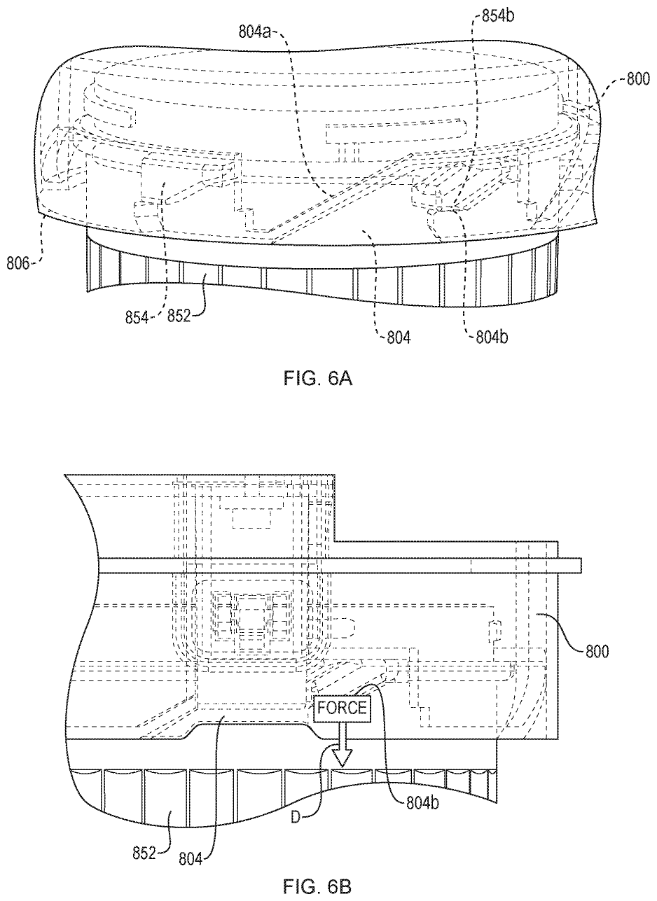

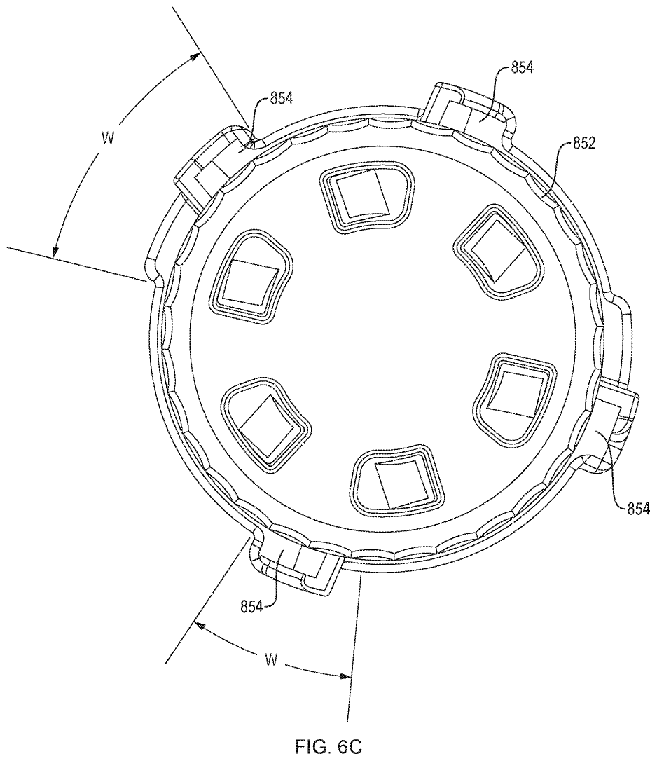

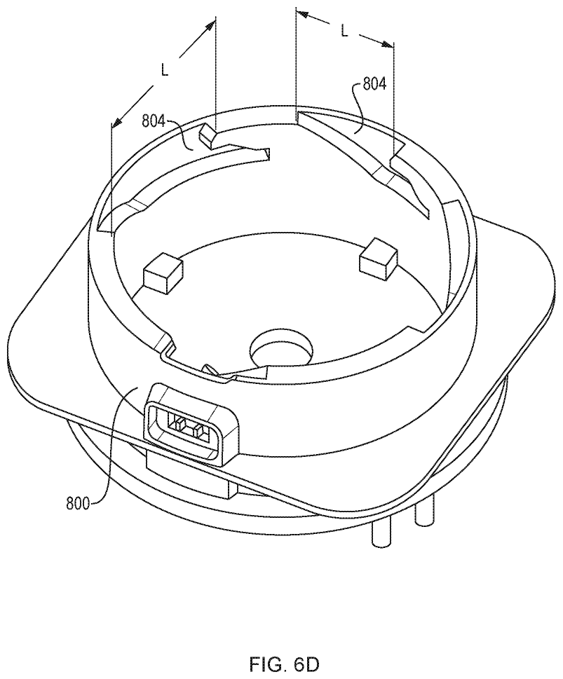

FIGS. 6A-6D illustrate an alternative version of the helical coupling mechanism of FIGS. 3A and 3B, according to some embodiments of the disclosure. As shown in FIG. 6A, the user may first insert the bowl 852 (e.g., bowl 352) into the coupling 800 (e.g., coupling 500) such that the protrusions 854 on the bowl 852 align with the slots 804 on the coupling 800. The slots 804 may comprise a helical first portion 804a that extends at an angle relative to a lower annular surface 806 of the coupling 800 and a linear second portion 804b that extends perpendicular to the lower annular surface 806. A length of the second portion 804b may comprise only a small percentage of the overall length of the slot 804-for example, less than a third of the length of the slot 804. The second portion 804b may engage a corresponding portion 854b on the protrusion 854. As such, the last few degrees of rotation of the protrusions 854 into the slots 804 may not be helical but may instead be linear. As shown in FIG. 5B, the second portion 804b of the slot 804 may thus absorb the force of the movement of the plunger (e.g., plunger 602) through the bowl 852 in a direction D to prevent the bowl 852 from inadvertently rotating back out of the coupling 800 during extrusion of ingredients from the bowl 852.

The helical coupling assembly may also include features that are designed to allow the user to assemble the bowl 852 to the coupling 800 in only one orientation to ensure that the nozzle (e.g., nozzle 760) always points downward. As shown in FIG. 6C, the protrusions 854 may be unevenly spaced about a circumference of the bowl 852 to prevent the user from installing the bowl 852 to the coupling 800 in the wrong orientation. For example, some of the adjacent protrusions 854 may be spaced 90 degrees apart about a circumference of the bowl 852, while others of the adjacent protrusions 854 may be spaced greater or less than 90 degrees apart about a circumference of the bowl 852, as shown. This uneven spacing, corresponding to an uneven spacing of the slots 804 in the coupling 800, may ensure that the nozzle is pointed in the vertically downward direction when the bowl 852 is properly installed to the coupling 800. In addition, the protrusions 854 may have a varying width W that corresponds to a varying opening length L of the slots 804 of the coupling 800 (FIG. 6D). This varying length L may also ensure that the user installs the bowl 852 to the coupling 800 in the correct orientation.

FIG. 2A is a detailed view of the coupling 500′ and the processing shaft 250′ of the micro puree machine 10 according to some embodiments. As shown in FIG. 2A, the processing shaft 250′ may extend through the coupling 500′ to couple with either a blade or a plunger housed within a lid on the processing bowl 350, 350′. The inner surface 502′ of the coupling 500′ may comprise one or more helical slots 504 sized to receive at least one corresponding helical projection 352 (FIG. 7A) on an outer surface of the processing bowl 350. In embodiments, the at least one helical slot 504 may be four helical slots 504 spaced 90 degrees apart about the inner surface 502′ of the coupling 500′ for receiving a corresponding one of four helical projections 352 on the processing bowl 350. However, the disclosure contemplates more or fewer than four helical slots 504.

FIG. 7A shows the processing bowl 350 inserted into the coupling 500′ (shown in a transparent view for ease of illustration) but before the processing bowl 350 is secured to the coupling 500′ according to some embodiments. As shown in FIG. 7A, the user may rotate the processing bowl 350 relative to the coupling 500′ in a first direction (e.g., clockwise) such that the protrusions 352 rotate into the slots 504, securing the processing bowl 350 to the coupling 500′ (FIG. 7B). Because of the angle of the slots 504 and the protrusions 352, rotating the processing bowl 350 relative to the coupling 500′ may cause the processing bowl 350 to move both rotationally and axially within the coupling 500′.

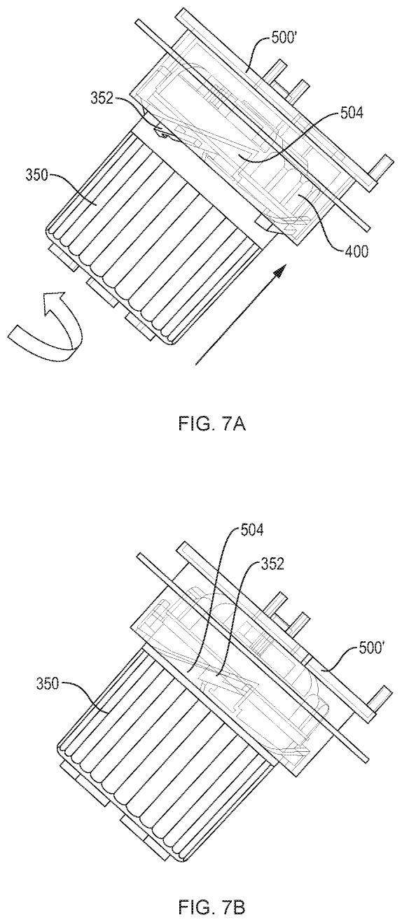

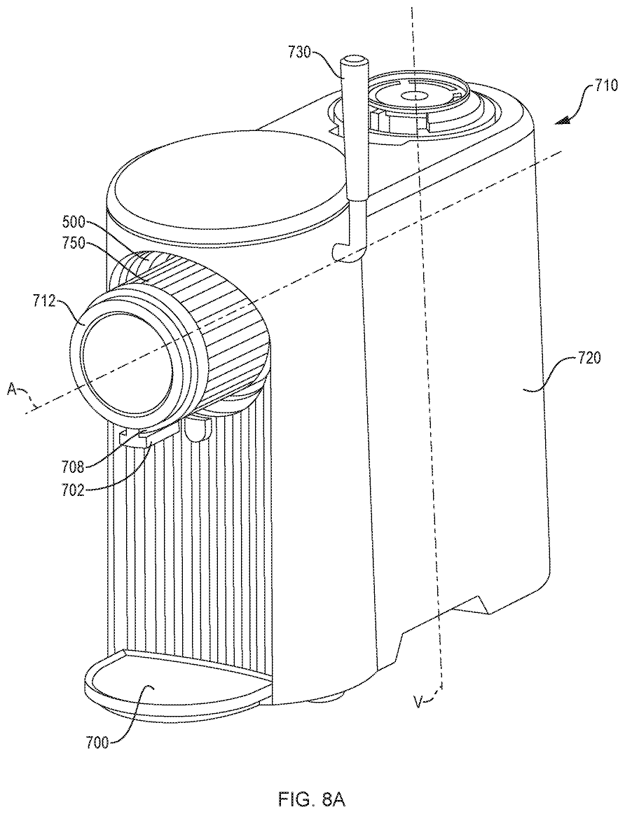

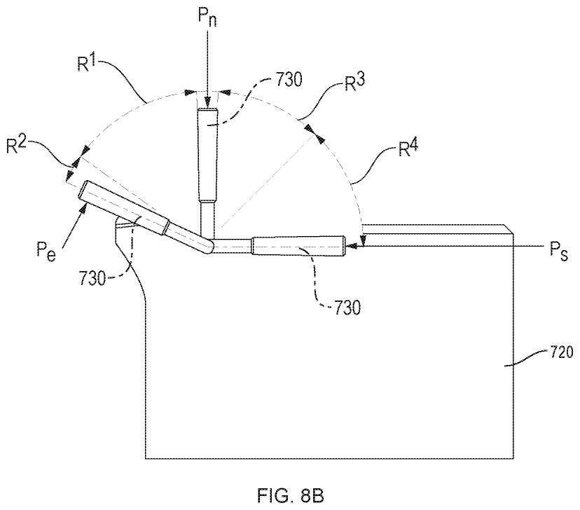

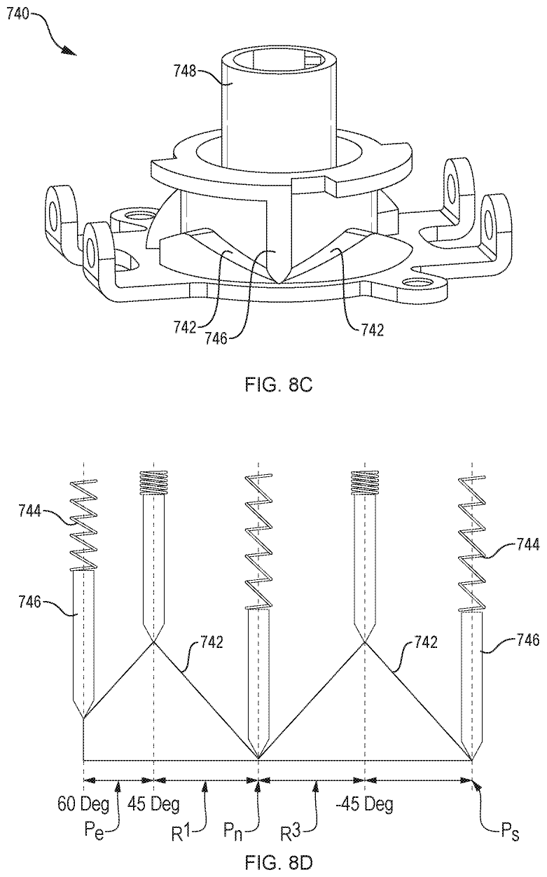

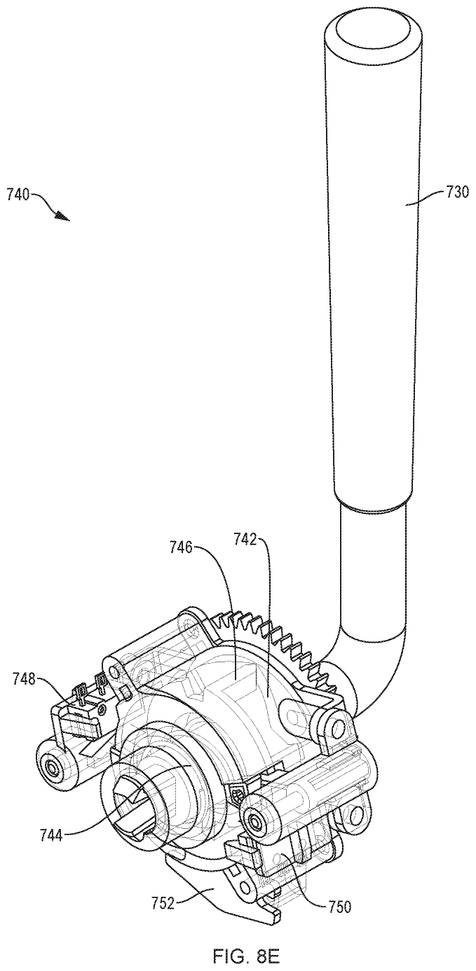

FIG. 8A shows an isometric view of a micro puree machine 710 according to another illustrative embodiment of the disclosure. The micro puree machine 710 may include a base 700 and a housing 720. The housing 720 may include a user interface (not shown) for receiving user inputs to control the micro puree machine 710 and/or display information. The micro puree machine 710 may also include the processing bowl 750. The processing bowl 750 may be assembled to the housing 720 such that a central axis A of the processing bowl 750 extends perpendicular to a vertical axis V of the housing 720, as shown. However, the disclosure contemplates that the processing bowl 750 may be assembled to the housing 720 such that the central axis A extends at an angle of between 0 and 90° to the vertical axis V, or such that the central axis A extends parallel to the vertical axis V. A nozzle 708 may be integrated with the bottom edge of the processing bowl 750. In embodiments, the processing bowl 750 may be configured to be installed to the coupling 500 such that the nozzle 708 faces vertically downwards when the processing bowl 750 is properly installed. The processing bowl 750 may have a hinged plug 702 that is spring loaded into an open position. The plug 702 may be held and locked in the closed position by a front cap 712 with a CAM path (not shown) that the plug 702 slots into. The front cap 712 may also be spring loaded rotationally in the closed position. In order to open the plug 702, the user may twist the front cap 712 in a first direction (e.g., counterclockwise), causing the hinged plug 702 to be released from the CAM and spring into the open position. To close the plug 702, the user may manually hinge the plug 702 back into the closed position, causing the front cap 712 to twist using the CAM to capture the plug 702. The micro puree machine 710 may further include an extrusion lever 730 for controlling the extrusion of ingredients through the nozzle 708, as further described below.

FIG. 8B illustrates the various positions of the extrusion lever 730 relative to the housing 720 according to some embodiments. As shown in FIG. 8B, the extrusion lever 730 may provide an electro-mechanical system for a user to interact with. The neutral position Pₙ of the lever 730 may be vertical. The user can pull the lever 730 towards them (i.e., between a vertical position and a first radial position, such as 45 degrees) in order to activate manual extrusion of the plunger 602 (FIG. 4A). The extrusion lever 703 may be configured such that, throughout this range of angles R¹, the lever 730 must be held by the user to maintain extrusion, as the lever 730 is configured to naturally be sprung toward the neutral position Pₙ. The extrusion lever 730 may furthermore be configured such that, if the range of angles exceeds the first radial position, the lever 730 transitions to an automatic extrusion position Pₑ. This state may spring the lever 730 through a range of angles R² towards a second radial position (e.g., 60 degrees toward the user from the neutral position Pₙ) and may lock the lever 730 in place until pushed back past the first position by the user. When in the extrusion position Pₑ, the extrusion state may be locked on without the need for user operation (i.e., the user does not need to hold it in place).

Still referring to FIG. 8B, from the neutral position Pₙ, the user can push the lever 730 away from them (i.e., between a vertical position and a third radial position, such as 45 degrees). Positioning the lever 730 in this range of angles R³ may initiate retraction of the plunger 602, for example, according to a program that runs without the need for continuous user input. If the angle exceeds the third radial position away from the user, the lever 730 may be sprung through a range of angles R⁴ towards the storage position Pₛ. The storage position Pₛ may be on a horizontal plane pointing away from the user (e.g., perpendicular to the neutral position Pₙ). Advantageously, the storage position Pₛ may reduce the overall dimensions of the machine 710, allowing for easier storage. The user may pull the lever 730 upwards from the storage position Pₛ to return the lever 730 automatically to the neutral position Pₙ.

FIGS. 8C and 8D illustrate a triple bi-stable mechanism 740 for controlling the position of the lever 730 according to some embodiments of the disclosure. As shown in FIG. 8C, the mechanism 740 may comprise a plurality of inclined planes 742 that map around a diameter of a hub 748 configured to receive a portion of the lever 730. A pin 746 that is rotationally keyed to the lever 730 may be configured to rotate about the hub 748 to engage the inclined planes 742. As shown schematically in FIG. 8D, a spring 744 may be configured to force the pin 746 into the most stable angle-that is, the lowest point of intersection of two adjacent inclined planes 742. The spring 744 may force the lever 730 to rotate to the position of the intersection when all user inputs are removed. The pin 746 may rotate with the lever 730 but may also be able to slide relative to the lever 730. This may allow the pin 746 to track up the height of the next inclined plane 742 without causing translation to the lever 730. The position of the intersection of the inclined plane 742 may dictate the angle at which the lever 730 changes stable state, which can be defined to be any angle required.

FIG. 8E illustrates the arrangement of the lever 730, inclined planes 742, the pin 746, and the spring 744 of the mechanism 740 according to some embodiments. As shown in FIG. 8E, the mechanism may further include two micro switches 748, 750 that provide information about the angle of the lever 730 to a printed circuit board (PCB). A maximum of one microswitch 748, 750 may be active at a time. One microswitch 750 may be used for the extrusion state while the other microswitch 748 may be used for the plunger retraction state. In the neutral position Pₙ and the storage position Pₛ, neither microswitch is active. The disclosure also contemplates that this information could be provided to the PCB with the use of pogo pins that interact with slip rings, which may provide for better angular accuracy. The mechanism 740 can further have resistance added with the use of a damper 752, such as a rotary damper.

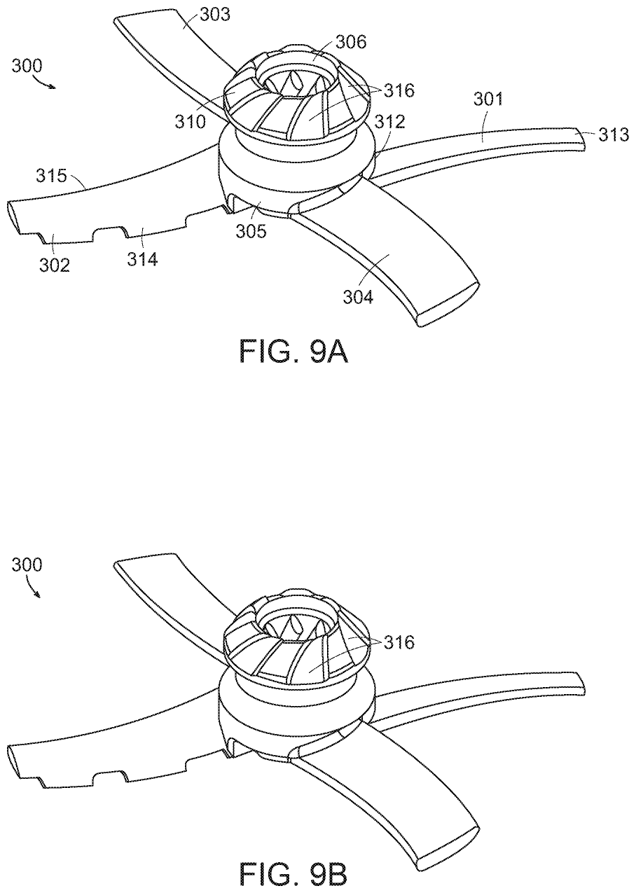

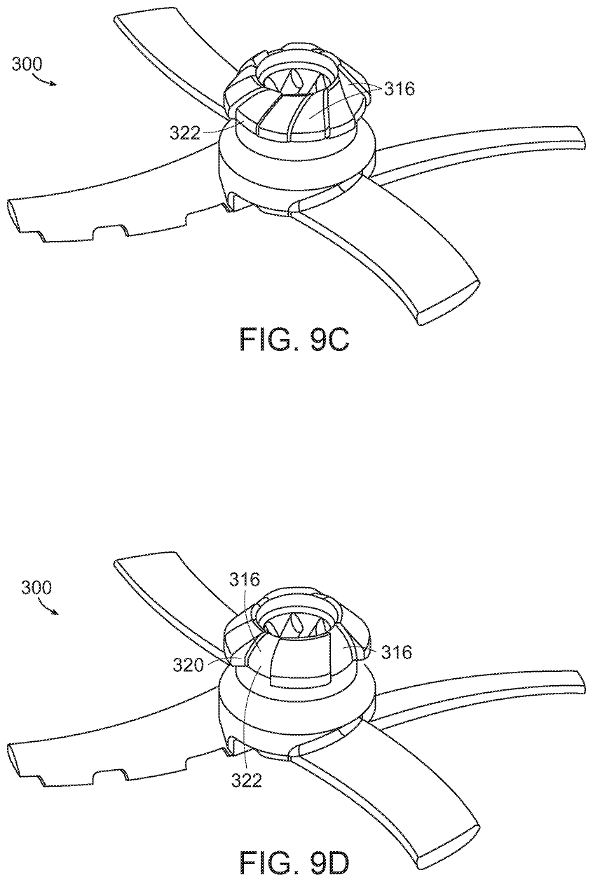

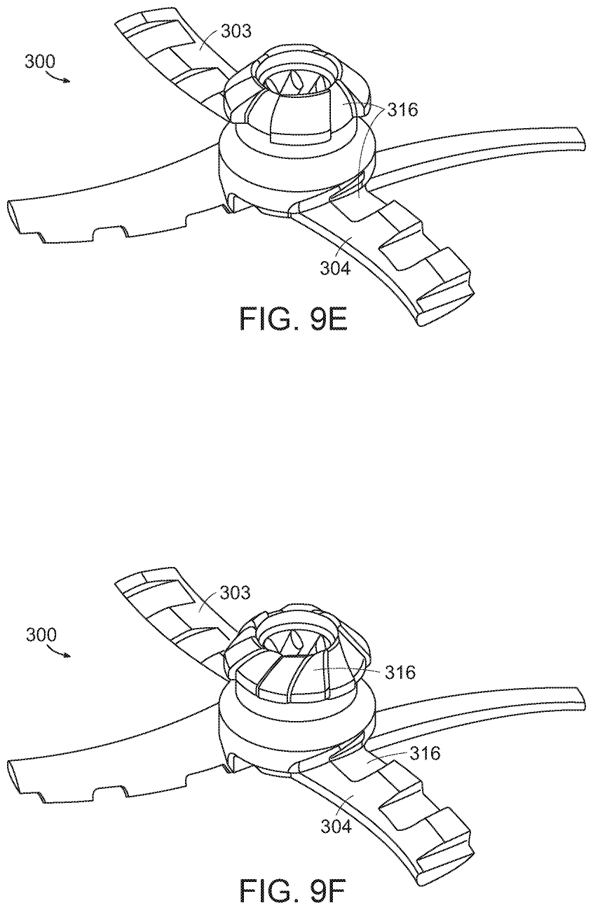

FIG. 9A shows an isometric view of an embodiment of the blade 300 of this disclosure. Embodiments of the blade 300 can comprise a unitary structure or distinct structures joined together either directly or indirectly. In embodiments, the material of the blade 300 may comprise cast stainless steel with a PVD titanium coating. The blade 300 may comprise one or more cutting arms 301, 302 (for example, two as shown) and one or more mixing arms 303, 304 (for example, two as shown). The blade 300 may further comprise a central support hub 305. The cutting arms 301, 302 and the mixing arms 303, 304 extend outward from the central support hub 305. The central support hub 305 may define a central opening 306 for accepting the processing shaft 250. The cutting arms 301 and 302 may comprise a horizontally extending length having a proximal end 312 and a distal end 313. The proximal end 312 meets the central support hub 305. The cutting arms 301, 302 may also comprise a leading edge 314 and a following edge 315. Likewise, mixing arms 303, 304 extend from the central support hub 305 and are generally positioned in an opposing orientation. In embodiments, the cutting arms 301, 302 and the mixing arms 303, 304 may have a curvature extending along all or at least a portion of the length of the arms 301, 302, 303, 304 in a concave configuration in relation to a direction of rotation during use.

Still referring to FIG. 9A, embodiments of the central support hub 305 may also comprise an angled external ledge 310. The ledge 310 may include a plurality of features for clearing slush deposits when the blade 300 is engaged with the lid 400. For example, a top surface of the ledge 310 may define a series of serrated grooves 316 alternating in depth around the circumference of the ledge 310. As the blade 300 retracts into the lid 400, the serrated grooves increase the contact area between the blade 300 and the ice, allowing more ice to be sloughed off the blade 300.

Various configurations of the serrated grooves 316 are shown in FIGS. 9B-9D. As in FIG. 9A, the ledge 310 in FIGS. 9B-9D includes the plurality of serrated grooves 316. For example, in FIG. 9B, the serrated grooves 316 have an increased depth to improve the cutting action as the blade 300 retracts through the slush. In FIG. 9C, an outer diameter of an overhang 322 of the serrated grooves 316 is reduced with respect to the remainder of the ledge 310 to improve the cutting action and to free up space around the blade 300 for ice to fall away. In FIG. 9D, the outer diameter of the overhang 322 of the serrated grooves 316 is reduced even further to allow for ice to fall, and to increase the size of the cutting teeth 320. In other embodiments, shown in FIGS. 9E and 9F, both the ledge 310 and the mixing arms 303, 304 include the serrated grooves 316 for increased moving of ice away from the blade 300.

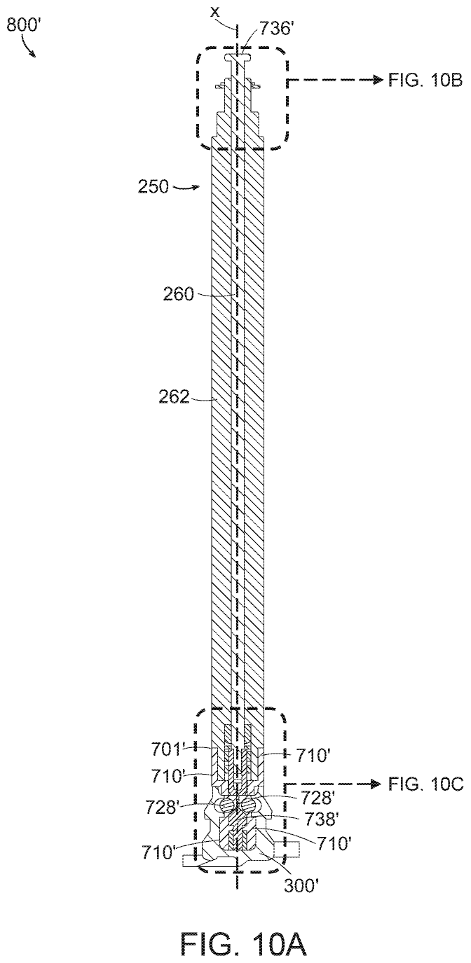

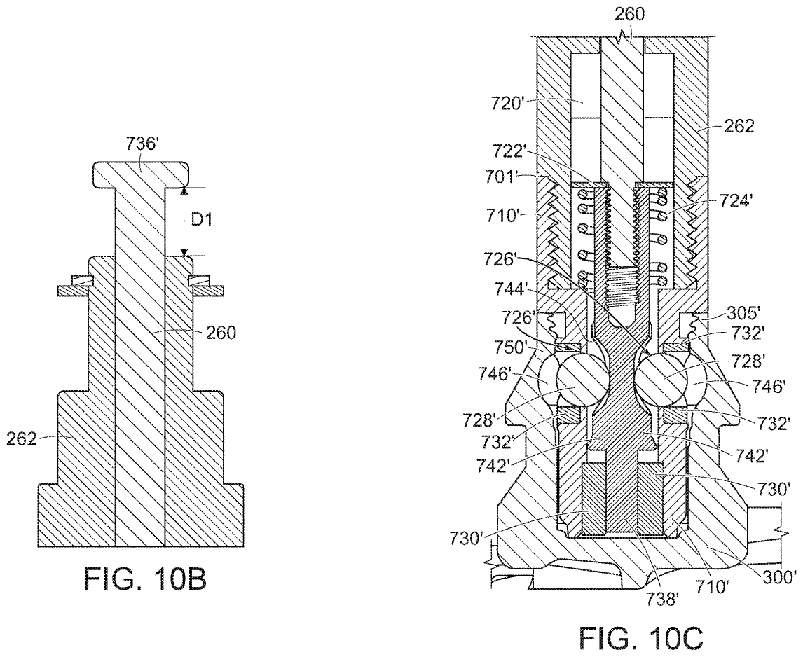

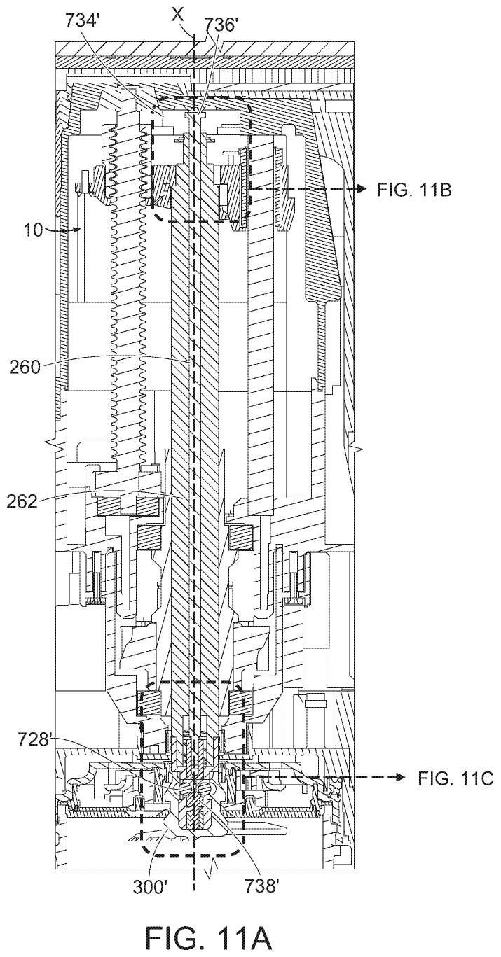

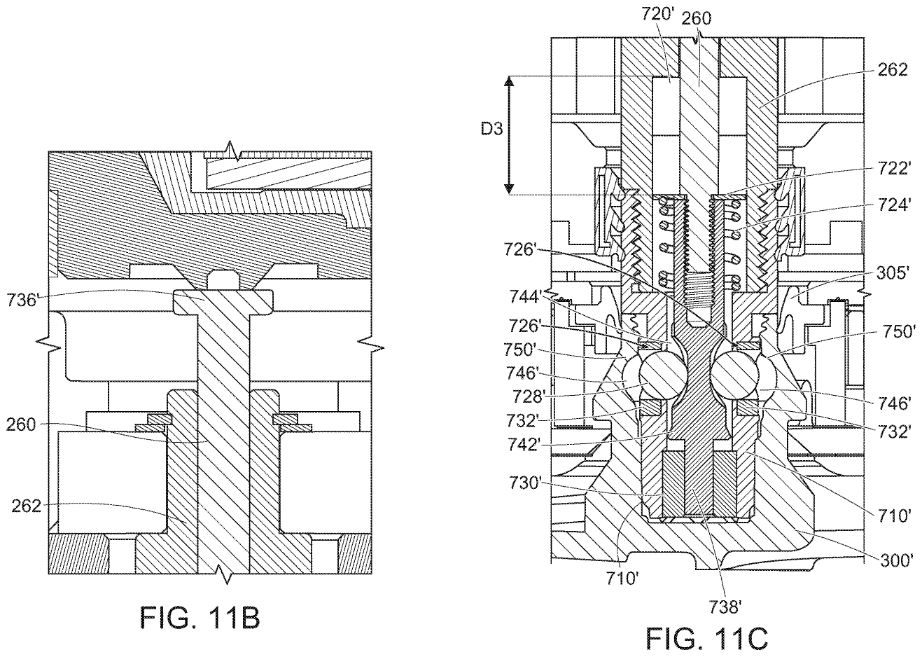

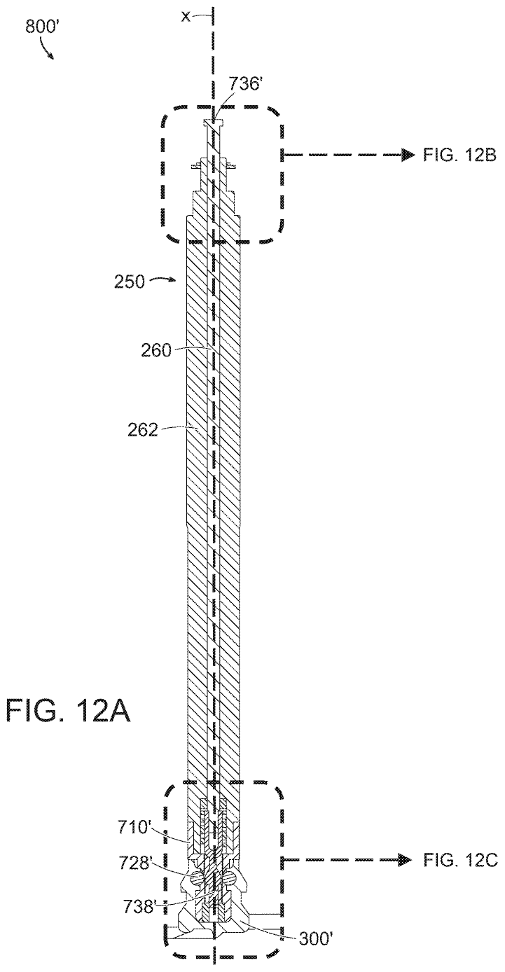

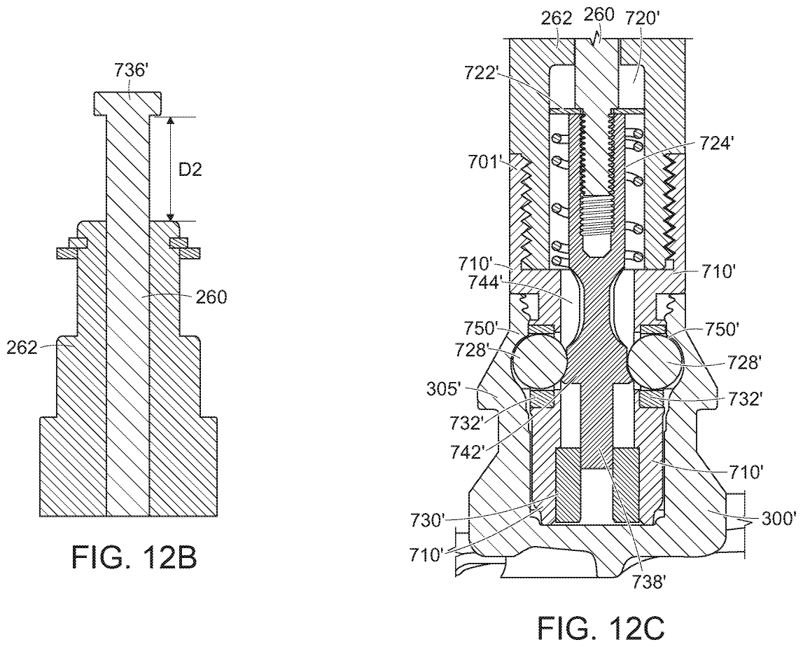

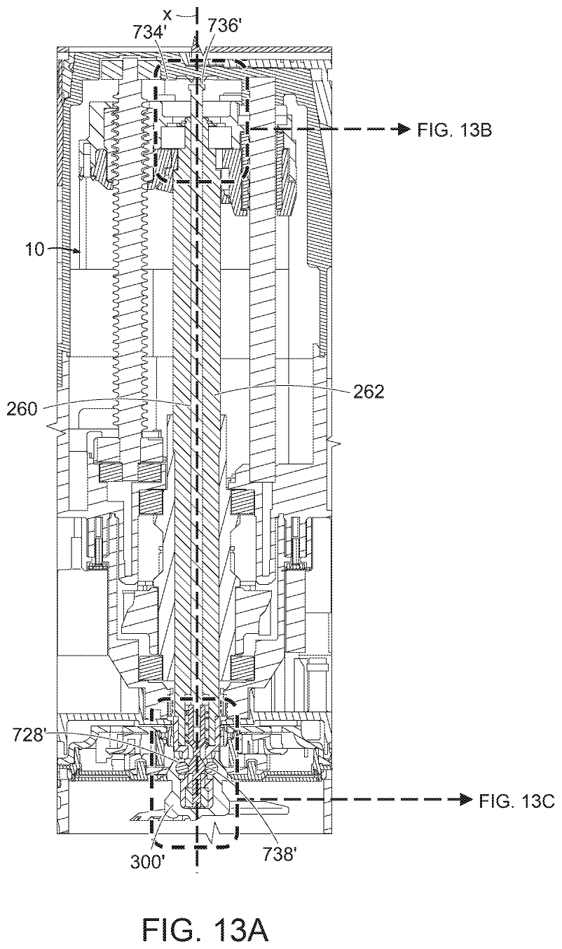

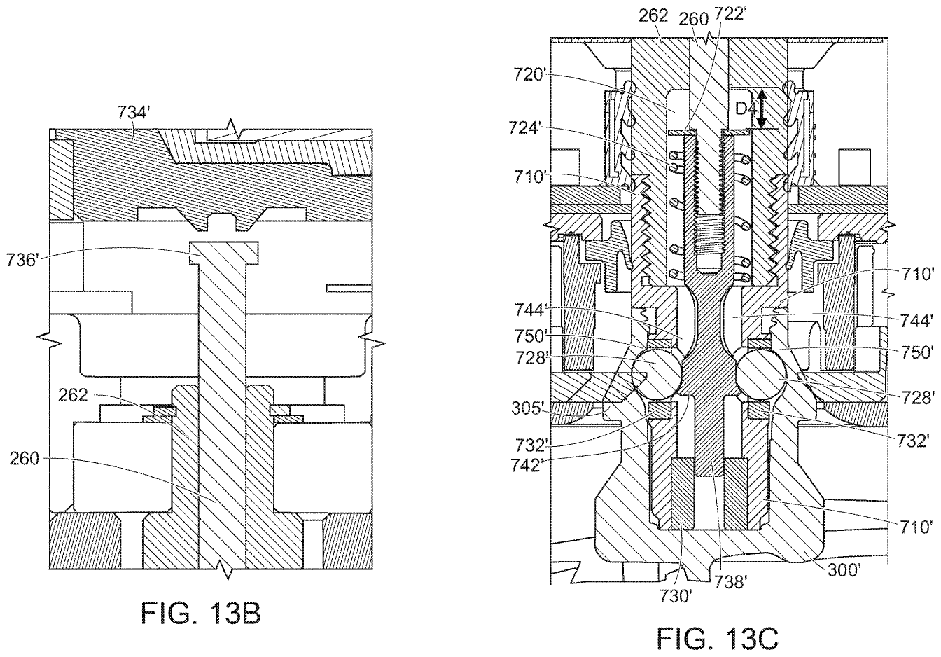

FIGS. 10A-10C are cross-sectional views of components of a locking mechanism 800′ for a food processor (e.g. micro puree machine 10) particularly focused on the processing shaft 250. As will be discussed in more detail below, FIGS. 10A-13A illustrate movement of the components between an unlocked startup configuration (show in FIGS. 10A-11C) and a locked configuration for operation (FIGS. 12A-13C). It should be understood that the configurations described herein refer to the arrangement of certain components with respect to the other components of the machine 10.

The processing shaft 250 includes an internal pin 260 which is moveable within, and guided by, a main shaft 262 to move axially. For example, when the micro puree machine 10 is oriented as shown in FIGS. 1A-1B, the main shaft 262 can direct the internal pin 260 to move horizontally, along the central axis x. In other embodiments, the main shaft 262 can be oriented such that the central axis x is oriented in another direction, such as vertically. A handle 736′ of the internal pin 260 extends out from the main shaft 262, providing a grip for a user to move the internal pin 260. The main shaft 262 is joined to a first end 701′ of a coupling 710′, for example via interlocking threads opposing the direction of rotation of the blade 300′. The blade 300′ is positioned around the coupling 710′, for example, further down the coupling 710′ from the first end 701′ at which the main shaft 262 joins the coupling 710′. To that end, the blade 300′ can include a support hub 305′ with a central opening which receives the coupling 710′. In this position, the support hub 305′ sits around the exterior of the coupling 710′.

In some embodiments, blade 300′ is similar, but not the same as, blade 300 illustrated in FIGS. 9A-9F. Unlike the blade 300, blade 300′ does not include helical coupling members within its central opening, like those shown in opening 306. This is because blade 300 may be helically coupled to the helical threads of a drive shaft of a micro-puree machine. However, the locking mechanism 800′, including the coupling 710′, are configured for linear coupling to a blade or other component, instead of helical coupling. As such, helical coupling members are not necessary or desirable, and in fact could impede coupling blade 301′ to the coupling 710′. Rather, an internal wall of the opening in blade hub 305′ may have internal cavities for receiving ball bearings of the locking mechanism 800′, as is described in more detail elsewhere herein. Likewise, the support hub 305′ can be similar to the support hub 305, except as otherwise shown and described herein.

Near the coupling 710′, the main shaft 262 defines an inner chamber 720′ of a greater width than the internal pin 260. An extension member 722′ is coupled to move in conjunction with the internal pin 260 (either by attachment to the internal pin, or by attachment to a plunger 738′ discussed in more detail below). The extension member 722′ extends outwardly from the internal pin 260 and moves within the chamber 720′ as the internal pin 260 moves. A spring 724′ sits within the chamber 720′, surrounding the internal pin 260, and engages the extension member 722′. As the internal pin 260 moves towards the blade 300′, (i.e., vertically downward as shown in FIG. 10A), the extension member 722′ compresses the spring 724. This creates a biasing force against the internal pin 260, pressing the internal pin 260 away from the blade 300′ along the central x axis.

The coupling 710′ forms internal sockets 726′ within which ball bearings 728′ are contained. The ball bearings 728′ can be a rigid material, such as stainless steel or the like. The sockets 726′ are sized and shaped to retain the ball bearings 728′ within the coupling 710′. As will be discussed in more detail below, in the locked configuration, the ball bearings 728′ secure the blade 300′ to the processing shaft 250. In the unlocked configuration, the ball bearings 728′ are not locked and therefore can be moved into an internal chamber 744′ defined by the coupling 710′ and rest within the internal chamber 744′ and sockets 726′. The ball bearings 728′ are not locked to the blade 300′ in this position, and therefore the blade 300′ can be removed, for example, relatively easily with small force. The coupling 710′ can also include ball coverings 732′ which surround the ball bearings 728′ and are sized and shaped to conform to the ball bearings 728′ and retain them within the coupling 710′. This prevents the ball bearings 728′ from falling out of the coupling 710′. The coupling 710′ includes one or more magnets 730′ near the location at which the blade 300′ comes into contact with the coupling 710′, which magnets 730′ apply a magnetic force to attract the blade 300′. In the unlocked configuration, the magnets 730′ removably couple the blade 300′ to the coupling 710′ to hold the blade in place. However, the magnets 730′ may be configured such that that the magnetic force between the magnets 730′ and the blade 300′ is relatively small, for example, just enough to overcome gravity and other static forces to keep the blade in place, e.g., until the blade 300′ is locked to the main shaft 262. For example, if the blade 300′ was disengaged from the lid 400 of the bowl 350, a user could readily remove the blade 300′ by simply pulling the blade 300′ and overcoming the magnetic force. This allows for the blade 300′ to be easily detached for cleaning or replacement while in the unlocked configuration.

Referring to FIGS. 10A-11C, the components are shown in the unlocked, or startup configuration, in which the internal pin 260 can connect to part of the housing 734′ of the micro puree machine 10. This generates a force pushing down on the handle 736′ of internal pin 260, that secures the internal pin 260 in the unlocked position before startup. When startup begins, the internal pin 260 can be disengaged to allow movement. In the startup configuration, the spring 724′ is compressed. Therefore when the internal pin 260 is disengaged, force from the spring 724′ pushes the internal pin 260 away from the blade 300′ (i.e. vertically upward as shown in FIGS. 10A-11C).

As best seen in FIG. 10C, the end of the internal pin 260 nearest the blade 300′ includes a plunger 738′. The plunger 738′ can be removably attached to the internal pin 260 via threads (as shown) or by other known mechanisms for removably coupling two parts. Alternatively, the plunger 738′ and the internal pin 260 can be permanently coupled or formed as a unitary body. The plunger 738′ forms wings 742′, which define a sloped surface increasing in width towards the end of the plunger 738′ closest the blade 300′. These wings 742′ contact the ball bearings 728′ as the internal pin 260 and plunger 738′ move away (upwardly in the context of FIGS. 10A-13C) from the blade 300′, moving from the unlocked configuration of FIGS. 10A-11C to the locked configuration of FIGS. 12A-13C). During movement between these two configurations, the sloped surfaces of the wings 742′ force the ball bearings 728′ further outward, into internal cavities 746′ of the blade 300′. This allows the blade 300′ to be locked to the processing shaft 250, as discussed in more detail below. Notably, while wings 742′ are referred to plurally herein, it should be understood that both wings 742′ can be formed by a single unitary member extending around the entire circumference of the plunger 738′.

Movement between the unlocked and locked configurations can be visualized by comparing FIG. 10B (unlocked) to FIG. 12B (locked) and comparing FIG. 11C (unlocked) to FIG. 13C (locked). As shown in FIG. 10B, in the unlocked configuration the handle 736′ of the internal pin 260 is located a distance D1 from the top of the main shaft 262. By contrast, in the locked configuration of FIG. 12B, the handle 736′ is located a distance D2 from the top of the main shaft 262. In some embodiments, D1 can be equal to or about 5.9 mm, while D2 can be equal to or about 10.5 mm. In such a case, the internal pin 260 moves away from the blade 300′ along the central axis x a distance equal to or about 4.6 mm between the unlocked configuration and the locked configuration. Similarly, FIG. 11C shows a distance D3 between the extension member 722′ and the end of the internal chamber 720′ in an unlocked configuration, while FIG. 13C shows a distance D4 between the extension member 722′ and the end of the internal chamber 720′ in a locked configuration. In one example, D3 can be equal to or about 8.4 mm while D4 can be equal to or about 3.8 mm. This would likewise mean the internal pin 260 moved equal to or about 4.6 mm between the unlocked and locked configuration. It should be understood that these distances are exemplary only and provided to explain one possible embodiment that has been found to be effective. Other separation distances may also be effective.

Referring now to FIGS. 12A-13C, the locked configuration is shown. In this position, the wings 742′ bias the ball bearings 728′ against the sidewalls of the internal cavities 746′ of the blade 300′. The wings 742′ can have an external surface with a slight concave shape, to mirror a convex (i.e., circular) shape of the ball bearings 728′ and help hold them in place. Similarly, the internal cavities 746′ can have a concave shape to match the convex shape of the ball bearings 728′. A narrow lip 750′ near the end of the blade′s support hub 305′ further secures the blade 300′ to the ball bearings 728′ by narrowing a diameter between the internal sidewalls of the blade 300′. In the locked configuration, the ball bearings 728′ are pressed outward to form a width that is greater than the diameter between the lips 750′, preventing the blade 300′ from being removed. Since the ball bearings 728′ are also fixed within sockets 726′ of the coupling 710′, and the coupling 710′ is connected to the internal pin 260, this arrangement effectively locks the processing shaft 250 to the blade 300′.

In this way, the processing shaft 250 can be reliably locked to the blade 300′, during operation, holding the blade 300′ in place. The blade 300′ can then be driven by the processing shaft 250 to create rotational movement of the blade 300′, and can also be driven downwards (in the orientation shown) by the micro puree machine 10 at the same time for processing food. The food processing is accomplished by both the rotational movement of the blade 300′ and the downward movement of the blade. When food processing is complete, the blade 300′ may be moved upwards to its startup, or unlock configuration. The handle 736′ can then be pressed back in the direction of the blade 300′ along the central axis x to reach the unlocked configuration shown in FIGS. 10A-11C. In the unlocked configuration, the blade 300′ is then only held in position by the force from the magnets 730′, and therefore can be easily removed, for example, while still coupled to lid 400.

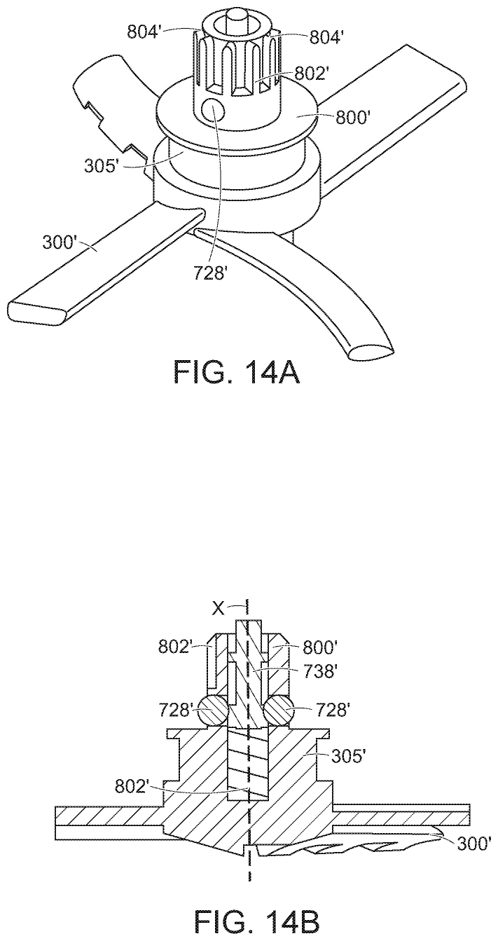

Referring now to FIGS. 14A-14B, an embodiment is shown of the micro puree machine with a different coupling arrangement. In this embodiment, the coupling 710′ has been replaced by the coupling 800′. However, except where differences are shown or described herein, it should be understood that the coupling 800′ serves the same function as the coupling 710′.

In particular, the coupling 800′ uses threads 802′ which run parallel to the central axis x of the processing shaft 250 (i.e. vertically as shown in FIGS. 14A-14B). The main shaft 262 can then include similar teeth running parallel to the axis x. The tops of the teeth 804′ can be pointed to facilitate easy engagement between the teeth of the main shaft 262 and coupling 800′ as they are initially attached. After the teeth 804′ of the coupling are engaged with teeth of the main shaft 262, rotational movement through the processing shaft 250 will turn the coupling 800′, thereby turning the blade 300′ for processing any ingredients in the bowl 350.

Further, the spring 724′ can be replaced or supplemented by the spring 802′. The spring 802′ sits below plunger 738′, in between the plunger 738′ and blade 300′. Therefore the spring 802′ applies a force to bias the plunger 738′, and in turn the internal pin 260, away from the blade 300′. This forces the plunger 738′ towards the locked configuration shown in FIG. 14B.

It should be understood that while a number of different exemplary components of locking mechanisms are shown, in various arrangements, the locking mechanism can utilize different components then those shown. For example, in some embodiments, the locking mechanism 800′ can include any outer assembly of components which includes at least one socket (e.g. the coupling 710′ and sockets 726′). The locking mechanism can then include any internal assembly of components which is movable along a central axis of the processing shaft between a first position and a second position (e.g. an internal pin 260) and contacts the ball bearings 728′ to cause the ball bearings 728′ to lock to the blade 300′. The outer assembly can also include the main shaft 262, which can be arranged concentrically around at least a portion of the internal pin 250 and connected to an end of the coupling 710′. In some arrangements, the roles of the outer assembly and internal assembly may also be reversed.

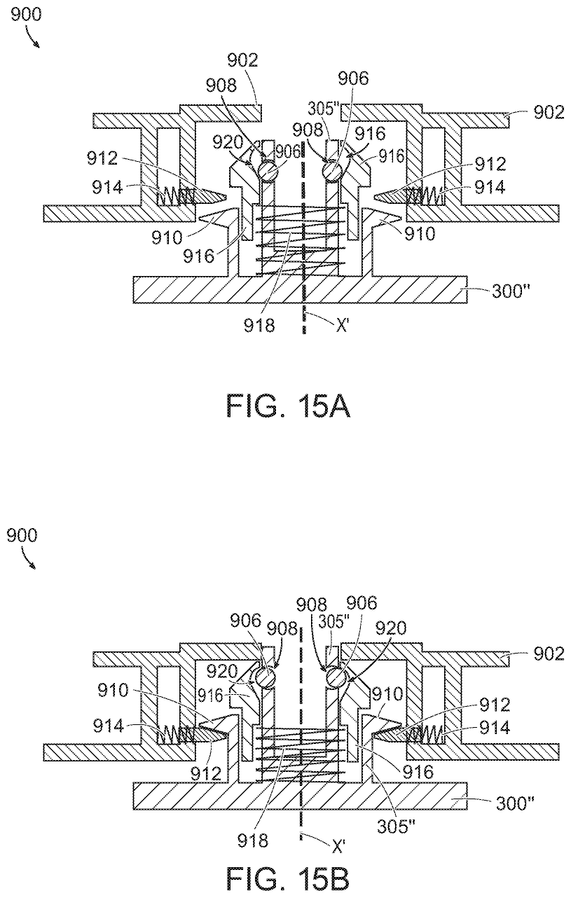

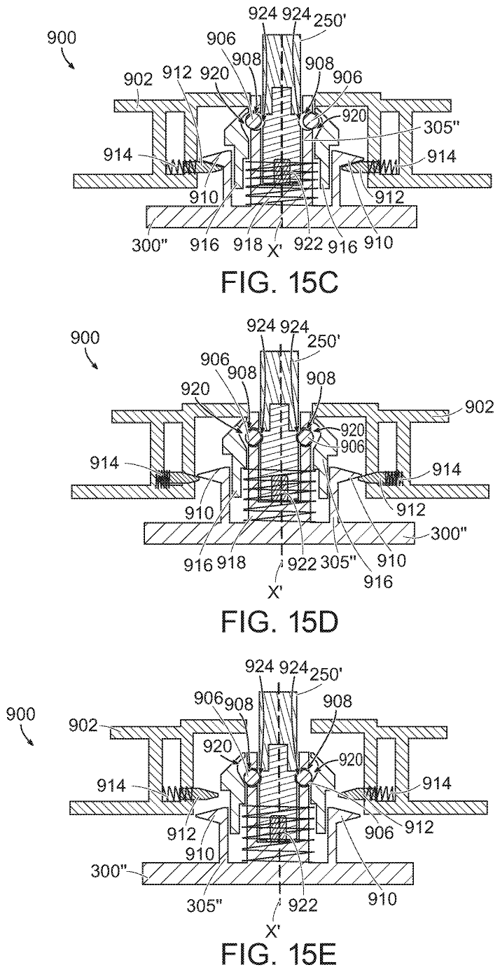

Referring now to FIGS. 15A-15E, another embodiment of a locking mechanism 900 for a food processor, such as the micro puree machine 10, is shown. In general, FIGS. 15A-15E show a progression as a blade 300″ is initially attached to a lid 902 (FIGS. 15A-15B) before being locked to a processing shaft 250′ (FIGS. 15C-15E). As will be discussed in more detail below, in the locking mechanism 900, the ball bearings 906 are provided as part of the blade 300″, and rest within opposing internal cavities 908 of a support hub 305″ of the blade 300″. It should be understood that the components of the locking mechanism 900 can be similar to those described in other embodiments herein, except as otherwise shown and described.

Referring now to FIGS. 15A-15B, the blade 300″ is shown moving from a position where it has not yet been coupled to the lid 902 (FIG. 15A), to a second position where the blade 300″ is received within, and coupled to, the lid 902 (FIG. 15B). The blade 300″ includes opposing wings 910, extending outwardly from the center (i.e. axis x′). The wings 910 can be on opposite sides of the blade 300″ with respect to the center, or can be formed from a single uniform extension spanning an entire circumference of the support hub 305″. The lid 902 includes inwardly extending protrusions 912 which engage the wings 910 as the blade 300″ is coupled to the lid 902 (i.e. as the blade 300″ moves upwardly into the lid 902, along the axis x′ in the orientation shown). Each protrusion 912 is biased inwardly, towards the center axis x′. In that regard, in one example, the lid 902 can include springs 914 corresponding to each protrusion 912, the springs 914 biasing the protrusions 912 towards the center axis x′. When the blade 300″ is moved upwardly such that the wings 910 pass beyond the protrusions 912, the wings 910 become secured within the interior of the lid 902 as shown in FIG. 15B. In this configuration, the blade 300″ is locked to the lid 902 with the protrusions 912 holding the wings 910 and preventing separation. In some cases, the wings 910 can include an angled surface extending outwardly to a pointed tip, to facilitate smoother engagement with the protrusions 912.

The lid 902 also includes a coupling 916 positioned between the wings 910 and the support hub 305″. The coupling 916 is movable upwards or downwards (i.e. along the x′ axis) and is biased by a spring 918 to move upwards and away from the bottom of the blade 300″. The coupling 916 includes sockets 920, corresponding to the internal cavities 908 of the blade 300″, which can have a concave shape, corresponding to a convex shape of the ball bearings 906. As the blade 300″ moves upwards within the lid 902, the coupling 916 comes in contact with a surface of the lid 902 which forces the coupling 916 downwards along the support hub 305″ of the blade 300″. This causes the internal sockets 920 of the coupling 916 to align with the internal cavities 908 of the blade 300″, and allows the ball bearings 906 to move outward from the center axis x′ to rest, at least partially, within the sockets 920. This is an unlocked configuration, as the ball bearings 906 are free to move within the sockets 920 and cavities 908.

Referring now to FIGS. 15C-15E, configurations of the blade 300″ as it is locked to a processing shaft 250′ of a micro puree machine 10 are shown. In FIG. 15C, the processing shaft 250′ is inserted into the support hub 305″ of the blade 300″. A magnet 922 within the shaft 250′ initially removably couples the blade 300″ to the processing shaft 250′ through magnetic force. The processing shaft 250′ has one or more internal recesses 924, corresponding to the internal cavities 908 of the ball bearings 906 which provide another area within which the ball bearings 906 may move. However, in the configuration shown in FIG. 15C, the ball bearings 906 are free to move and the blade 300″ is still not locked to the processing shaft 250′. In that configuration, the blade 300″ can be easily removed by overcoming the force from the magnet 922.

To lock the blade 300″ to the shaft 250′, the processing shaft 250′ is then pushed downwards, forcing the wings 910 to contact protrusions 912 and compress springs 914 outwardly (FIG. 15D). As shown in FIG. 15E, the wings 910 eventually overcome the biasing force of the springs 914 and pass over the protrusions 912 as the blade 300″ is pushed downwards. The blade 300″ moves away from the lid 902, such that the coupling 916 is no longer in contact with the lid 902. This allows the spring 918 to bias the coupling 916 upwards. As the coupling 916 moves upwards, sockets 920 are forced upwards and no longer align with the ball bearings 906 and cavities 908 of the blade 300′. The concave shape of the sockets 920 urge the ball bearings 906 towards the center until a narrower internal diameter of the coupling 916 comes in contact with the ball bearings 906, holding the ball bearings 906 inwards into the internal cavities 908 and recesses 924 of the processing shaft 250′. In this configuration, the blade 300″ has moved away from the lid 902, and the blade 300″ is locked to the processing shaft 250′ by the ball bearings 906 such that it can be rotated for processing food.

To remove the blade 300″ the processing shaft 250′ can be moved upwards, back into the configuration shown in FIG. 15C, unlocking the locking mechanism 900. In the unlocked configuration, the lid 902 forces the coupling 916 down until the sockets 920 align with the internal cavities 908 and ball bearings 906. The ball bearings 906 can then move freely out of the recesses 924 of the processing shaft 250′ as the shaft 250′ moves upwards, and thus, the processing shaft 250′ is not locked to the blade 300″.

The locking mechanism 900 has a number of advantages. First, many of the components of the locking mechanism 900 are coupled to the blade 300″, such as the ball bearings 906 and coupling 916. Since the blade 300″ is easily removable, these components can also be easily removed for cleaning. Additionally, if a locking mechanism 900 is faulty, or breaks, the locking mechanism 900 can easily be replaced by replacing the blade 300″. This makes shipping a replacement part to a consumer easy, as it avoids the need to replace the entire processing shaft 250′, as in embodiments where the locking mechanism is integrated within the processing shaft.

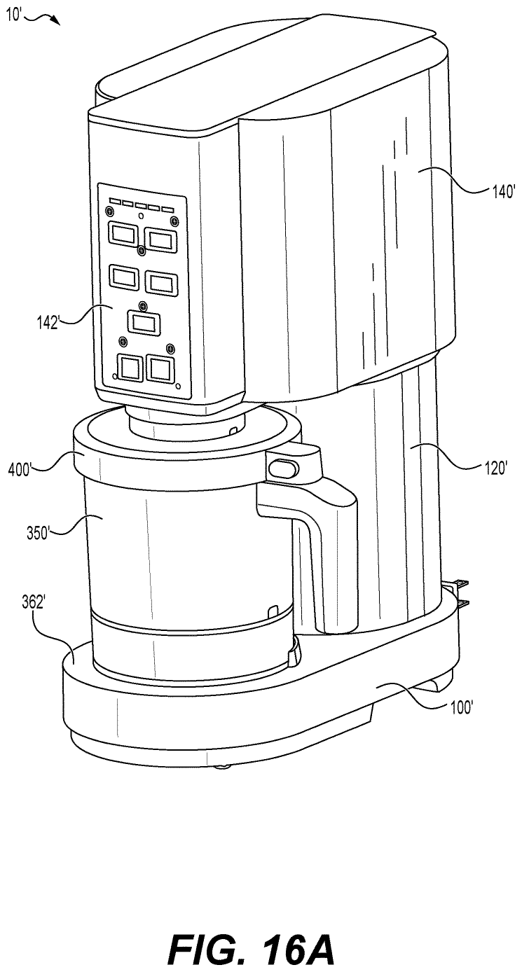

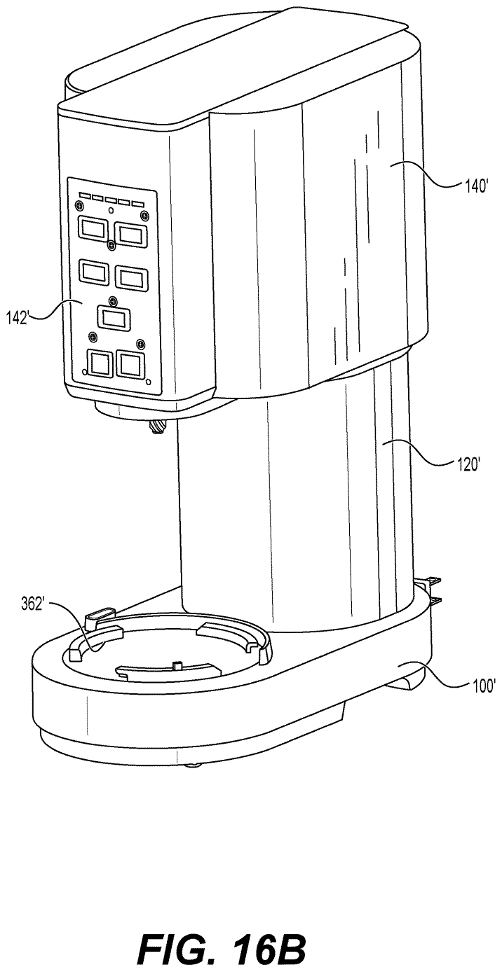

FIG. 16A shows an isometric view of a device 10′ according to an exemplary embodiment of the present disclosure. The device 10′ includes a lower housing or base 100′ and an upper housing 140′. A middle housing 120′ extends between the lower housing 100′ and upper housing 140′. The upper housing 140′ includes an interface 142′ for receiving user inputs to control the device 10′ and/or display information. The device 10′ includes a removable bowl assembly 350′ and lid assembly 400′ on the base 100′. FIG. 16B shows the device 10′ with the bowl assembly 350′ and lid assembly 400′ removed.

As further described herein, the bowl assembly 350′ receives one or more ingredients for processing. The bowl assembly 350′ and lid assembly 400′ are placed on the lower housing 100′ as show in FIG. 16A. The bowl assembly 350′ and lid assembly 400′ are rotatable on a lifting platform 362′ from a down position to an up position, and vice versa.

Advantageously, the micro puree machine 10′ may include a sensor (not shown) that recognizes which lid is installed into the machine 10′ to restrict certain programs based on the lid functions. For example, the user may only activate the blade 300′ when the bowl 352′ is installed in the first configuration and may only activate the plunger 602 when the bowl 352′ is installed in the second configuration. This prevents user error when operating the machine 10′.

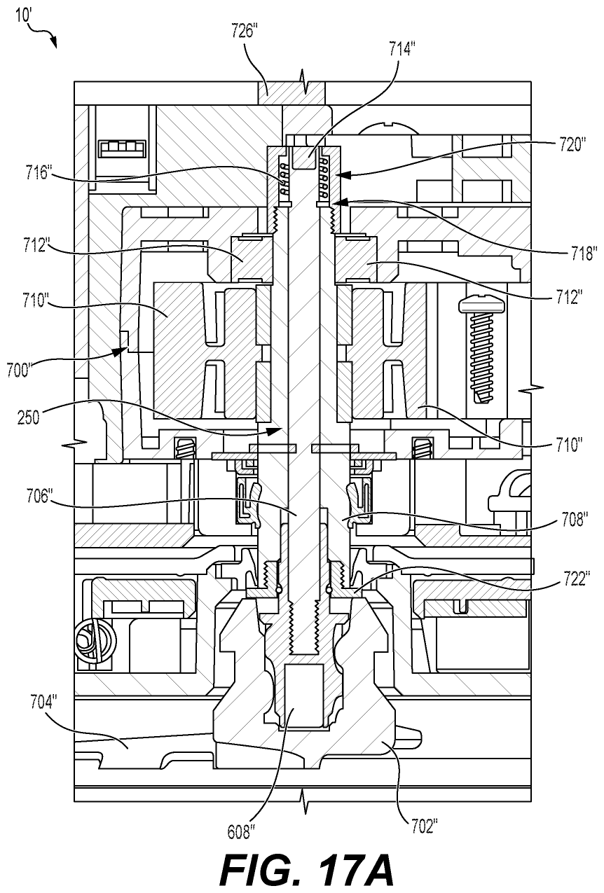

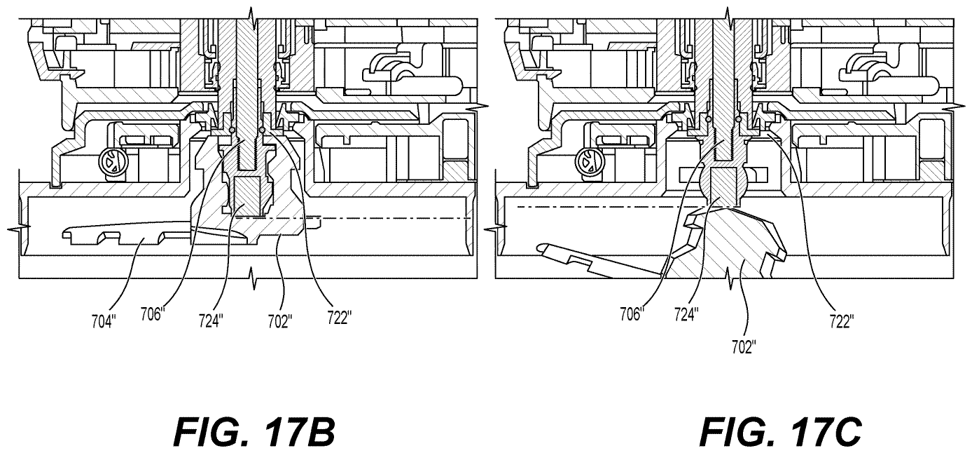

FIG. 17A is a cross-sectional view of machine 10 performing an example kill switch 700″. The kill switch 700″ includes drive and/or mixing shaft 250 positioned in machine 10′. Shaft 250 is connected to coupling 702″, which is used to connect shaft 250 to blade 704″. Shaft 250 includes an inner shaft 706″ and an outer shaft 708″, which rotates in unison and provides the necessary rotational speed to blade 704″ for chopping, stirring, or slicing food ingredients. A ballast 724″ is positioned in a region between coupling 702″ and inner shaft 706″. Ballast 724″ provides the support and balance needed for coupling 702″ to be engaged with shaft 250. A bushing 722″ is threaded to outer shaft 708″. This caps the blade, preventing accidental triggering of kill switch 700″.

A motor 710″ is positioned around shaft 250 and produces the necessary power used by machine 10′ to operate, including providing power to rotate shaft 250. A gearbox 712″ is positioned around shaft 250, near motor 710″, and transfers power from motor 710″ to shaft 250. A magnet 714″ is fixed on one end of inner shaft 706″. Moreover, a spring 716″ biases inner shaft 706″, and a clip 718″ provides a medium for spring 716″ to act against. A bushing 720″ is threaded to outer shaft 708″, which caps spring 716″. The arrangement of spring 716″, clip 718″, and bushing 720″ allows magnet 714″ and inner shaft 706″ to move upwards and downwards within this arrangement. In some instances, pressure plates may be used in place of spring 216 and magnet 714″ to detect upward displacement of inner shaft 704″. A sensor 726″ is configured to detect changes from magnet 714″. Moreover, sensor 726″ is positioned to minimize interference and maximize the detection of the magnetic fields of magnet 714″. In some implementations, sensor 726″ may be a Hall effect sensor 726″ or the like.

FIG. 17B shows the arrangement of machine 10′ when kill switch 700″ is not activated. In this case, the coupling 702″ remains attached to the shaft 250. FIG. 17C illustrates a case example when kill switch 700″ is activated when blade 704″ is dropped. Kill switch 700″ is triggered when coupling 702″ collides with a hard object resulting in blade 704″ being decoupled from coupling 702″. In other cases, blade 704″ may be dropped due to not being connected properly to coupling 702″ and inner shaft 706″ to move upwards. This, in turn, pushes magnet 714″ upwards, which changes its magnetic fields indicating the resistive forces being exerted on inner shaft 706″. Sensor 726″ detects these changes in the magnetic fields to determine if the resistive forces on inner shaft 702″ is significant enough to require shutting down machine 10 for safety reasons. Once the sensor 726″ detects that the changes in magnetic field surpass a threshold requiring machine 10′ to be shutdown, it triggers the shutdown of motor 710″.

Magnet 714″ and sensor 726″ operate similarly like a microswitch, which either keeps machine 10′ running or turning off machine 10′ when inner shaft 706″ has experienced a specified amount of hazardous resistive forces due to blade 704″ being dropped or unable to process food ingredients.

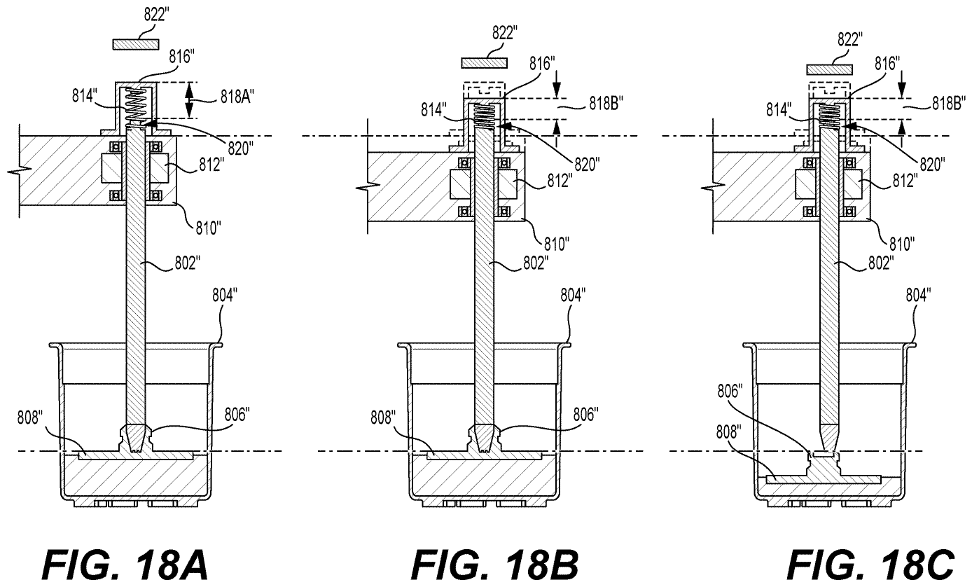

FIGS. 18A-18C are schematic diagrams of the details of performing an example kill shaft technique in machine 10′. The kill shaft technique involves measuring resistive forces being experienced by a shaft 802″. When the resistive forces are too high machine 10′ is shut down. In particular, FIG. 18A shows machine 10′ during normal operations. Inner shaft 802″ is securely placed in a bowl 804″ for processing food ingredients. Coupling 806″ connects inner shaft 802″ to blade 808″. Bowl 804″ is configured to received the food ingredients, including frozen food ingredients. Depending on the user′s preference, blade 808″ may dice, mince, cut, or blend the food ingredients in bowl 804″ to make ice cream. A motor 810″ is positioned around inner shaft 802″ and produces the necessary power used by machine 10′ to operate, including providing power to rotate shaft 802″. A gearbox 812″ is positioned around inner shaft 802″, near motor 810″, and transfers power from motor 810″ to shaft 802″. In one implementation, a spring 814″ is fixed on the top end of shaft 802″. A portion of shaft 802″ and spring 814″ are positioned within bushing 816″. The arrangement of spring 814″ and bushing 816″ allows for inner shaft 802″ to move up or down biased by spring 814″ within bushing 816″. Spring 814″ is preloaded in normal operation to a partially compressed state, by a normal operation force, with a length defined by the normal gap in bushing 816″. During normal operations, shaft 802″ is sprung down by spring 814″. Gearbox 812″ and shaft 802″ move together if the resistance from the ingredients of the ice cream is in the normal operation range. A magnet 820″ is fixed on one end of inner shaft 802″ to detect changes in the normal gap. A sensor may be positioned with machine 10′ to minimize interference and maximize the detection of the magnetic fields of magnet 820″. In some implementations, the sensor may be a Hall effect sensor or the like.

In other implementations, spring 814″ may be used to detect deviation. The deviation may be detected by monitoring the partial deflection of spring 814″ or electrically monitoring the force on spring 814″.

FIG. 18B shows an instance when the ingredients in bowl 804″ are excessively hard leading to possible damage to inner shaft 802″, blade 808″, gear 812″, and motor 810″, or other internal components machine 10′. In this case, gearbox 812″ continues to drive downwards but the blade 808″ and inner shaft 802″ are stopped due to too the hard ingredients leading to blade 808″ being dropped or damaged. This causes the inner shaft 802″ to be pushed upwards compressing spring 814″ and reducing the gap in bushing 816″ resulting in variations of the magnetic fields of magnet 820″, which are detected by the sensor. The smaller the size of the reduced gap 818B″ the more resistive forces being experienced by shaft 802″. To prevent damage to machine 10′, a threshold, associated with the detected variations of the magnetic fields of magnet 820″, may be assigned to the reduced gap 818B″ to indicate inner shaft 802″ is experiencing very dangerous resistive forces requiring motor 810″ to stop providing power to inner shaft 802″.

FIG. 18C shows an instance when inner shaft 802″ is not properly connected to blade 808″. This may occur either after the proper connection between shaft 802″ and blade 808″, where disruption occurs, causing blade 808″ to be dislodged from shaft 802″, or blade 808″ is initially improperly connected to shaft 802″ prior to operation. This results in gearbox 812″ continuing to drive downwards but inner shaft 802″ is prevented from moving downward due to blade 808″. This causes the shaft 802″ to be pushed upwards compressing spring 814″ and reducing the gap in bushing 816″ resulting in variations of the magnetic fields of magnet 820″, which are detected by the sensor. As mentioned in FIG. 18C, the smaller the size of the reduced gap 818B″ the more resistive forces being experienced by inner shaft 802″. To prevent damage to machine 10′, a threshold, associated with the detected variations of the magnetic fields of magnet 820″, may be assigned to the reduced gap 818B″ to indicate shaft 802″ is experiencing very dangerous resistive forces by disengaging motor 810″ from providing power to inner shaft 802″. This protects from damage inner shaft 802″, blade 808″, gear 812″, motor 810″, and other internal components machine 10′.

Magnet 820″ and sensor 822″ operate similarly like a microswitch, which disengages inner shaft 802″ from motor 810″ when inner shaft 802″ experiences a specified amount of hazardous resistive forces due to blade 704″ being dropped or unable to process food ingredients.

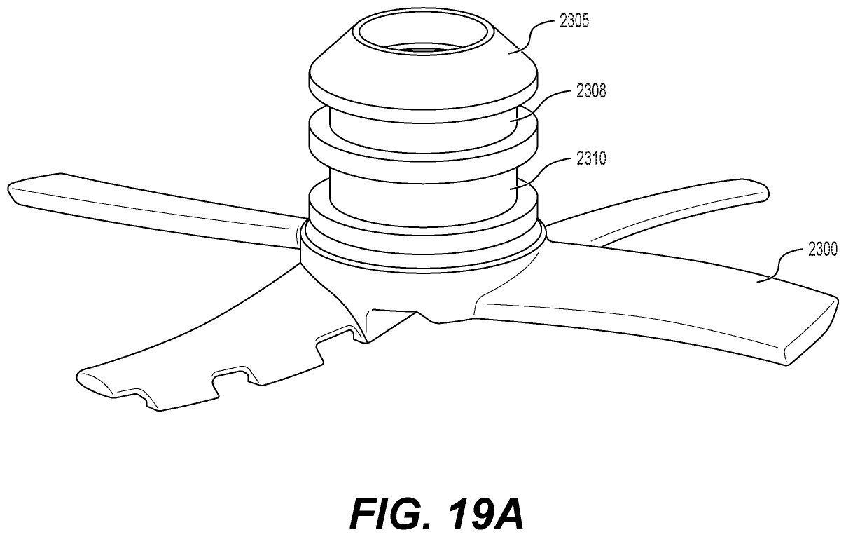

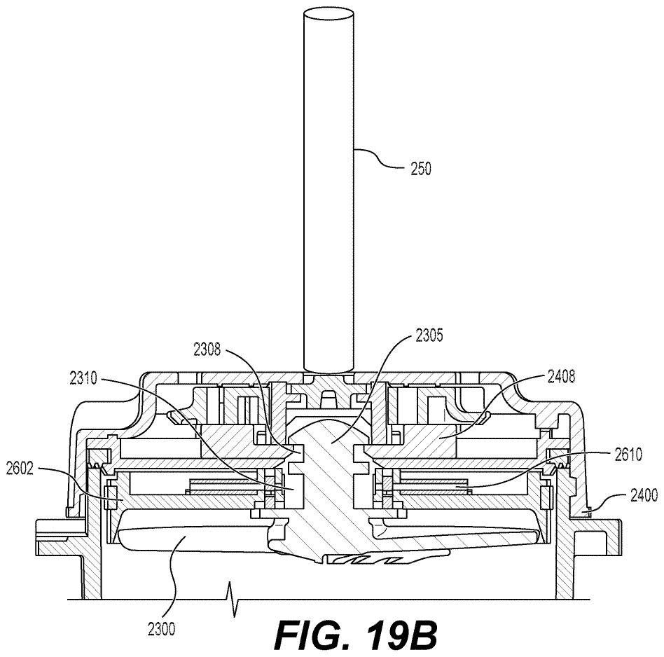

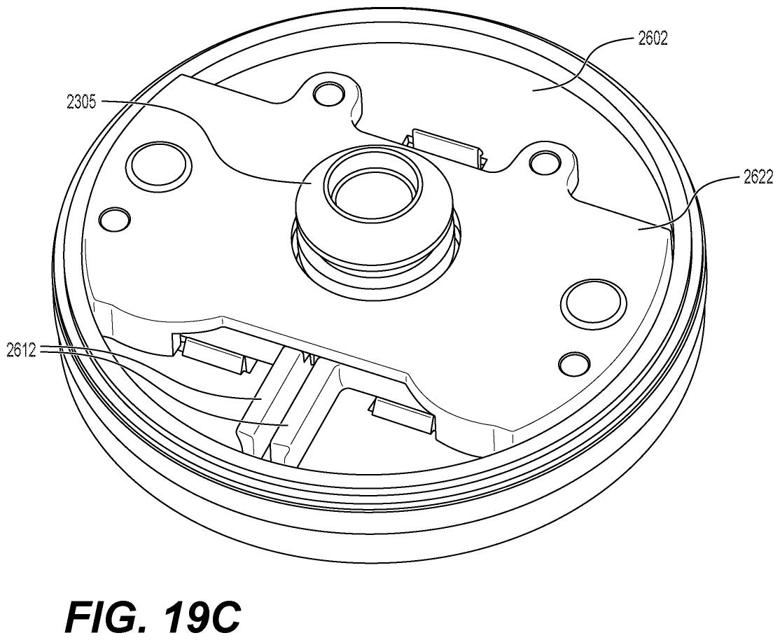

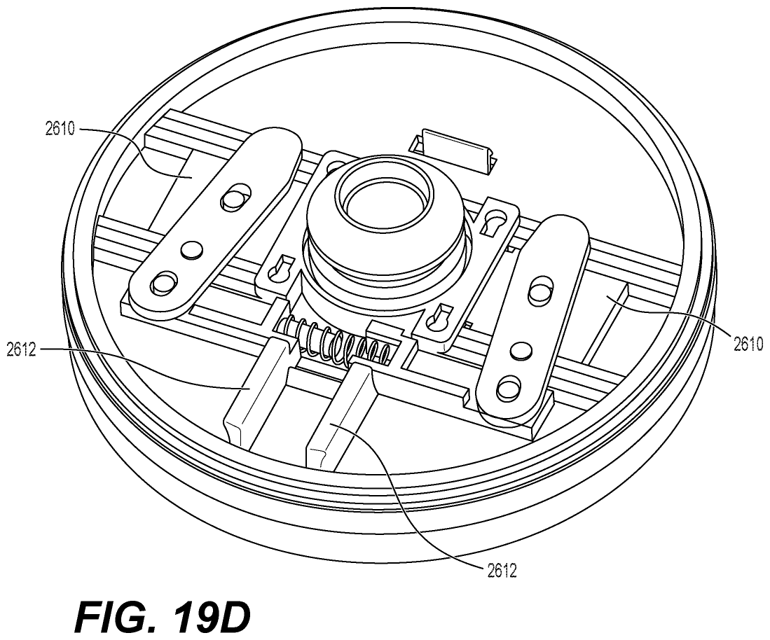

FIGS. 19A-19D illustrate an example extended shaft 250 used to determine if a blade assembly 2300 is properly positioned in a lid 2400. As shown in FIG. 19A, the central support hub 2305 of the blade assembly 2300 may include an upper groove 2308 and a lower groove 2310. As shown in FIG. 19B, the lid 2400 may include a first set of engagement features, such as primary clips 2408, that are biased (e.g., spring biased) toward the central support hub 2305. As the user installs the blade assembly 2300 to the lid 2400, the primary clips 2408 may engage the upper groove 2308 of the central support hub 2305. In this configuration, a second set of engagement features on the plunger 2602, such as secondary clips 2610, are disengaged from the lower groove 2310 such that the blade assembly 2300 can be driven axially and rotationally by the driven shaft 250 independent of the plunger 2602.

FIGS. 19C-19D illustrate the configuration and movement of the secondary clips 2610 according to some embodiments of the disclosure. As shown in FIG. 19C, an upper surface of the plunger 2602 may comprise a set of moveable magnetic levers 2612 disposed within a housing 2622 that is configured to allow for passage of the central support hub 2305. As shown in FIG. 19D, the levers 2612 may be operatively coupled to the secondary clips 2610 such that the levers 2612 are positioned apart when the secondary clips 2610 are engaged with the lower groove 2310.

Extended shaft 250 is configured to enable detection of whether the blade assembly 2300 is properly positioned within the lid 2400, not whether the blade assembly 2300 is connected to the shaft 250. Shaft 250 is extended vertically to ensure that the blade assembly is not partially connected to shaft 250 by, for example, by pushing a partially connected blade assembly 2300 from lid 2400 before detection of the blade levers 2612 is performed. If blade assembly 2300 is fully engaged with clips 2408 or 2610 of lid 2400, the extended blade shaft 250 properly engages with blade assembly 2300 while the lever's position is rotated such that its magnetic field is in a sufficiently close position to trigger sensors, such as sensors 726 or 822, indicating that blade assembly 2300 is properly and/or fully engaged within lid 2400. If the blade assembly is not fully or properly engaged with clips 2408 or 2610 of lid 2400, extended blade shaft 250 will not properly engage with blade assembly 2300, pushing down on and causing extended blade shaft 250 to disengage blade assembly 2300 from clips 2408 or 2610 of lid 2400 which, in turn, causes levers 2612 to move to the “no blade” position. Thus, when the container is rotated to the upward/engaged position, the lever magnet is not in a sufficiently closed position to trigger a sensor.

In some embodiments of the disclosure, a drip stop for an extrusion nozzle of a micro-processing machine (or other type of device for processing food) may be provided, as now will be described.

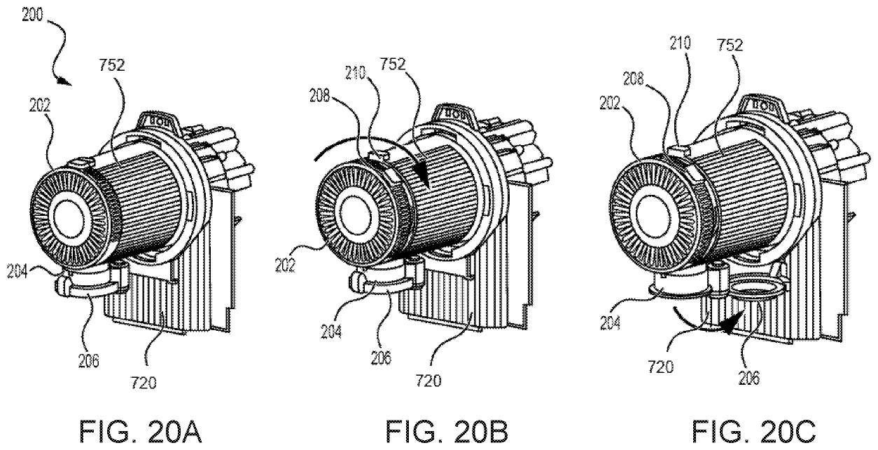

FIGS. 20A-20C are schematic diagrams of an example extrusion nozzle assembly 200 used with a micro-puree machine. In this implementation, the micropuree machine is similar to micro-puree machine 700 of FIGS. 5A-5L. Extrusion nozzle assembly 200 may include a radial dial 202, a nozzle 204, a drip stop 206, and protruding sections 208 and 210. When protruding rib sections 208 and 210 are aligned, as shown in FIG. 20A, this indicates that extrusion nozzle assembly 200 is in a closed position. Otherwise, extrusion nozzle assembly 200 is in an open position, as shown in FIGS. 20B and 20C. To extrude processed ingredients (e g., frozen or semifrozen food material) in processing bowl 752, a user may rotate radial dial 202 to the open position to start a flow path from inside processing bowl 752 through nozzle 204, as shown in FIG. 20B. However, the user can still not extrude until drip stop 206 detaches from nozzle 204 and is rotated into the open position, as shown in FIG. 20C.

Extrusion nozzle assembly 200 may include a bayonet coupling and may be detached for cleaning. Moreover, extrusion nozzle assembly 200 may be tethered to processing bowl 752 by a strap or the like. In some implementations, extrusion nozzle assembly 200 may work with other micro-puree machines besides micro-puree machine 700.

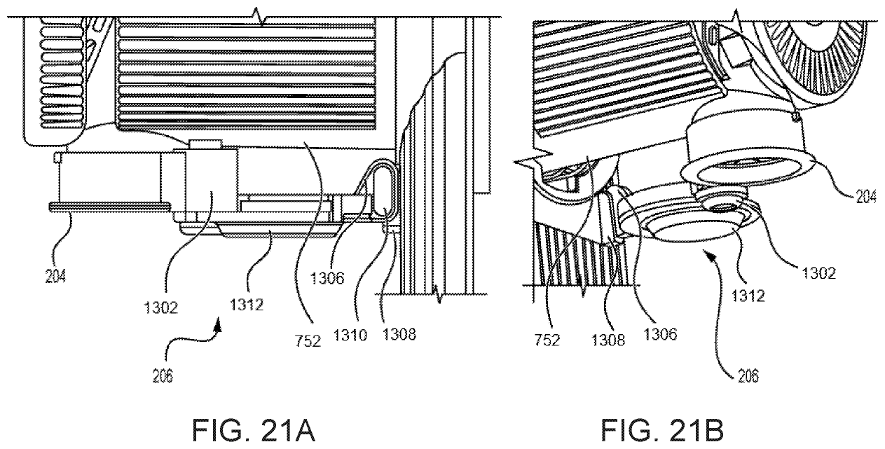

FIGS. 21A-21B are schematic diagrams of different views of extrusion nozzle assembly 200 of FIGS. 20A-20C. FIG. 21A is a side view of extrusion nozzle assembly 200 showing nozzle 204 coupled to drip stop 206 via a hinge 1302. Drip stop 206 may include a plate 1312 and finger grip 1306 positioned on plate 1312. Plate 1312 may be configured to protect and collect spillage from nozzle 204 when idled or in the closed position. Hinge 1302 may extend vertically from processing bowl 752, where nozzle 204 connects to one side of hinge 1302, and one end of drip stop 206 connects to the bottom of hinge 1302.

Drip stop 206 may be configured to rotate about hinge 1302. The other end of drip stop 206 may connect to housing 720 via a finger grip 1306 on a finger grip holder 1308, as shown in FIG. 21B. A user may move finger grip 1306 in a rotated motion to finger grip holder 1308. Holder 1308 may connect to housing 720 of the micro-puree machine 700. Finger grip 1306 may include a magnet 1310, and when drip stop 206 is in the open position, magnet 1308 may align with a hall sensor or reed switch in housing 720 to indicate to micro-puree machine 700 that it is in the open position. This prevents the user from extruding until drip stop 206 is in the open position.

In other implementations, magnet 1310 may be placed in a different location on finger grip 1306 to align with a hall sensor or reed switch in housing 720.

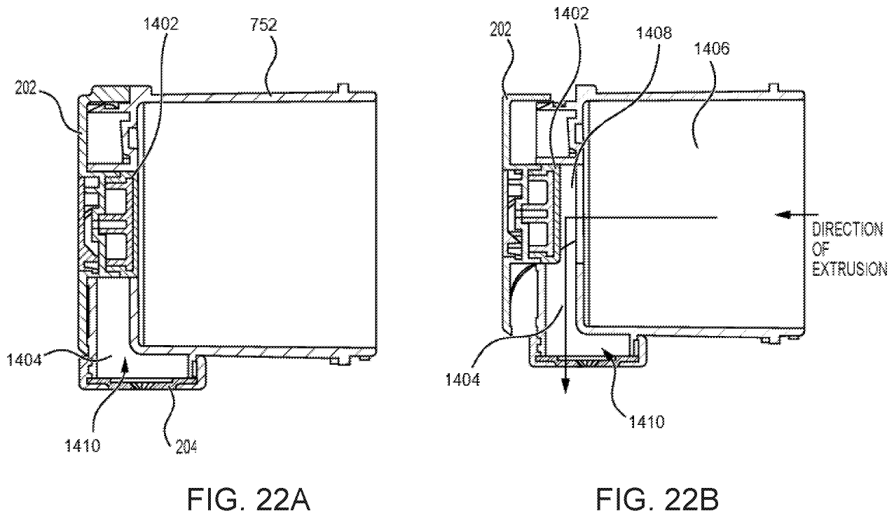

FIGS. 22A-22B are schematic diagrams of cross-sectional views of an example extrusion nozzle assembly 200 of FIGS. 20A-20C. FIG. 22A shows protruding rib sections 208 and 210 being aligned, indicating extrusion 200 is in the closed position. Extrusion nozzle assembly 200 may include a plunger 1402, plunger channel 1404, an inlet 1408, and an outlet 1410. Inlet 1408 may be arranged to receive the processed ingredient from the processing bowl 752 and outlet 1410 is arranged to output the processed ingredients from extrusion nozzle assembly 200. When extrusion nozzle assembly 200 is closed, plunger 1402 may seal inlet 1408 from an opening at one end of processing bowl 752 from which frozen food materials are extruded. As described herein, when the user moves dial 202 to the open position, resulting in protruding rib sections 208 and 210 being misaligned, plunger 1402 unseals the opening, allowing frozen food materials to extrude into inlet 1408, as shown by arrow 1406, through plunger channel 1404 of outlet 1410 and out to nozzle 204 when drip stop 206 is in the open position.

In this implementation, plunger1 402 may unseal the opening through lever actuation due to the movement of dial 202. In other implementations, plunger 1402 may unseal the opening using MEMS actuation or the like.

In some embodiments of the disclosure, a drip tray, for example, a movable drip tray, for an extrusion component of a micro-puree machine, may be provided, as now will be described.

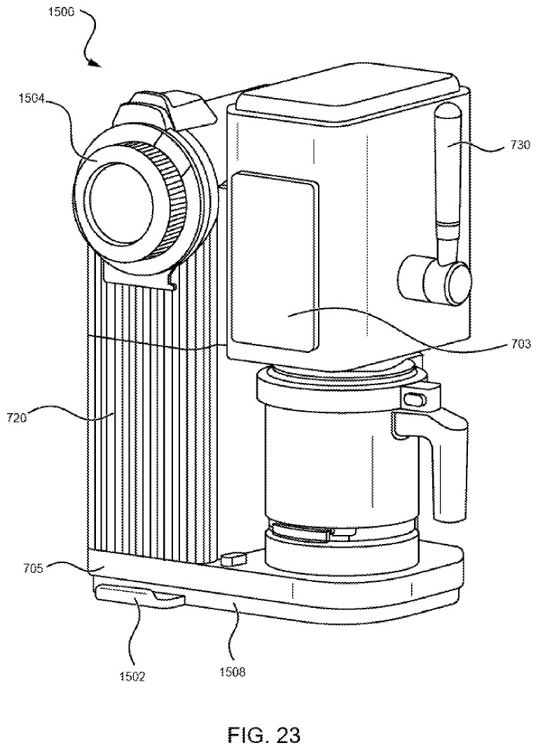

FIG. 23 is a schematic diagram of a micro-puree machine 1500 with an example drip tray 1502 and an example extrusion storage assembly 1504. Micro-puree machine 5100 may be similar to micro-puree machine 700 of FIGS. 5A-5L, except that processing bowl 752, including extrusion nozzle assembly 200, may be removed. Moreover, micro-puree machine 1500 may include a drip tray 1502 and an extrusion storage assembly 1504. Drip tray 1502 may be positioned in an opening of base 1508 of micro-puree machine 1500. Moreover, drip tray 1502 may extend horizontally underneath nozzle 204 to collect any spillage from extrusion nozzle 204 when processing bowl 752 is used. Extrusion storage assembly 1504 may protect the interior components of micropuree machine 1500 in housing 720, such as interior couplings and a driven shaft, when processing bowl 752 is removed. In this implementation, a driven shaft may extend through the coupling to couple with either a blade or a plunger housed within an extrusion lid. Further details regarding drip tray 1502 and extrusion storage assembly 1504 are provided below.

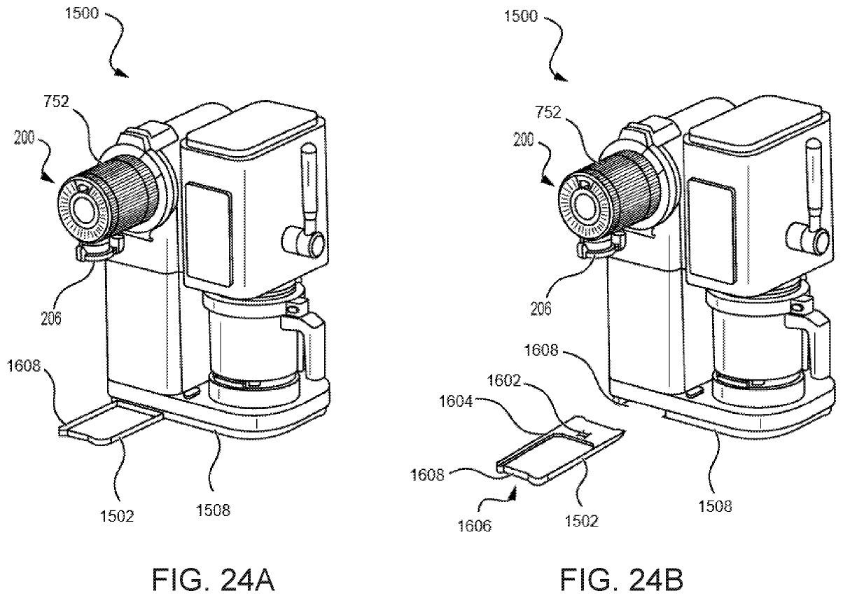

FIGS. 24A-24B are detailed schematic diagrams of drip tray 1502 of micropuree machine 1500 connected with processing bowl 752 and extrusion nozzle assembly 200. As shown in FIG. 24A, drip tray 1502 may include a grip 1608 used for horizontally extending drip tray 1502 to be positioned underneath nozzle 204 of micro-puree machine 1500 to collect any spillage from extrusion nozzle assembly 200 when processing bowl 752 is in use. Drip tray 1502 may include a latch 1602 and a rib section 1604 to securely position it in opening 1608 of base 1508, as shown in FIG. 24B. Latch 1602 may be positioned on rib section 1604. Rib section 1604 may provide structural support to latch 1602. Drip tray 1502 may be sized to horizontally extend from base 1508 to an open position underneath extrusion nozzle assembly 200 without being removed from base 1508.

When this occurs, rib section 1604 may be located at the exact location as front portion 1606 of drip tray 1502 is located when drip tray 1502 is in a close position, as shown in FIG. 23. A user may also remove drip tray 1502 from base 1508 for cleaning by further extending drip tray 1502 beyond rib section 1604 resulting in latch 1604 detaching from base 1508 and complete removal of drip tray 1502 from micro-puree machine 1500, as shown in FIG. 24B. The user may reattach drip tray 1502 to base 1508 by sliding drip tray 1502 into opening 1608 until rib section 1604 is correctly aligned with opening 1608 so latch 1604 is attached to base 1508. Once latch 1604 may attach to base 1508, the user may further slide the remaining portion of drip 1604 into opening 1608. Drip tray 1502 may be made from non-corrosive plastics or metals.

In some embodiments of the disclosure, a storage container for extrusion components (and/or other components) of a micro-processing machine (or other type of device for processing food) may be provided, as now will be described.

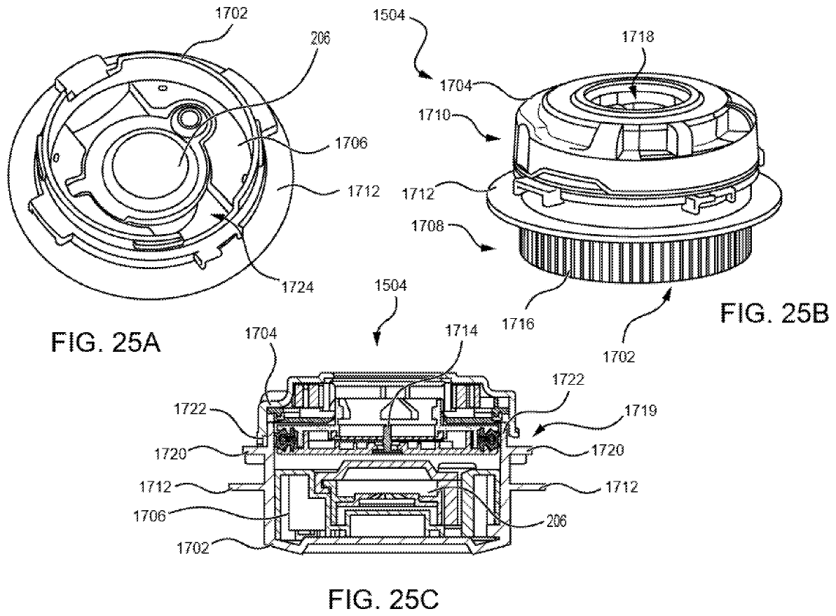

FIGS. 25A-25C are schematic diagrams of an extrusion storage assembly 1504 of FIG. 23. Extrusion storage assembly 1504 may provide storage for drip stop 206 and the extrusion lid of micro-puree machine 1500 when the processing bowl 752 has been removed. Moreover, extrusion storage assembly 1504 may prevent spillage of food materials, including protecting the interior components of micro-puree machine 1500 in housing 720 when processing bowl 752 is removed. Extrusion storage assembly 1504 may include a storage container 1702 and an extrusion lid 1704.

Storage container 1702 may provide storage for drip stop 206 when processing bowl 752 is removed, as shown in FIG. 25A. Storage container 1702 may include housing 1724 defining a compartment 1706 specifically designed to receive and protect drip stop 206. Extrusion lid 1704 may be associated with the same extrusion lid that houses extrusion plunger 1714 used by micro-puree machine 1500. Both storage container 1702 and extrusion lid 1704 may be arranged where extrusion lid 1704 is attached to storage container 1702, forming extrusion storage assembly 1504, as shown in FIG. 25B.

Extrusion storage assembly 1504 may include a circular flap 1712 that separates the front portion 1708 and back portion 1710 of extrusion storage assembly 1504. Front portion 1708 of extrusion storage assembly 1504 may be external to micro-puree machine 1500 while back portion 1710 is positioned internally to the micro-puree machine 1500. Also, front portion 1708 of extrusion storage assembly 1504 may include a dial 1716 that may be rotated by a user to couple the extrusion storage assembly 1504 to micropuree machine 1500 via bayonet tabs of coupler 1719. The user may press storage assembly 1504 against back portion 1710, which includes extrusion lid 1704 with an opening 1718 to receive and protect the driven shaft of micro-puree machine 1500.

FIG. 25C shows a cross-sectional view of extrusion storage and/or storage assembly 1504. As depicted, drip stop 206 is positioned in container 1702 while extrusion plunger 1714 is positioned in extrusion lid 1704. Storage container 1702 may include an interface coupler 1719 having several protruding sections or bayonet tabs 1720, including upper portions 1722 extending vertically from protruding sections 1720. Moreover, each outer portion 1722 of the storage container 1702 may form a component coupler that is positioned within extrusion lid 1704, allowing the extrusion lid 1704 to be securely locked with and/or coupled to storage container 1702 to form extrusion storage assembly 1504.

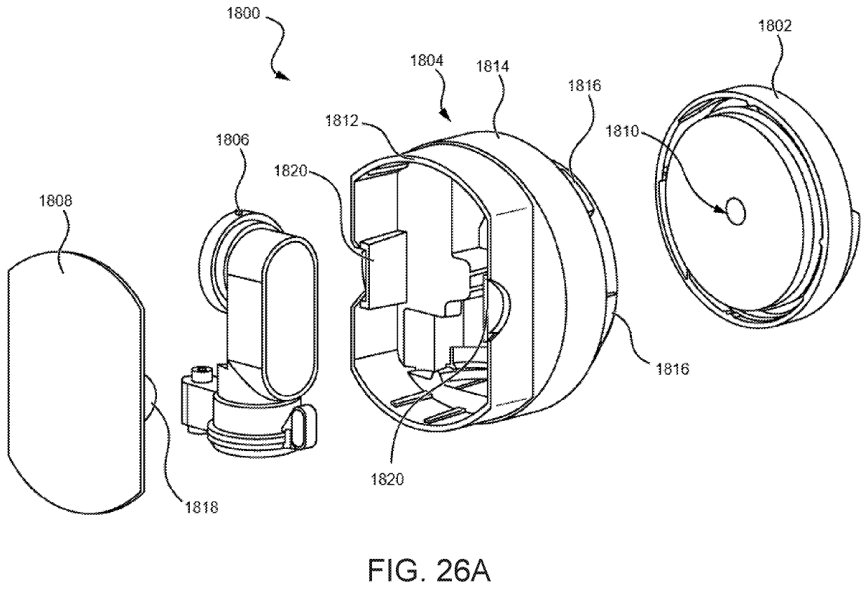

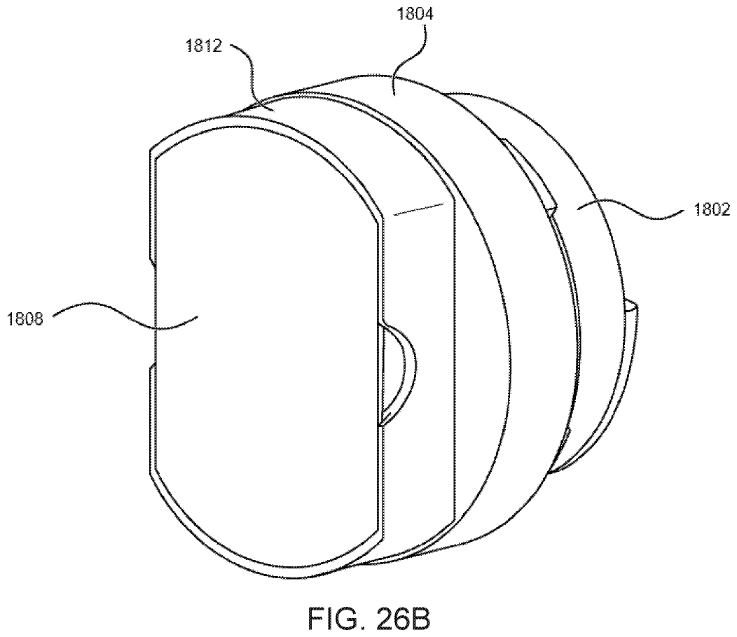

FIGS. 26A-26B are schematic diagrams of another example extrusion storage and/or storage assembly 1800. Extrusion storage 1800 may work with micro-puree machine 700 or the like. Extrusion storage 1800 may prevent spillage of food materials, including protecting the interior components of micro-puree machine 1500 in housing 720, such as interior couplings and a driven shaft, when processing bowl 752 is removed. Moreover, extrusion storage 1800 may store components used to extrude frozen materials when processing bowl 752 is not in use. FIG. 26A shows the exploded view of extrusion storage 1800 having an extrusion lid 1802 of micro-puree machine 700, a storage container 1804, an inlet 1806 of micro-puree machine 1500, and a cover 1808, as shown in FIG. 26A. Extrusion lid 1802 may include an opening 1810 for receiving and protecting the driven shaft of micropuree machine 700. Moreover, inlet 1806 may be a detachable nozzle used by micropuree machine 1500. In some implementations, inlet 1806 may be replaced by other extrusion components used by micro-puree machine 1500 for storage.

Moreover, extrusion lid 1802 may house the extrusion plunger used by micropuree machine 700 for extrusion. Storage container 1804 may include an inlet protection portion 1812 for housing inlet 1806 and a coupling section 1814 that is securely connected to the extrusion lid. Cover 1808 may be securely placed on the open side of inlet protection portion 1812 to protect inlet 1806.

FIG. 26B shows the assembled view of extrusion storage 1800. In this implementation, coupling section 1814 and extrusion lid 1802 may be attached and positioned within micro-puree machine 1500. Coupling section 1814 may include several protruding sections 1816 that securely lock extrusion lid 1802 in place, allowing for coupling section 1814 and extrusion lid 1802 to be attached. Also, inlet protection 1812 and cover 1808 may be attached and positioned at the exterior of micro-puree machine 1500. Cover 1808 may include one or more protruding sections 1818, and inlet protection 1812 contains one or more receiving portions 1820 for receiving the one or more protruding sections 1818 to securely connect cover 1808 to inlet protection 1812. In this implementation, one or more protruding sections 1818 may snap into one or more receiving portions 1820. In other implementations, one may connect one or more protruding sections 1818 to one or more receiving portions 1820 using other means besides that described here.

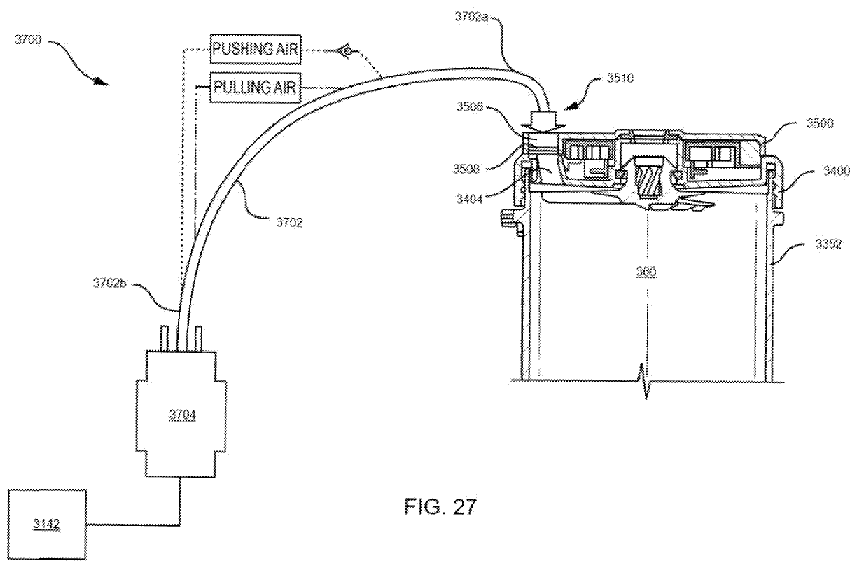

FIG. 27 illustrates an aeration system 3700 for use with the micro-puree machine 10, according to some embodiments of the disclosure. As shown in FIG. 27, the aeration system 3700 may comprise an opening 3506 in the coupling 3500. When the bowl 3352 is in the first configuration, the interior volume 3360 may be substantially sealed from ambient air. The opening 3506 may include a filter 3508 for filtering dust particles and debris from entering the interior volume 3360. A first end 3702a of a tube 3702 may operatively attach to the opening 3506 via a pliable stopper 3510 (for example, a silicone bung) such that the tube 3702 is in fluid communication with the interior volume 3360. A second end 3702b of the tube 3702 may operatively couple to a pump 3704 or other mechanism for forcing fluids (e.g., pushing air) in fluid communication with the tube 3702. The pump 3704 may be operable to change a pressure of the interior volume 3360 of the bowl 3352 by selectively pumping gas (e.g., air) into or pulling gas (e.g., air) out of the interior volume 3360 during processing. The addition of air or gas to the ingredients during processing may allow a user to change a density and texture of the final product. For example, processing the ingredient under a high pressure (for example, 8 psi) results in a lighter and airier output. In embodiments, the aeration system 3700 may be integrated into a processing program on the user interface 3142 with a predetermined processing time and aeration percentage. The disclosure also contemplates that the user interface 3142 would have a separate aeration input to allow for further user control.

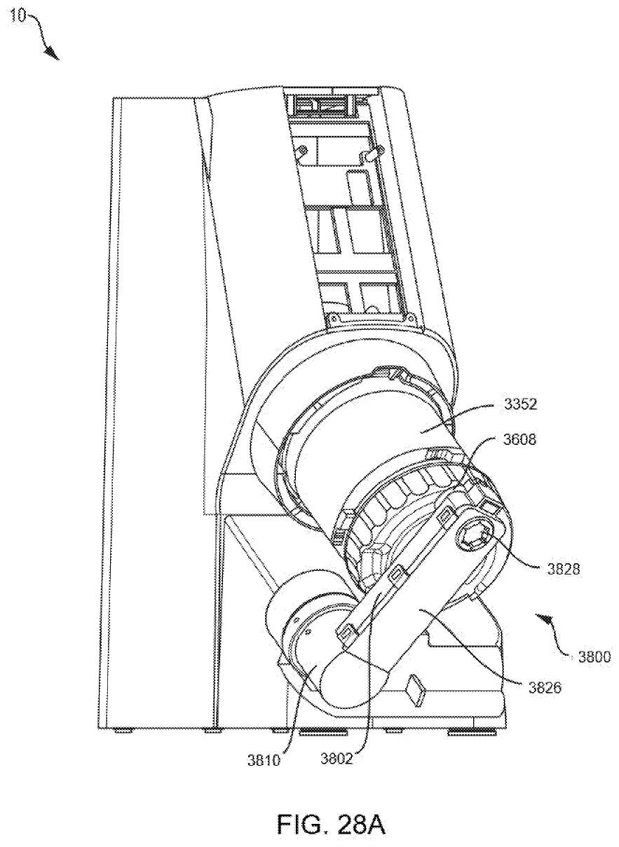

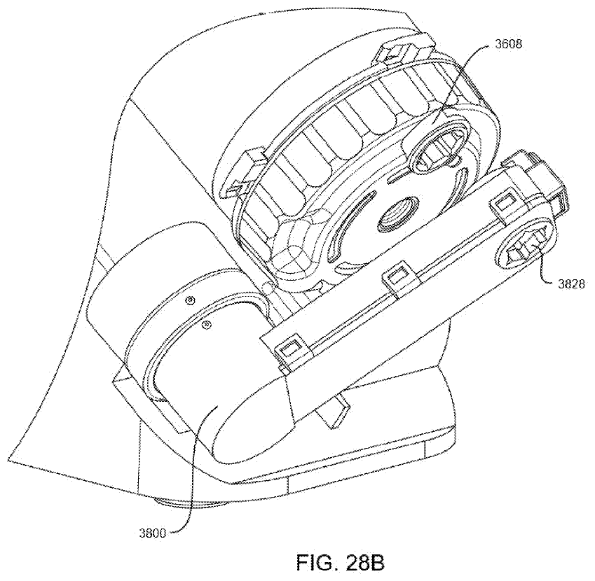

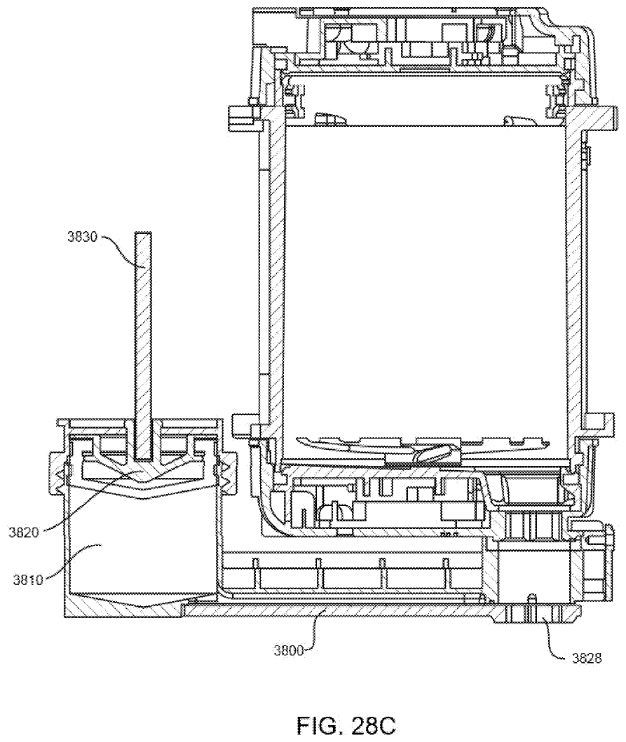

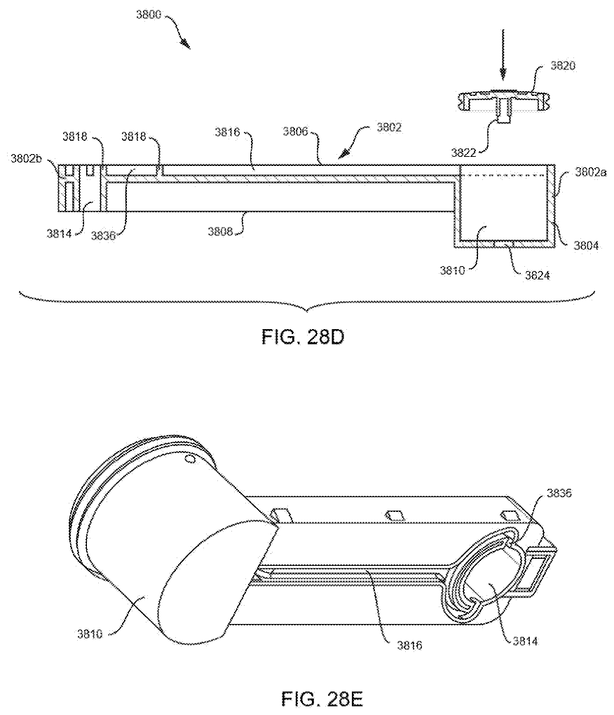

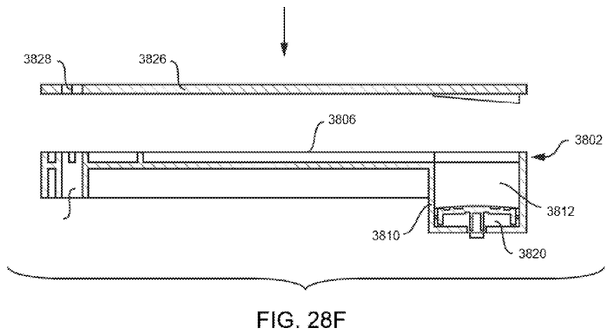

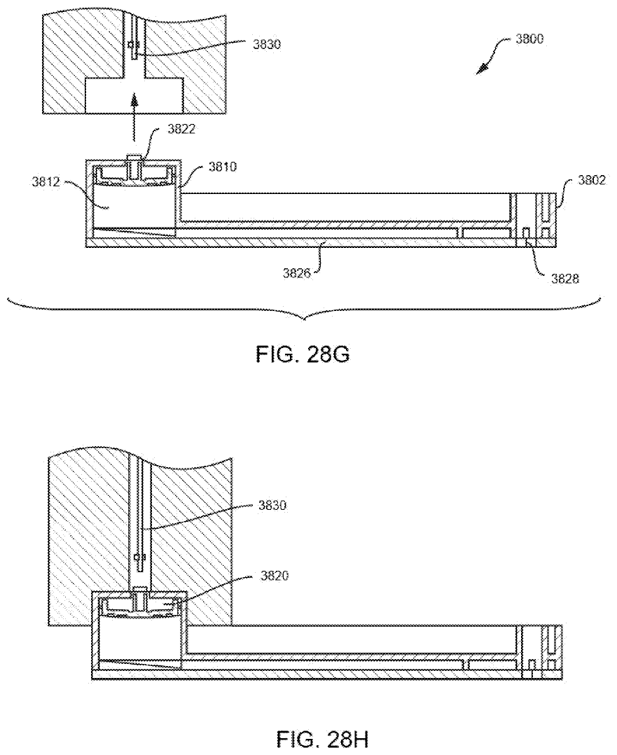

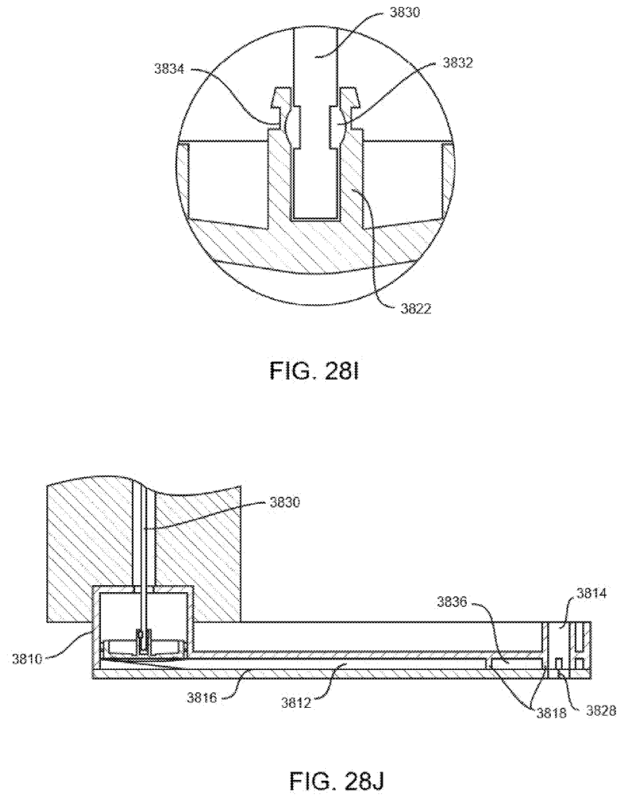

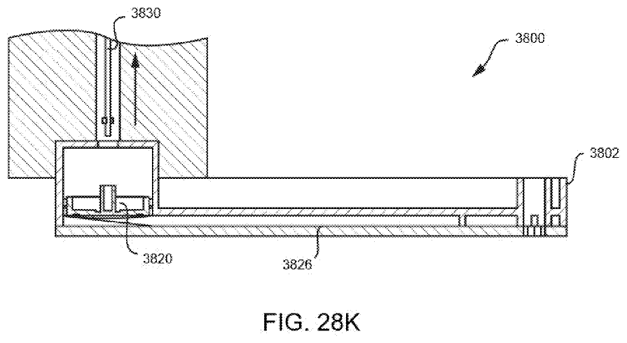

FIGS. 28A-28C illustrate an automated additive assembly 3800 for use with the micro-puree machine 10, according to some embodiments of this disclosure. As shown in FIG. 28A, the additive assembly 3800 may assemble to the micro-puree machine 10 and be configured for holding an additive ingredient capable of being extruded through an opening 3828 in the assembly 3800 along with the processed ingredients in the bowl 3352. For example, the additive ingredient may be syrups, sauces, jams, and the like. Embodiments of the additive assembly 3800 may generally comprise an elongated body 3802 including a reservoir 3810 for holding the additive ingredient, and a lid 3826 including the opening 3828. In embodiments, the lid 3826 may form a snap fit with the body 3802. However, the disclosure contemplates that the lid 3826 may couple to the body 3802 by another means, such as with an interference fit. FIG. 28A shows the additive assembly 3800 engaged with the nozzle 3608, while FIG. 28B shows the additive assembly disengaged from the nozzle 3608. As shown in FIG. 28C, the additive assembly 3800 may further include a plunger 3820 connectable to a rod 3830. The plunger 3820 may be insertable into the reservoir 3810 for extruding the additive ingredient through the opening 3828.

FIGS. 28D-28F further illustrate components of the additive assembly 3800, according to some embodiments. As shown in FIG. 28D, the additive assembly 3800 may comprise the elongated body 3802 having at least one sidewall 3804 defining an open first surface 3806 and a closed second surface 3808. A first end 3802a of the body 3802 may include the reservoir 3810 defined through the body 3802. A second end 3802b of the body 3802 may include a transverse channel 3814 defined through the body 3802 and alignable with the nozzle 3608. A passage 3816 in fluid communication with the reservoir 3810 may extend toward the channel 3814. The plunger 3820 may be inserted into the reservoir 3810 such that a connector 3822 on the plunger 3820 extends through a first opening 3824 in the reservoir 3810. As shown in FIG. 28E, the passage 3816 may include a circumferential groove 3836 at least partially surrounding and in fluid communication with the channel 3814. As shown in FIG. 28F, after inserting the plunger 3820 into the reservoir 3810 from the open first surface 3806, a user may fill the reservoir 3810 with the additive ingredient 3812 and secure the lid 3826 to the open first surface 3806. The interface between the lid 3826 and the body 3802 may enable a tight seal that prevents any ingress or leaking of the additive ingredients 3812 into the machine 10. The lid 3826 may define a second opening 3828 in communication with the channel 3814, and which may be fluidly connected to the nozzle 3608 (FIG. 28B).

FIGS. 28G-28K illustrate the use of the additive assembly 3800, according to some embodiments of the disclosure. As shown in FIG. 28G, once the reservoir 3810 has been filled with the additive ingredient 3812 and the lid 3826 has been secured to the body 3802, the user may invert the body 3802 such that the connector 3822 is attachable to a rod 3830 on the micro-puree machine 10. The user may further arrange the additive assembly 3800 such that the opening 3828 in the lid 3826 is in fluid communication with the nozzle 3608. In embodiments, the rod 3830 may be configured to operate separately from the driven shaft 3250. However, the disclosure contemplates that the rod 3830 may be operably connected to the driven shaft 3250. As shown in FIG. 28H, the user may activate a setting on the user interface 3142 to move the rod 3830 axially toward the plunger 3820. As shown in FIG. 28I, the rod 3830 may then engage the plunger 3820. For example, the rod 3830 may engage the plunger 3820 by the engagement of a circumferential projection 3832 on the rod 3830 with a corresponding groove 3834 on an internal surface of the connector 3822. However, the disclosure contemplates other suitable engagement means between the rod 3830 and the plunger 3820. As shown in FIG. 28J, axial movement of the plunger 3830 through the reservoir 3810 may force the additive ingredient 3812 into the passage 3816 and the groove 3836 such that the additive ingredient 3812 flows though the channel 3814 and out through the opening 3828. As such, the additive ingredient 3812 may be “swirled” into the processed ingredients extruded from the bowl 3352. As shown in FIG. 28K, once the additive operation is complete, the rod 3830 may automatically disengage from the plunger 3820. The user may then disassemble the additive assembly 3800 from the micro-puree machine 10. Advantageously, the lid 3826 and the plunger 3820 may be removed from the body 3802 for easy cleaning of the component parts.

In embodiments, the additive assembly 3800 may be powered by a motor that is separate from the one or more motors operating the driven shaft 3250 to allow for precise user control over both when the additive ingredient 3812 is added, as well as the amount of the additive ingredient 3812 added. If the user decides not to use all of the additive ingredient 3812, the additive assembly 3800 can be removed from the micro-puree machine 10 and stored for later use. High ratio gearboxes and reinforced internals in the micro-puree machine 10 may allow for the additive assembly 3800 to withstand the high forces necessary to extrude thick ingredients.

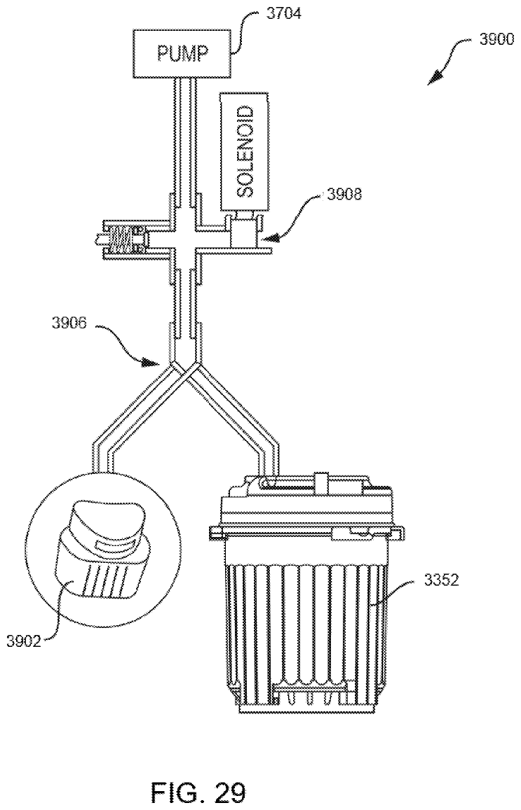

FIG. 29 schematically illustrates another automated additive assembly 3900 for use with the micro-puree machine 10, according to some embodiments of this disclosure. As shown in FIG. 29, the automated additive assembly 3900 may use the air pump 3704 (FIG. 27) configured to be in fluid communication with both a pod 3902 containing the additive ingredient 3812 and the bowl 3352. The air pump 3704 may configured to pressurize the pod 3902 to extrude the additive ingredient 3812 through the nozzle 3608. A change over valve 3906 may redirect the air flow based on which function is selected—i.e., between pressurizing the bowl 3352 during processing and pressurizing the pod 3902 during extrusion of the additive ingredient. A solenoid valve 3908 may be configured to open at the end of the extrusion cycle to release the pressure in the pod 3902.

The disclosure contemplates that, in some embodiments (not shown), the bowl 3352 can be coupled vertically in an inverted orientation (i.e., downward) on a top or upward-facing surface of the housing 120 whereby blade 3300 moves up and then down to creamify, process, and/or mix ingredients in the bowl 3352. The upward-facing surface may face vertically upward or be angled in an upward direction. In some embodiments, micro-puree machine 10 may be configured to automatically detect a size of the bowl 3352 and, in response to the detection, extend the blade 3300 a depth and/or travel distance into the bowl 3352 based on the detected size of the bowl 3352. This bowl-size detection would advantageously enable the micro-puree machine 10 to process ingredients in different sized containers, such as a single serve container or larger containers.

It will be appreciated by persons skilled in the art that the present disclosure is not limited to what has been particularly shown and described herein above. In addition, unless mention was made above to the contrary, it should be noted that all of the accompanying drawings are not to scale. Of note, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein. Moreover, while certain embodiments or figures described herein may illustrate features not expressly indicated on other figures or embodiments, it is understood that the features and components of the examples disclosed herein are not necessarily exclusive of each other and may be included in a variety of different combinations or configurations without departing from the scope and spirit of the disclosure. A variety of modifications and variations are possible in light of the above teachings without departing from the scope and spirit of the disclosure, which is limited only by the following claims.

What is claimed is:

1. A locking mechanism, comprising:
a processing shaft coupled to a blade for a food processor; and
a coupling connected to move with one of the blade or the processing shaft, wherein the processing shaft is configured to move from (i) a first configuration in which the blade is not locked to the processing shaft, to (ii) a second configuration in which the blade is locked to the processing shaft.

2. The locking mechanism of claim 1, wherein the coupling includes at least one socket.

3. The locking mechanism of claim 2, further comprising at least one ball bearing, wherein, in the first configuration, each of the at least one ball bearing is positioned within one of the at least one socket.

4. The locking mechanism of claim 3, wherein the coupling has a narrower inner diameter between the at least one socket and the blade, the narrower inner diameter forcing the ball bearings into the recesses of the processing shaft in the second configuration.

5. The locking mechanism of claim 3, wherein the blade includes at least one internal cavity configured to receive at least a portion of the at least one ball bearing.

6. The locking mechanism of claim 1, wherein the processing shaft includes an outer assembly including at least one socket, and at least one ball bearing, each ball bearing positioned within one of the at least one socket.

7. The locking mechanism of claim 6, wherein the processing shaft includes an internal assembly including one or more components configured to move along a central axis of the processing shaft between the first configuration and the second configuration.

8. The locking mechanism of claim 7, wherein the one or more components includes at least one wing sloping outwardly from the central axis.

9. The locking mechanism of claim 8, wherein each of the at least one wing has a sidewall with a concave shape corresponding to a convex shape of the at least one ball bearing.

10. The locking mechanism of claim 8, wherein as the one or more components of the internal assembly move from the first configuration to the second configuration, the at least one wing engages at least one of the ball bearings, forcing the at least one ball bearing into a corresponding internal cavity of the blade, thereby locking the blade to the coupling.

11. The locking mechanism of claim 7, wherein the internal assembly includes:
an internal pin configured to move along the central axis between the first configuration and the second configuration, and
a plunger coupled to the internal pin and configured to move along the central axis therewith, wherein as the internal pin moves from the first configuration to the second configuration, the internal pin forces the plunger to engage at least one of the ball bearings.

12. The locking mechanism of claim 11, wherein the outer assembly includes an outer shaft arranged concentrically around at least a portion of the pin and connected at one end to the coupling.

13. The locking mechanism of claim 12, wherein each of the at least one internal cavity has a concave shape corresponding to a convex shape of the at least one ball bearing.

14. The locking mechanism of claim 1, further comprising at least one magnet retained within the coupling and proximate the blade, wherein the at least one magnet applies a magnetic force to removably retain the blade to the processing shaft in the unlocked, first configuration.

15. The locking mechanism of claim 1, further comprising a spring positioned between the coupling and the blade, the spring configured to bias the coupling away from the blade along a central axis of the processing shaft.

16. The locking mechanism of claim 1, further comprising a lid configured to receive the blade, wherein the lid includes at least one protrusion biased inwardly, wherein the blade comprises at least one outwardly extending wing configured to engage the protrusions as the blade is received by the lid such that the at least one wing opposes a biasing force on the protrusions.

17. The locking mechanism of claim 16, wherein when the blade is received within the lid, the protrusions retain the wings within the lid, coupling the blade to the lid.

18. The locking mechanism of claim 16, wherein the at least one wing includes an angled surface extending outwardly to a pointed tip to engage the protrusions.
